(19) United States
(12) Patent Application Publication
(10) Pub. No.: US 2022/0343431 A1
(43) Pub. Date: Oct. 27, 2022

(54) SYSTEM, SERVER AND METHOD TO MODERNIZE, MECHANIZE AND MONETIZE IMMIGRANT VISAS TO SUPPORT ECONOMIC DEVELOPMENT

(71) Applicant: O3 Worldwide, Inc., Huntington Beach, CA (US)

(72) Inventor: Tariq Syed Hasan, Huntington Beach, CA (US)

(21) Appl. No.: 17/727,459

(22) Filed: Apr. 22, 2022

Related U.S. Application Data
(60) Provisional application No. 63/178,121, filed on Apr. 22, 2021.

(51) Int. Cl. G06Q 40/06; G06Q 40/02

(52) U.S. Cl. CPC G06Q 40/06; G06Q 40/025

(57) ABSTRACT

Some embodiments include a computer-implemented system to automate and process the monetization of immigrant visas and/or non-immigrant visas and/or the financial structuring of immigrant visas and/or non-immigrant visas to develop, construct and support the legal and financial structuring of immigrant visas and non-immigrant visas for immigrant and non-immigrant visa financial markets, immigrant and non-immigrant visa financial products, immigrant and non-immigrant visa financial tools, immigrant and non-immigrant visa financial structures, and/or immigrant and non-immigrant visa financial algorithms to support economic development, job creation, direct investment, indirect investment, credit enhancement and/or loan guarantees to support immigrant visa-based and/or non-immigrant visa-based financing, funding and/or investment in multiple industry sectors in the United States and on a global basis.

### CROSS-REFERENCE RELATED APPLICATIONS

This application claims the benefit of U.S. Provisional Patent Application No. 63/178,121, filed Apr. 22, 2021, entitled “System, Server and Method to Modernize, Mechanize and Monetize Immigrant Visas to Support Economic Development”, the entire contents of which are incorporated herein by reference.

### BACKGROUND

There is a need to develop a computer-implemented system to automate and process the monetization of immigrant visas and/or non-immigrant visas and/or the financial structuring of immigrant visas and/or non-immigrant visas to develop, construct and support the legal and financial structuring of immigrant visas and non-immigrant visas for immigrant and non-immigrant visa financial markets, immigrant and non-immigrant visa financial products, immigrant and non-immigrant visa financial tools, immigrant and non-immigrant visa financial structures, and/or immigrant and non-immigrant visa financial algorithms to support economic development, job creation, direct investment, indirect investment, credit enhancement and/or loan guarantees to support immigrant visa-based and/or non-immigrant visa-based financing, funding and/or investment in multiple industry sectors in the United States and on a global basis.

There is a need for a system, server and method to modernize, mechanize and monetize immigrant visas.

There is a need for a system, server and method to automate and process the monetization of immigrant visas and/or the financial structuring of immigrant visas.

There is a need for a system, server and method to automate and process the monetization of immigrant visas and/or the financial structuring of immigrant visas for financing, funding and/or investment for job creation and economic development.

There is a need for a system, server and method to aggregate, manage and track immigrant visas.

There is a need for a system, server and method to aggregate, manage and track immigrant visas for financing, funding and/or investment.

There is a need for a system, server and method to apply financing, funding and/or investment criteria to immigrant visas.

There is a need for a system, server and method to develop, construct and support the monetization of immigrant visas to support immigrant visa financial markets, immigrant visa financial products, immigrant visa financial tools, immigrant visa financial structures, and/or immigrant visa financial algorithms to support economic development, job creation, direct investment, indirect investment, credit enhancement, loan guarantees and/or immigrant visa-based financing, funding and/or investment in multiple industry sectors in the United States and on a global basis.

There is a need for a system, server and method to develop, construct and support the financial structuring of immigrant visas to support immigrant visa financial markets, immigrant visa financial products, immigrant visa financial tools, immigrant visa financial structures, and/or immigrant visa financial algorithms to support economic development, job creation, direct investment, indirect investment, credit enhancement, loan guarantees and/or immigrant visa-based financing, funding and/or investment in multiple industry sectors in the United States and on a global basis.

There is a need for a system, server and method to apply monetization structuring to some or all immigrant visas, recaptured immigrant visas, recaptured unused immigrant visas and/or unused immigrant visas that can be implemented as a result of Presidential action, federal administrative action and/or legislative action.

There is a need for a system, server and method to apply financial structuring to some or all immigrant visas, recaptured immigrant visas, recaptured unused immigrant visas and/or unused immigrant visas that can be implemented as a result of Presidential action, federal administrative action and/or legislative action.

There is a need for a system, server and method to apply financing, funding and/or investment criteria to some or all immigrant visas, recaptured immigrant visas, recaptured unused immigrant visas and/or unused immigrant visas that can be implemented as a result of Presidential action, federal administrative action and/or legislative action.

There is a need for a system, server and method to modernize, mechanize and monetize non-immigrant visas.

There is a need for a system, server and method to automate and process the monetization of non-immigrant visas and/or the financial structuring of non-immigrant visas.

There is a need for a system, server and method to automate and process the monetization of non-immigrant visas and/or the financial structuring of non-immigrant visas for financing, funding and/or investment for job creation and economic development.

There is a need for a system, server and method to aggregate, manage and track non-immigrant visas.

There is a need for a system, server and method to aggregate, manage and track non-immigrant visas for financing, funding and/or investment.

There is a need for a system, server and method to apply financing, funding and/or investment criteria to non-immigrant visas.

There is a need for a system, server and method to develop, construct and support the monetization of non-immigrant visas to support non-immigrant visa financial markets, non-immigrant visa financial products, non-immigrant visa financial tools, non-immigrant visa financial structures, and/or non-immigrant visa financial algorithms to support economic development, job creation, direct investment, indirect investment, credit enhancement, loan guarantees and/or non-immigrant visa-based financing, funding and/or investment in multiple industry sectors in the United States and on a global basis.

There is a need for a system, server and method to develop, construct and support the financial structuring of non-immigrant visas to support non-immigrant visa financial markets, non-immigrant visa financial products, non-immigrant visa financial tools, non-immigrant visa financial structures, and/or non-immigrant visa financial algorithms to support economic development, job creation, direct investment, indirect investment, credit enhancement, loan guarantees and/or non-immigrant visa-based financing, funding and/or investment in multiple industry sectors in the United States and on a global basis.

There is a need for a system, server and method to apply monetization structuring to some or all non-immigrant visas, recaptured non-immigrant visas, recaptured unused non-immigrant visas and/or unused non-immigrant visas that can be implemented as a result of Presidential action, federal administrative action and/or legislative action.

There is a need for a system, server and method to apply financial structuring to some or all non-immigrant visas, recaptured non-immigrant visas, recaptured unused non-immigrant visas and/or unused non-immigrant visas that can be implemented as a result of Presidential action, federal administrative action and/or legislative action.

There is a need for a system, server and method to apply financing, funding and/or investment criteria to some or all non-immigrant visas, recaptured non-immigrant visas, recaptured unused non-immigrant visas and/or unused non-immigrant visas that can be implemented as a result of Presidential action, federal administrative action and/or legislative action.

### SUMMARY

Some embodiments include a computer-implemented system to automate and process the monetization of immigrant visas and/or non-immigrant visas and/or the financial structuring of immigrant visas and/or non-immigrant visas to develop, construct and support the legal and financial structuring of immigrant visas and non-immigrant visas for immigrant and non-immigrant visa financial markets, immigrant and non-immigrant visa financial products, immigrant and non-immigrant visa financial tools, immigrant and non-immigrant visa financial structures, and/or immigrant and non-immigrant visa financial algorithms to support economic development, job creation, direct investment, indirect investment, credit enhancement and/or loan guarantees to support immigrant visa-based and/or non-immigrant visa-based financing, funding and/or investment in multiple industry sectors in the United States and on a global basis.

Some embodiments include a computer-implemented system to modernize, mechanize and monetize immigrant visas.

Some embodiments include a computer-implemented system to automate and process the monetization of immigrant visas and/or the financial structuring of immigrant visas.

Some embodiments include a computer-implemented system to automate and process the monetization of immigrant visas and/or the financial structuring of immigrant visas for financing, funding and/or investment for job creation and economic development.

Some embodiments include a computer-implemented system to aggregate, manage and track immigrant visas.

Some embodiments include a computer-implemented system to aggregate, manage and track immigrant visas for financing, funding and/or investment.

Some embodiments include a computer-implemented system to apply financing, funding and/or investment criteria to immigrant visas.

Some embodiments include a computer-implemented system to develop, construct and support the monetization of immigrant visas to support immigrant visa financial markets, immigrant visa financial products, immigrant visa financial tools, immigrant visa financial structures, and/or immigrant visa financial algorithms to support economic development, job creation, direct investment, indirect investment, credit enhancement, loan guarantees and/or immigrant visa-based financing, funding and/or investment in multiple industry sectors in the United States and on a global basis.

Some embodiments include a computer-implemented system to develop, construct and support the financial structuring of immigrant visas to support immigrant visa financial markets, immigrant visa financial products, immigrant visa financial tools, immigrant visa financial structures, and/or immigrant visa financial algorithms to support economic development, job creation, direct investment, indirect investment, credit enhancement, loan guarantees and/or immigrant visa-based financing, funding and/or investment in multiple industry sectors in the United States and on a global basis.

Some embodiments include a computer-implemented system to apply monetization structuring to some or all immigrant visas, recaptured immigrant visas, recaptured unused immigrant visas and/or unused immigrant visas that can be implemented as a result of Presidential action, federal administrative action and/or legislative action.

Some embodiments include a computer-implemented system to apply financial structuring to some or all immigrant visas, recaptured immigrant visas, recaptured unused immigrant visas and/or unused immigrant visas that can be implemented as a result of Presidential action, federal administrative action and/or legislative action.

Some embodiments include a computer-implemented system to apply financing, funding and/or investment criteria to some or all immigrant visas, recaptured immigrant visas, recaptured unused immigrant visas and/or unused immigrant visas that can be implemented as a result of Presidential action, federal administrative action and/or legislative action.

Some embodiments include a computer-implemented system, server and method that aggregates, manages and tracks immigrant visas and/or investments in furtherance of immigrant visas and/or job creation in furtherance of immigrant visas and/or immigrant visa employment opportunities in furtherance of immigrant visas including, but not limited to, immigrant visas, recaptured immigrant visas for use in subsequent fiscal years, unused immigrant visas recaptured for use in subsequent fiscal years, prospective immigrant visas for use in a specific fiscal year and prospective immigrant visas for use in subsequent fiscal years. In some embodiments, the system includes the ability to modernize immigrant visas, mechanize immigrant visas, monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas, fund immigrant visas, finance immigrant visas, collateralize immigrant visas, collateralize the financing of immigrant visas, securitize immigrant visas, securitize the financing of immigrant visas, create financial algorithms for immigrant visas, create financial algorithms for the funding of immigrant visas, create financial algorithms for the financing of immigrant visas, create a market for immigrant visas, create a market for the funding of immigrant visas, create a market for the financing of immigrant visas, create financial products for immigrant visas, create financial products for the funding of immigrant visas, create financial products for the financing of immigrant visas, create financial tools for immigrant visas, create financial tools for the funding of immigrant visas, create financial tools for the financing of immigrant visas, create financial structures for immigrant visas, create financial structures for the funding of immigrant visas, create financial structures for the financing of immigrant visas, accept and process visa applications, accept and process expedited visa applications, authenticate investment source of funds, enable background check processing, enable national security related screening and processing, track visa processing, track legal compliance, track securities law compliance, track national security law compliance, suggest investments, track job creation, track investment performance, suggest and place immigrants with job creation entities, suggest and place immigrants with employment opportunities and/or monitor investments for fraud. In some embodiments, the system significantly increases the likelihood of obtaining an immigrant visa while mitigating risk associated with obtaining an immigrant visa.

Some embodiments include a computer-implemented system to aggregate, manage, and track immigrant visas to develop, construct and support financial algorithms, financial products, financial tools and financial structures to support direct investment, credit enhancement, loan guarantees and other economic development in multiple industry sectors in the United States and on a global basis.

Some embodiments include a computer-implemented system that includes at least specifically programming at least one computer system to aggregate, manage, track and monetize immigrant visas.

Some embodiments include a computer-implemented system that includes at least specifically programming at least one computer system to process the executive, administrative and/or legislative recapture up to or over 4,547,236 immigrant visas and for these recaptured immigrant visas to be aggregated, managed and tracked.

Some embodiments include a computer-implemented system that includes at least specifically programming at least one computer system or a portion of at least one computer system to aggregate, manage and track immigrant investor visas and/or immigrant investor visas funding including, but not limited to, recaptured immigrant visas to be used for financing investment and/or financing, funding and/or investment and/or credit enhancement for financing, funding or investment.

Some embodiments include a computer-implemented system to modernize, mechanize and monetize non-non-immigrant visas.

Some embodiments include a computer-implemented system to automate and process the monetization of non-immigrant visas and/or the financial structuring of non-immigrant visas.

Some embodiments include a computer-implemented system to automate and process the monetization of non-immigrant visas and/or the financial structuring of non-immigrant visas for financing, funding and/or investment for job creation and economic development.

Some embodiments include a computer-implemented system to aggregate, manage and track non-immigrant visas.

Some embodiments include a computer-implemented system to aggregate, manage and track non-immigrant visas for financing, funding and/or investment.

Some embodiments include a computer-implemented system to apply financing, funding and/or investment criteria to non-immigrant visas.

Some embodiments include a computer-implemented system to develop, construct and support the monetization of non-immigrant visas to support immigrant visa financial markets, immigrant visa financial products, immigrant visa financial tools, immigrant visa financial structures, and/or immigrant visa financial algorithms to support economic development, job creation, direct investment, indirect investment, credit enhancement, loan guarantees and/or immigrant visa-based financing, funding and/or investment in multiple industry sectors in the United States and on a global basis.

Some embodiments include a computer-implemented system to develop, construct and support the financial structuring of non-immigrant visas to support immigrant visa financial markets, immigrant visa financial products, immigrant visa financial tools, immigrant visa financial structures, and/or immigrant visa financial algorithms to support economic development, job creation, direct investment, indirect investment, credit enhancement, loan guarantees and/or immigrant visa-based financing, funding and/or investment in multiple industry sectors in the United States and on a global basis.

Some embodiments include a computer-implemented system to apply monetization structuring to some or all non-immigrant visas, recaptured non-immigrant visas, recaptured unused non-immigrant visas and/or unused non-immigrant visas that can be implemented as a result of Presidential action, federal administrative action and/or legislative action.

Some embodiments include a computer-implemented system to apply financial structuring to some or all non-immigrant visas, recaptured non-immigrant visas, recaptured unused non-immigrant visas and/or unused non-immigrant visas that can be implemented as a result of Presidential action, federal administrative action and/or legislative action.

Some embodiments include a computer-implemented system to apply financing, funding and/or investment criteria to some or all non-immigrant visas, recaptured non-immigrant visas, recaptured unused non-immigrant visas and/or unused non-immigrant visas that can be implemented as a result of Presidential action, federal administrative action and/or legislative action.

Some embodiments include a computer-implemented system, server and method that aggregates, manages and tracks non-immigrant visas and/or investments in furtherance of non-immigrant visas and/or job creation in furtherance of non-immigrant visas and/or immigrant visa employment opportunities in furtherance of non-immigrant visas including, but not limited to, non-immigrant visas, recaptured non-immigrant visas for use in subsequent fiscal years, unused non-immigrant visas recaptured for use in subsequent fiscal years, prospective non-immigrant visas for use in a specific fiscal year and prospective non-immigrant visas for use in subsequent fiscal years. In some embodiments, the system includes the ability to modernize non-immigrant visas, mechanize non-immigrant visas, monetize non-immigrant visas, attribute a financial value to non-immigrant visas, attribute a monetary value to non-immigrant visas, attribute an economic value to non-immigrant visas, attribute a unit of time to non-immigrant visas, attribute a monetary value to a unit of time to non-immigrant visas, attribute a financial value to a unit of time to non-immigrant visas, attribute an economic value to a unit of time to non-immigrant visas, fund non-immigrant visas, finance non-immigrant visas, collateralize non-immigrant visas, collateralize the financing of non-immigrant visas, securitize non-immigrant visas, securitize the financing of non-immigrant visas, create financial algorithms for non-immigrant visas, create financial algorithms for the funding of non-immigrant visas, create financial algorithms for the financing of non-immigrant visas, create a market for non-immigrant visas, create a market for the funding of non-immigrant visas, create a market for the financing of non-immigrant visas, create financial products for non-immigrant visas, create financial products for the funding of non-immigrant visas, create financial products for the financing of non-immigrant visas, create financial tools for non-immigrant visas, create financial tools for the funding of non-immigrant visas, create financial tools for the financing of non-immigrant visas, create financial structures for non-immigrant visas, create financial structures for the funding of non-immigrant visas, create financial structures for the financing of non-immigrant visas, accept and process visa applications, accept and process expedited visa applications, authenticate investment source of funds, enable background check processing, enable national security related screening and processing, track visa processing, track legal compliance, track securities law compliance, track national security law compliance, suggest investments, track job creation, track investment performance, suggest and place immigrants with job creation entities, suggest and place immigrants with employment opportunities and/or monitor investments for fraud. In some embodiments, the system significantly increases the likelihood of obtaining an immigrant visa while mitigating risk associated with obtaining an immigrant visa.

Some embodiments include a computer-implemented system to aggregate, manage, and track non-immigrant visas to develop, construct and support financial algorithms, financial products, financial tools and financial structures to support direct investment, credit enhancement, loan guarantees and other economic development in multiple industry sectors in the United States and on a global basis.

Some embodiments include a computer-implemented system that includes at least specifically programming at least one computer system to aggregate, manage, track and monetize non-immigrant visas.

Some embodiments include a computer-implemented system that includes at least specifically programming at least one computer system to process the executive, administrative and/or legislative recapture up non-immigrant visas and for these recaptured non-immigrant visas to be aggregated, managed and tracked.

Some embodiments include a computer-implemented system that includes at least specifically programming at least one computer system or a portion of at least one computer system to aggregate, manage and track immigrant investor visas and/or immigrant investor visas funding including, but not limited to, recaptured non-immigrant visas to be used for financing investment and/or financing, funding and/or investment and/or credit enhancement for financing, funding or investment.

### DESCRIPTION OF THE DRAWINGS

FIG. 1 illustrates a monetization structure and/or financial structure using immigrant visas for financing, funding and/or investment for job creation and economic development in accordance with some embodiments of the invention.

FIG. 2 illustrates a monetization structure and/or financial structure using immigrant visas for financing for job creation and economic development in accordance with some embodiments of the invention.

FIG. 3 illustrates a monetization structure and/or financial structure using immigrant visas for funding for job creation and economic development in accordance with some embodiments of the invention.

FIG. 4 illustrates a monetization structure and/or financial structure using immigrant visa criteria, investment criteria and job creation criteria for financing, funding and/or investment for job creation and economic development in accordance with some embodiments of the invention.

FIG. 5 illustrates a monetization structure and/or financial structure using immigrant visa criteria, financing criteria, funding criteria, investment criteria and job creation criteria for financing, funding and/or investment for job creation and economic development in accordance with some embodiments of the invention.

FIG. 6 illustrates a monetization structure and/or financial structure using immigrant visas criteria and financing criteria for financing, funding and/or investment for job creation and economic development in accordance with some embodiments of the invention.

FIG. 7 illustrates a monetization structure and/or financial structure using immigrant visas criteria and funding criteria for financing, funding and/or investment for job creation and economic development in accordance with some embodiments of the invention.

FIG. 8 illustrates a monetization structure and/or financial structure using immigrant visas criteria and investment criteria for financing, funding and/or investment for job creation and economic development in accordance with some embodiments of the invention.

FIG. 9 illustrates a monetization structure and/or financial structure using immigrant visas criteria and job creation criteria for financing, funding and/or investment for job creation and economic development in accordance with some embodiments of the invention.

FIG. 10 illustrates a monetization structure and/or financial structure using immigrant visas for financing, funding and/or investment of $1,800,000 for job creation and economic development in accordance with some embodiments of the invention.

FIG. 11 illustrates a monetization structure and/or financial structure using immigrant visas for financing, funding and/or investment of $900,000 for job creation and economic development in accordance with some embodiments of the invention.

FIG. 12 illustrates a monetization structure and/or financial structure using immigrant visas financing for an immigrant visa unit of time for job creation and economic development in accordance with some embodiments of the invention.

FIG. 13 illustrates a monetization structure and/or financial structure using immigrant visas funding for an immigrant visa unit of time for job creation and economic development in accordance with some embodiments of the invention.

FIG. 14 illustrates a monetization structure and/or financial structure using immigrant visas investment for an immigrant visa unit of time for job creation and economic development in accordance with some embodiments of the invention.

FIG. 15 illustrates a monetization structure and/or financial structure using immigrant visas investment for an immigrant visa unit of time to collateralize immigrant visas for job creation and economic development in accordance with some embodiments of the invention.

FIG. 16 illustrates a monetization structure and/or financial structure using immigrant visas investment for an immigrant visa unit of time to securitize immigrant visas for job creation and economic development in accordance with some embodiments of the invention.

FIG. 17 illustrates a monetization structure and/or financial structure using immigrant visas investment for an immigrant visa unit of time to collateralize the financing of immigrant visas for job creation and economic development in accordance with some embodiments of the invention.

FIG. 18 illustrates a monetization structure and/or financial structure using immigrant visas investment for an immigrant visa unit of time to securitize the financing of immigrant visas for job creation and economic development in accordance with some embodiments of the invention.

FIG. 19 illustrates a monetization structure and/or financial structure using immigrant visas financial algorithms for the financing of immigrant visas to securitize the financing of immigrant visas for job creation and economic development in accordance with some embodiments of the invention.

FIG. 20 illustrates a monetization structure and/or financial structure using immigrant visas financial algorithms for the funding of immigrant visas to securitize the financing of immigrant visas for job creation and economic development in accordance with some embodiments of the invention.

FIG. 21 illustrates a monetization structure and/or financial structure using immigrant visas financial algorithms for investment involving immigrant visas to securitize the financing of immigrant visas for job creation and economic development in accordance with some embodiments of the invention.

FIG. 22 illustrates a monetization structure and/or financial structure using an immigrant visas financial market to finance immigrant visas for job creation and economic in accordance with some embodiments of the invention.

FIG. 23 illustrates a monetization structure and/or financial structure using an immigrant visas financial market fund immigrant visas for job creation and economic in accordance with some embodiments of the invention.

FIG. 24 illustrates a monetization structure and/or financial structure using an immigrant visas financial market for investments involving immigrant visas for job creation and economic in accordance with some embodiments of the invention.

FIG. 25 illustrates a monetization structure and/or financial structure using an immigrant visas financial product to finance immigrant visas for job creation and economic in accordance with some embodiments of the invention.

FIG. 26 illustrates a monetization structure and/or financial structure using an immigrant visas financial product fund immigrant visas for job creation and economic in accordance with some embodiments of the invention.

FIG. 27 illustrates a monetization structure and/or financial structure using an immigrant visas financial product for investments involving immigrant visas for job creation and economic in accordance with some embodiments of the invention.

FIG. 28 illustrates a monetization structure and/or financial structure using immigrant visas financial tools to finance immigrant visas for job creation and economic in accordance with some embodiments of the invention.

FIG. 29 illustrates a monetization structure and/or financial structure using immigrant visas financial tools to fund immigrant visas for job creation and economic in accordance with some embodiments of the invention.

FIG. 30 illustrates a monetization structure and/or financial structure using immigrant visas financial tools for investment involving immigrant visas for job creation and economic in accordance with some embodiments of the invention.

FIG. 31 illustrates a monetization structure and/or financial structure using immigrant visas financial structures to finance immigrant visas for job creation and economic in accordance with some embodiments of the invention.

FIG. 32 illustrates a monetization structure and/or financial structure using immigrant visas financial structures to fund immigrant visas for job creation and economic in accordance with some embodiments of the invention.

FIG. 33 illustrates a monetization structure and/or financial structure using immigrant visas financial structures for investment involving immigrant visas for job creation and economic in accordance with some embodiments of the invention.

FIG. 34 illustrates a monetization structure and/or financial structure using immigrant visas for financing, funding and/or investment using direct investment for job creation and economic development in accordance with some embodiments of the invention.

FIG. 35 illustrates a monetization structure and/or financial structure using immigrant visas for financing, funding and/or investment using credit enhancement for job creation and economic development in accordance with some embodiments of the invention.

FIG. 36 illustrates a monetization structure and/or financial structure using immigrant visas for financing, funding and/or investment using loan guarantees for job creation and economic development in accordance with some embodiments of the invention.

FIG. 37 illustrates a monetization structure and/or financial structure using immigrant visas for financing, funding and/or investment using direct investment, credit enhancement, loan guarantee, financial market, financial product, financial tools, financial structures, financial algorithms for job creation and economic development in accordance with some embodiments of the invention.

FIG. 38 illustrates a strategic overview an immigrant visa program enabled implementation in accordance with some embodiments of the invention.

FIG. 39 illustrates a strategic overview an immigrant visa program enabled implementation in accordance with some embodiments of the invention.

FIG. 40 illustrates a strategic overview an immigrant visa recapture program enabled implementation in accordance with some embodiments of the invention.

FIG. 41 illustrates a strategic overview an immigrant visa recapture program enabled implementation in accordance with some embodiments of the invention.

FIG. 42 illustrates a strategic overview an immigrant visa program enabled implementation with presidential action in accordance with some embodiments of the invention.

FIG. 43 illustrates a strategic overview an immigrant visa program enabled implementation with administrative action in accordance with some embodiments of the invention.

FIG. 44 illustrates a strategic overview an immigrant visa program enabled implementation with legislative action in accordance with some embodiments of the invention.

FIG. 45 illustrates a strategic overview an immigrant visa recapture program enabled implementation in accordance with some embodiments of the invention.

FIG. 46 illustrates a strategic overview an immigrant visa recapture program enabled implementation in accordance with some embodiments of the invention.

FIG. 47 illustrates a strategic overview an immigrant visa recapture program enabled implementation in accordance with some embodiments of the invention.

FIG. 48 illustrates a strategic overview an immigrant visa recapture program enabled implementation in accordance with some embodiments of the invention.

FIG. 49 illustrates a strategic overview an immigrant visa recapture program enabled implementation in accordance with some embodiments of the invention.

FIG. 50 illustrates a strategic overview an immigrant visa recapture program enabled implementation in accordance with some embodiments of the invention.

FIG. 51 illustrates a strategic overview an immigrant visa recapture program enabled implementation in accordance with some embodiments of the invention.

FIG. 52 illustrates a strategic overview an immigrant visa recapture program enabled implementation in accordance with some embodiments of the invention.

FIG. 53 illustrates a strategic overview an immigrant visa recapture program enabled implementation in accordance with some embodiments of the invention.

FIG. 54 illustrates a strategic overview an immigrant visa recapture program enabled implementation in accordance with some embodiments of the invention.

FIG. 55 illustrates a strategic overview an immigrant visa recapture program enabled implementation in accordance with some embodiments of the invention.

FIG. 56 illustrates a strategic overview an immigrant visa recapture program enabled implementation in accordance with some embodiments of the invention.

FIG. 57 illustrates a strategic overview an immigrant visa recapture program enabled implementation in accordance with some embodiments of the invention.

FIG. 58 illustrates a strategic overview an immigrant visa recapture program enabled implementation in accordance with some embodiments of the invention.

FIG. 59 illustrates a strategic overview an immigrant visa recapture program enabled implementation in accordance with some embodiments of the invention.

FIG. 60 illustrates a strategic overview an immigrant visa recapture program enabled implementation in accordance with some embodiments of the invention.

FIG. 61 illustrates a monetization structure and/or financial structure using immigrant visas for financing, funding and/or investment using a financing and loan model for job creation and economic development in accordance with some embodiments of the invention.

FIG. 62 illustrates a monetization structure and/or financial structure using immigrant visas for financing, funding and/or investment for job creation and economic development in accordance with some embodiments of the invention.

FIG. 63 illustrates a monetization structure and/or financial structure using immigrant visas for financing, funding and/or investment for job creation and economic development in accordance with some embodiments of the invention.

FIG. 64 illustrates a strategic overview of an immigrant visa program enabled implementation and job creation in accordance with some embodiments of the invention.

FIG. 65 illustrates a strategic overview of an immigrant visa program enabled implementation and job creation in accordance with some embodiments of the invention.

FIG. 66 illustrates a strategic overview of an immigrant visa program enabled implementation and job creation in accordance with some embodiments of the invention.

FIG. 67 illustrates a strategic overview of an immigrant visa program enabled implementation and job creation using commercial airplanes or commercial satellites in accordance with some embodiments of the invention.

FIG. 68 illustrates a monetization structure and/or financial structure using immigrant visas for financing, funding and/or investment for job creation and economic development using Boeing® products and Boeing® customers in accordance with some embodiments of the invention.

FIG. 69 illustrates a strategic overview an immigrant visa recapture program enabled implementation in accordance with some embodiments of the invention.

FIG. 70 illustrates a monetization structure and/or financial structure using immigrant visas for financing, funding and/or investment for job creation and economic development in accordance with some embodiments of the invention.

FIG. 71 illustrates a monetization structure and/or financial structure using immigrant visas for financing, funding and/or investment for job creation and economic development in accordance with some embodiments of the invention.

FIG. 72 illustrates a strategic overview an immigrant visa recapture program enabled implementation in accordance with some embodiments of the invention.

FIG. 73 illustrates a monetization structure and/or financial structure using immigrant visas for financing, funding and/or investment for job creation and economic development in accordance with some embodiments of the invention.

FIG. 74 illustrates a strategic overview an immigrant visa recapture program enabled implementation in accordance with some embodiments of the invention.

FIG. 75 illustrates a strategic overview an immigrant visa recapture program enabled implementation in accordance with some embodiments of the invention.

FIG. 76 illustrates a strategic overview an immigrant visa recapture program enabled implementation in accordance with some embodiments of the invention.

FIG. 77 illustrates a financing system process in accordance with some embodiments of the invention.

FIG. 78 illustrates a financing system process in accordance with some embodiments of the invention.

FIG. 79 illustrates a funding system process in accordance with some embodiments of the invention.

FIG. 80 illustrates a funding system process in accordance with some embodiments of the invention.

FIG. 81 illustrates an investor system process in accordance with some embodiments of the invention.

FIG. 82 illustrates an investor system process in accordance with some embodiments of the invention.

FIG. 83 illustrates a system network for performing the processes of FIGS. 74-79 in accordance with some embodiments of the invention.

FIG. 84 shows a block diagram of a server system for implementing or operating any of the processes or methods of the invention.

### DETAILED DESCRIPTION

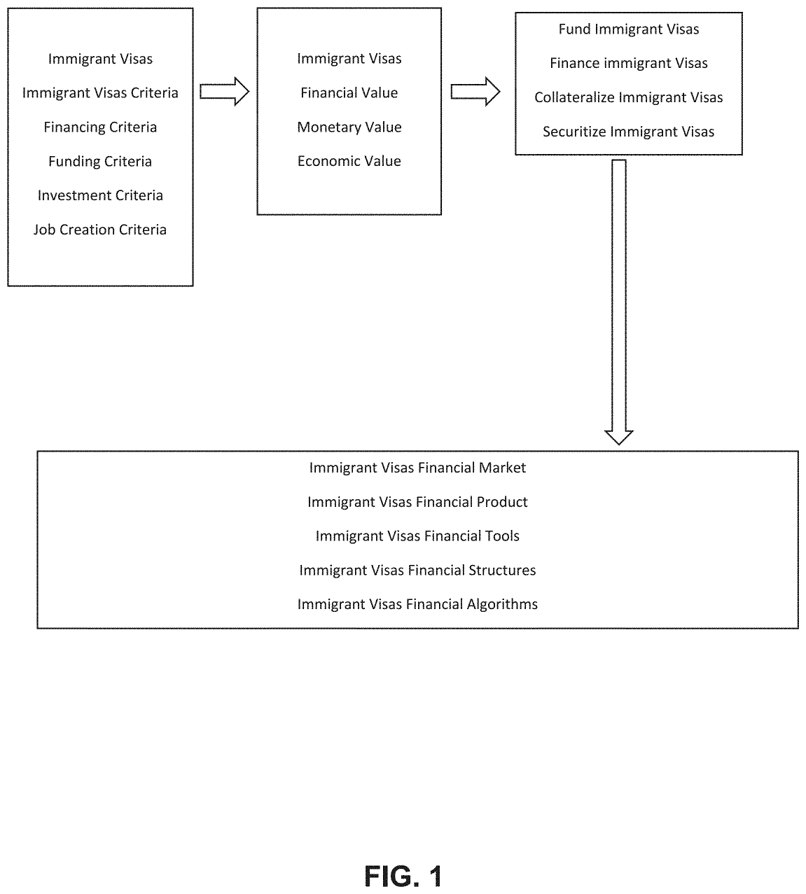

FIG. 1 illustrates a monetization structure and/or financial structure using immigrant visas for financing, funding and/or investment for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas. As used herein, in some embodiments, the term “aggregate” means “aggregate, manage and/or track”.

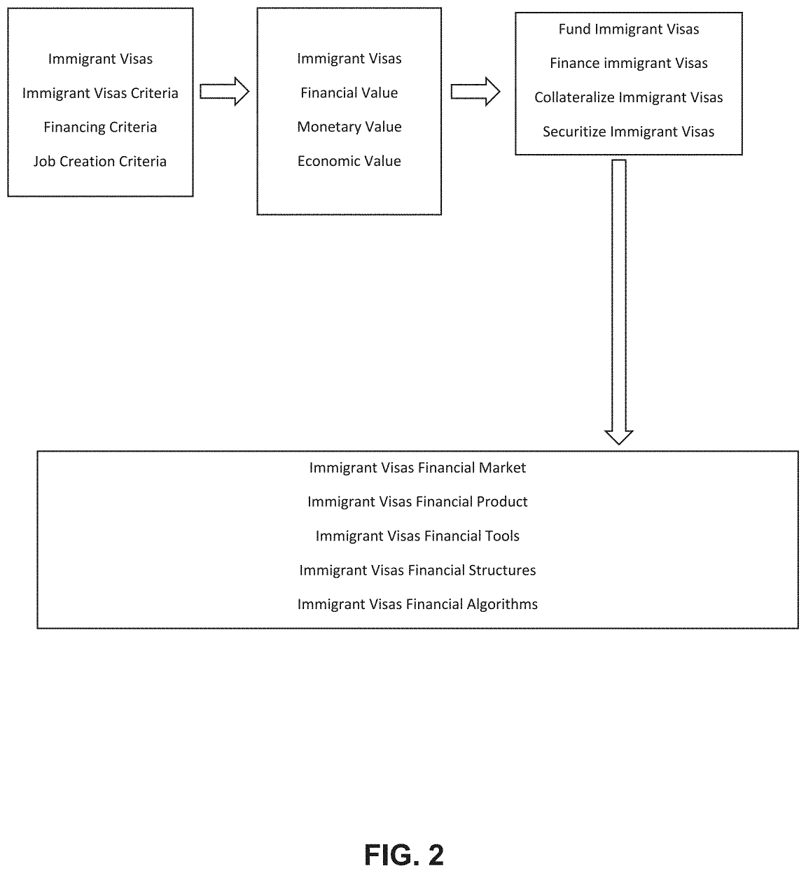

FIG. 2 illustrates a monetization structure and/or financial structure using immigrant visas for financing for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

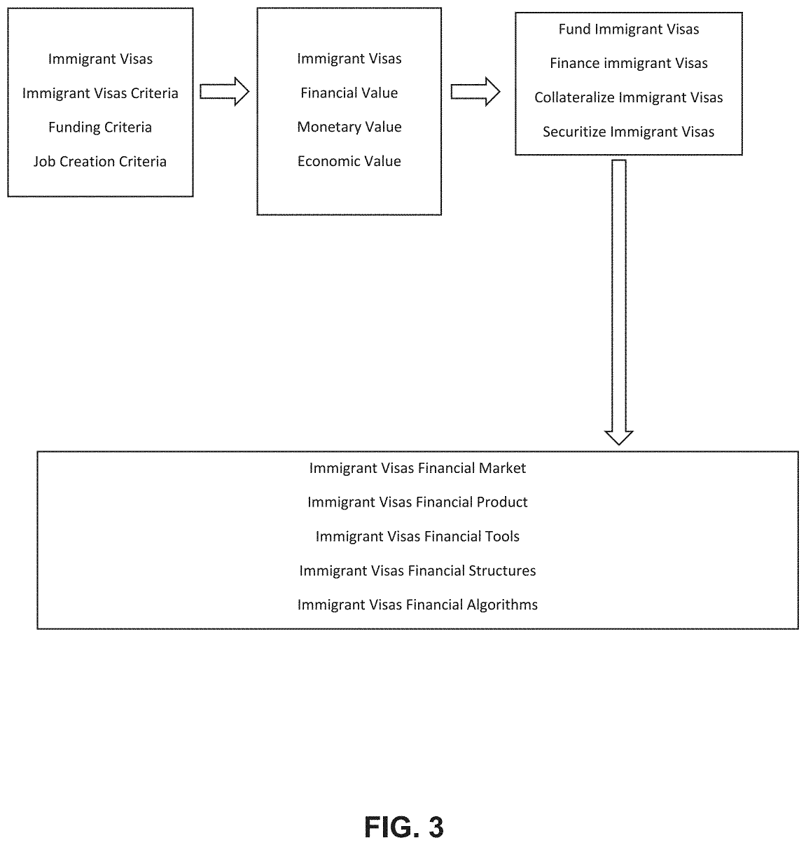

FIG. 3 illustrates a monetization structure and/or financial structure using immigrant visas for funding for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

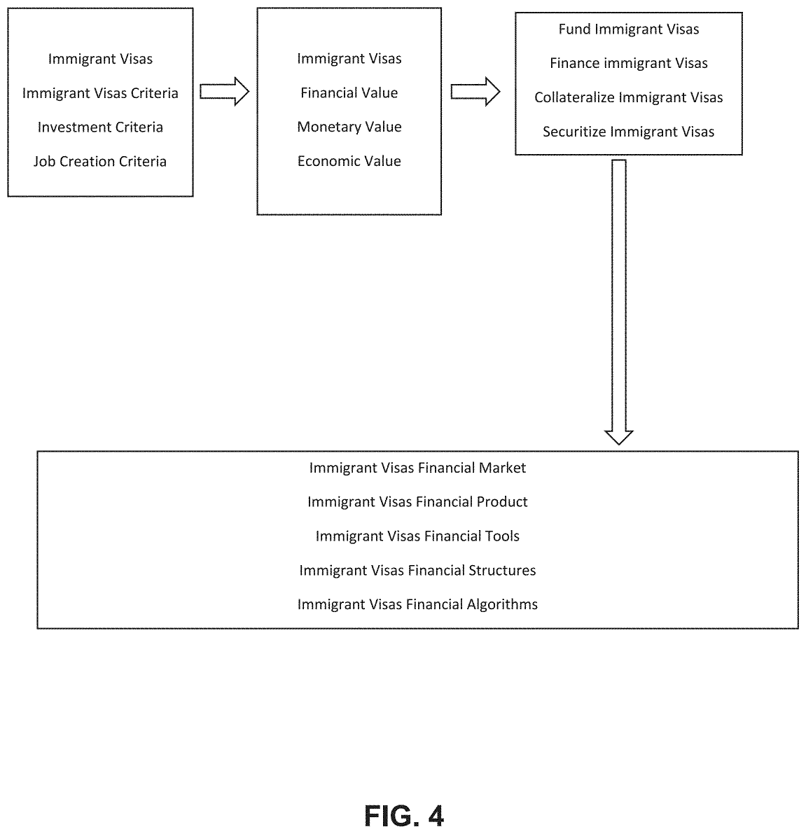

FIG. 4 illustrates a monetization structure and/or financial structure using immigrant visa criteria, investment criteria and job creation criteria for financing, funding and/or investment for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

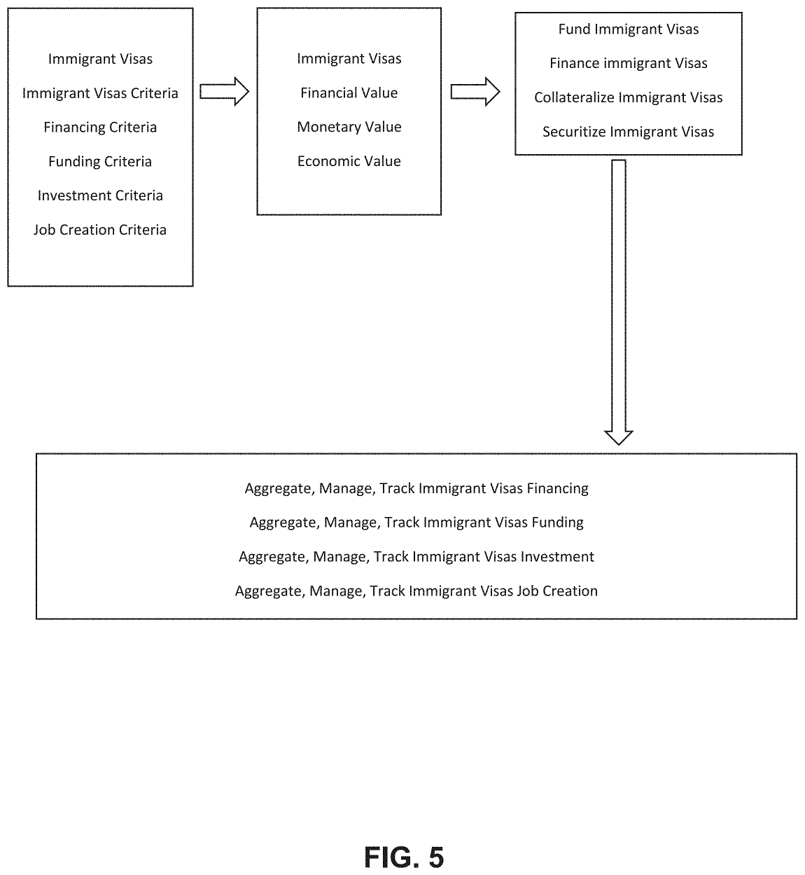

FIG. 5 illustrates a monetization structure and/or financial structure using immigrant visa criteria, financing criteria, funding criteria, investment criteria and job creation criteria for financing, funding and/or investment for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

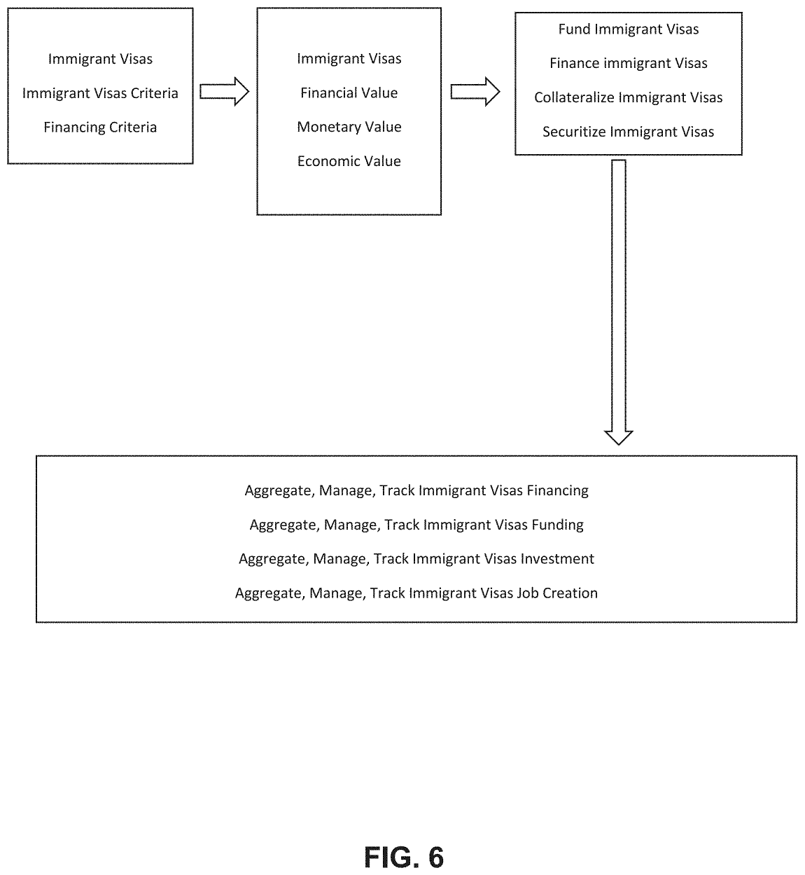

FIG. 6 illustrates a monetization structure and/or financial structure using immigrant visas criteria and financing criteria for financing, funding and/or investment for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

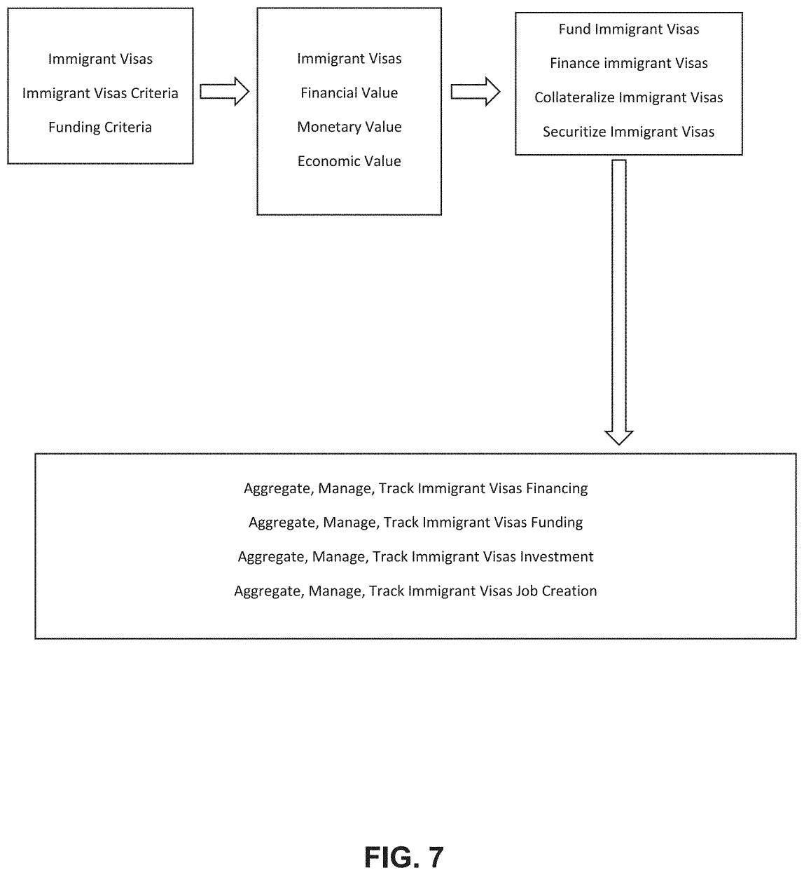

FIG. 7 illustrates a monetization structure and/or financial structure using immigrant visas criteria and funding criteria for financing, funding and/or investment for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

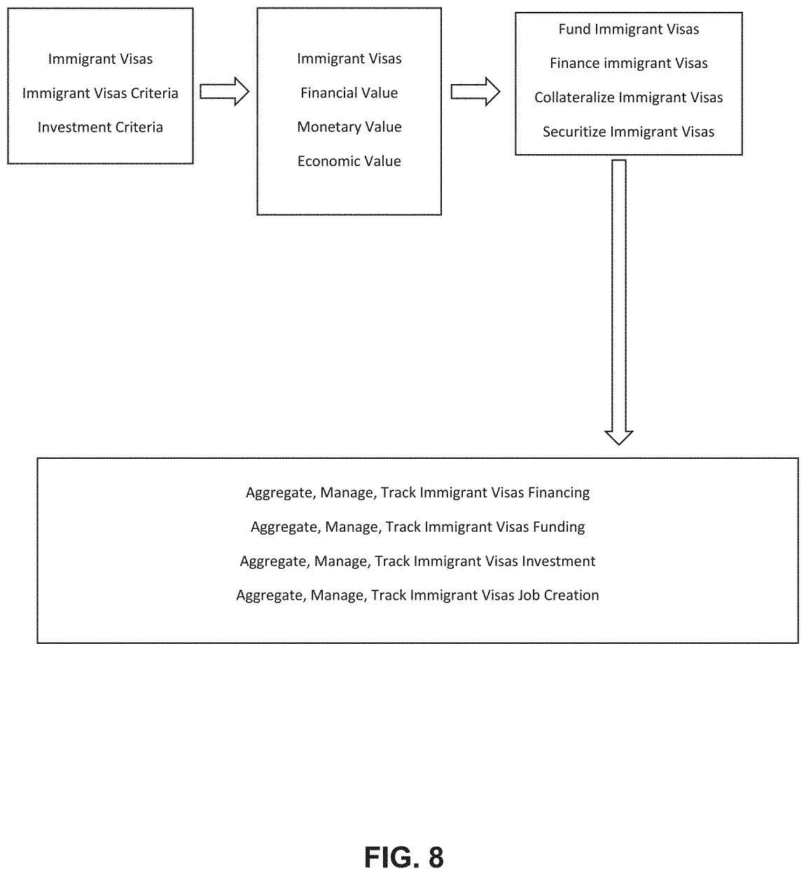

FIG. 8 illustrates a monetization structure and/or financial structure using immigrant visas criteria and investment criteria for financing, funding and/or investment for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

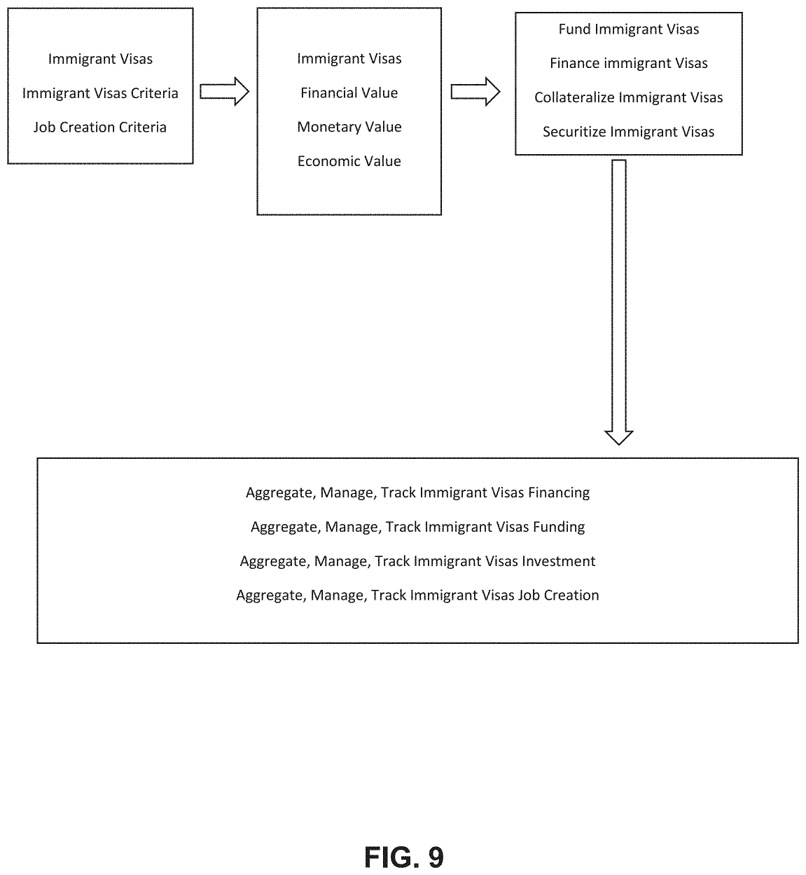

FIG. 9 illustrates a monetization structure and/or financial structure using immigrant visas criteria and job creation criteria for financing, funding and/or investment for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

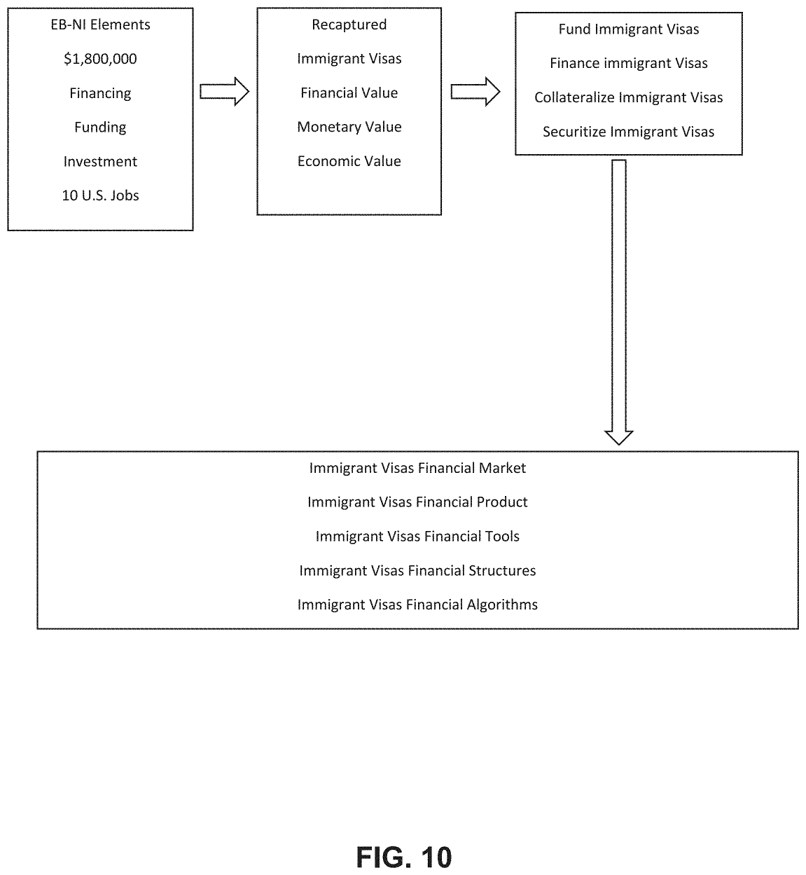

FIG. 10 illustrates a monetization structure and/or financial structure using immigrant visas for financing, funding and/or investment of $1,800,000 for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

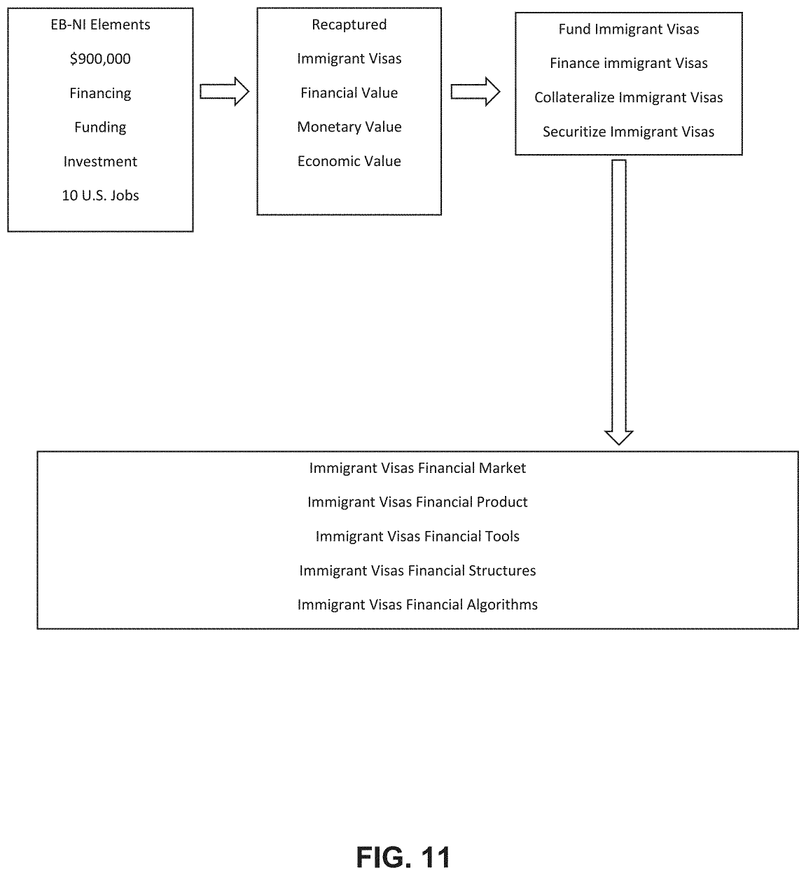

FIG. 11 illustrates a monetization structure and/or financial structure using immigrant visas for financing, funding and/or investment of $900,000 for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

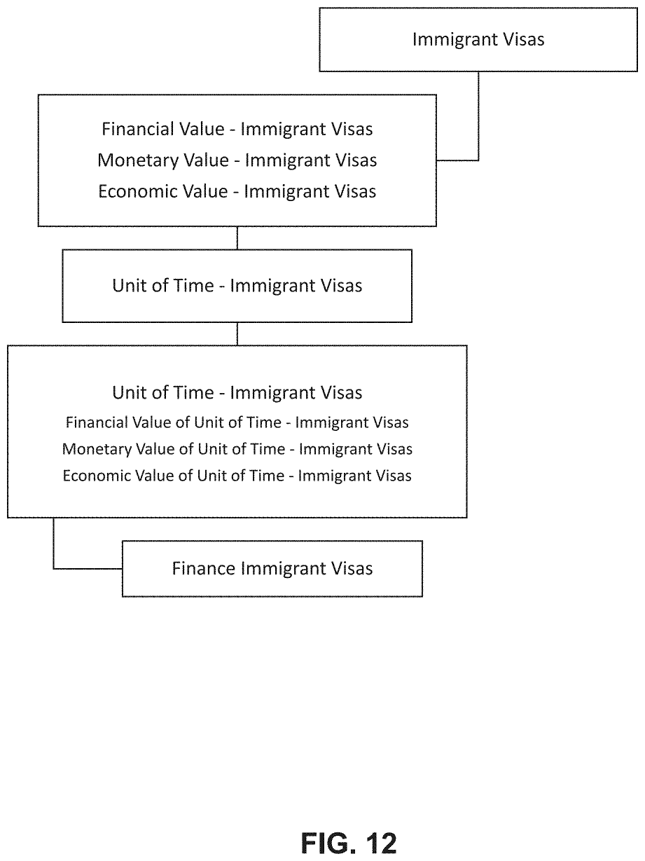

FIG. 12 illustrates a monetization structure and/or financial structure using immigrant visas financing for an immigrant visa unit of time for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

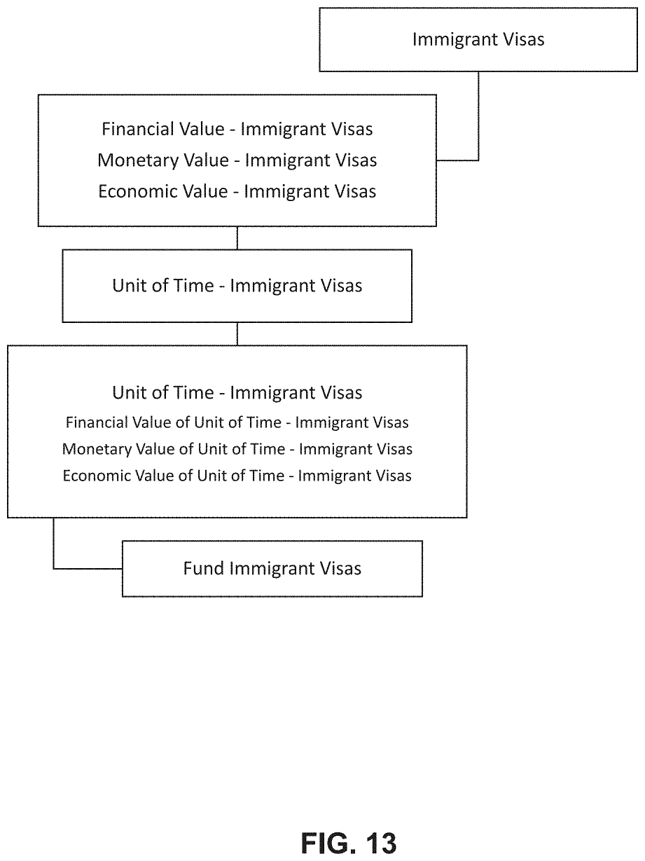

FIG. 13 illustrates a monetization structure and/or financial structure using immigrant visas funding for an immigrant visa unit of time for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

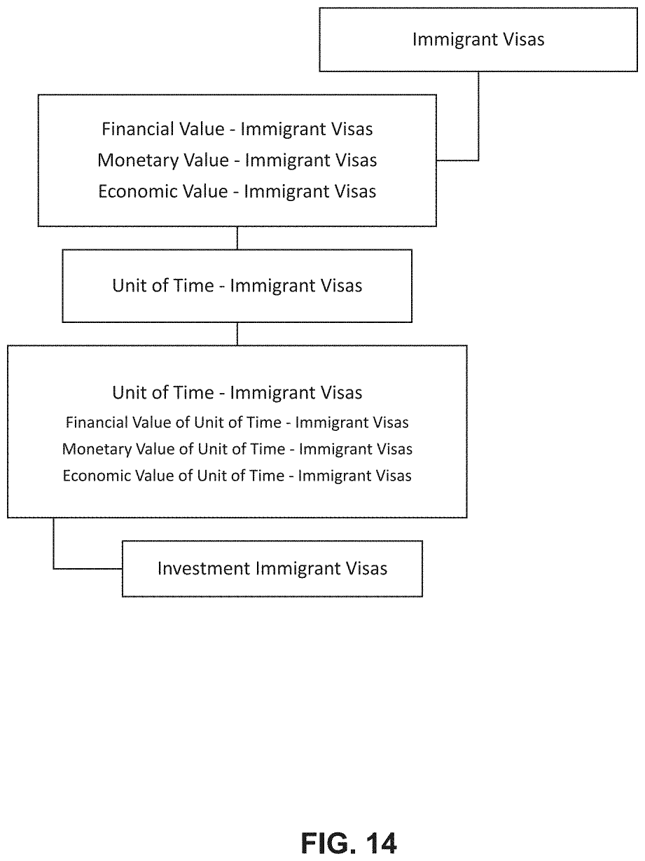

FIG. 14 illustrates a monetization structure and/or financial structure using immigrant visas investment for an immigrant visa unit of time for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

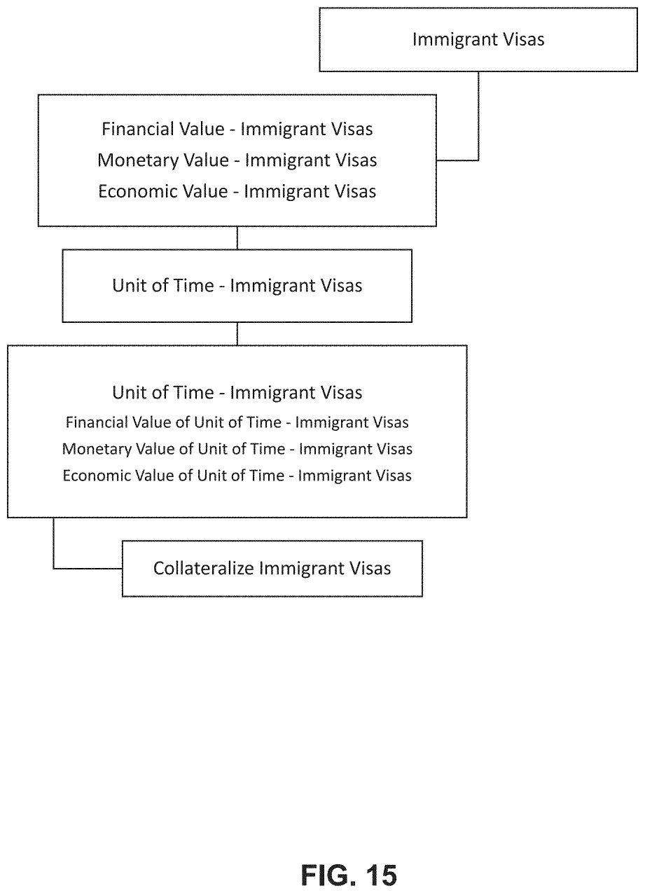

FIG. 15 illustrates a monetization structure and/or financial structure using immigrant visas investment for an immigrant visa unit of time to collateralize immigrant visas for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

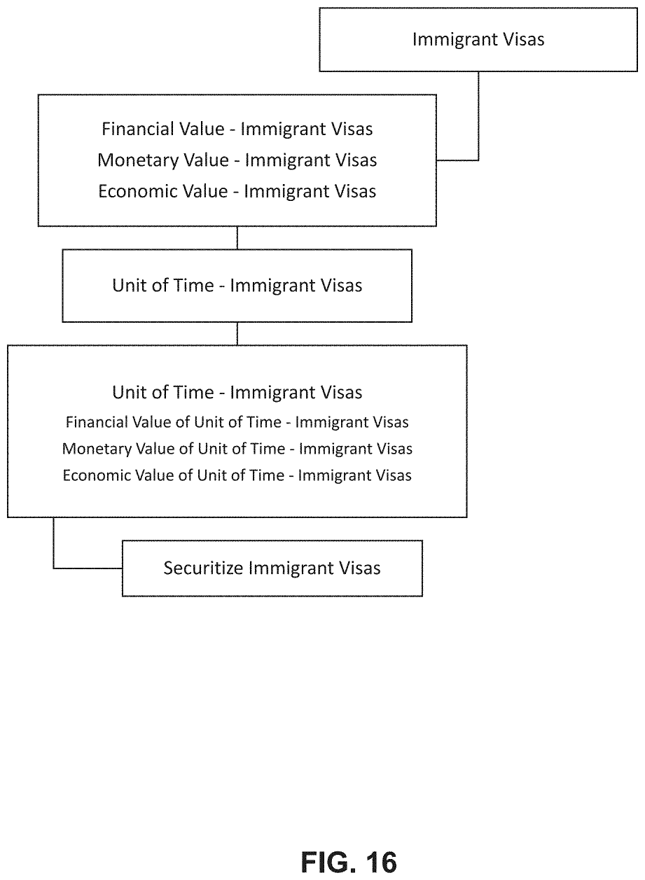

FIG. 16 illustrates a monetization structure and/or financial structure using immigrant visas investment for an immigrant visa unit of time to securitize immigrant visas for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

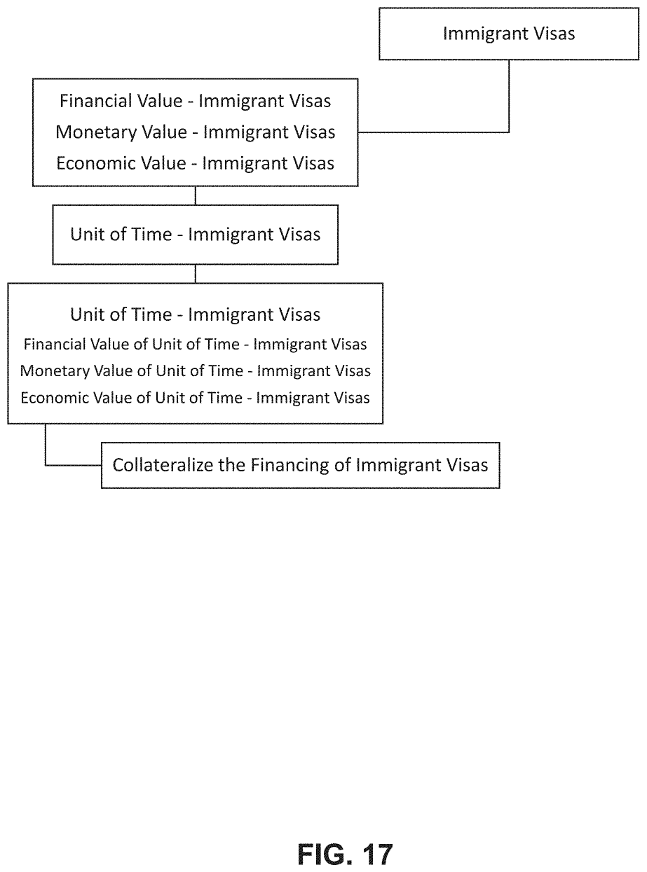

FIG. 17 illustrates a monetization structure and/or financial structure using immigrant visas investment for an immigrant visa unit of time to collateralize the financing of immigrant visas for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

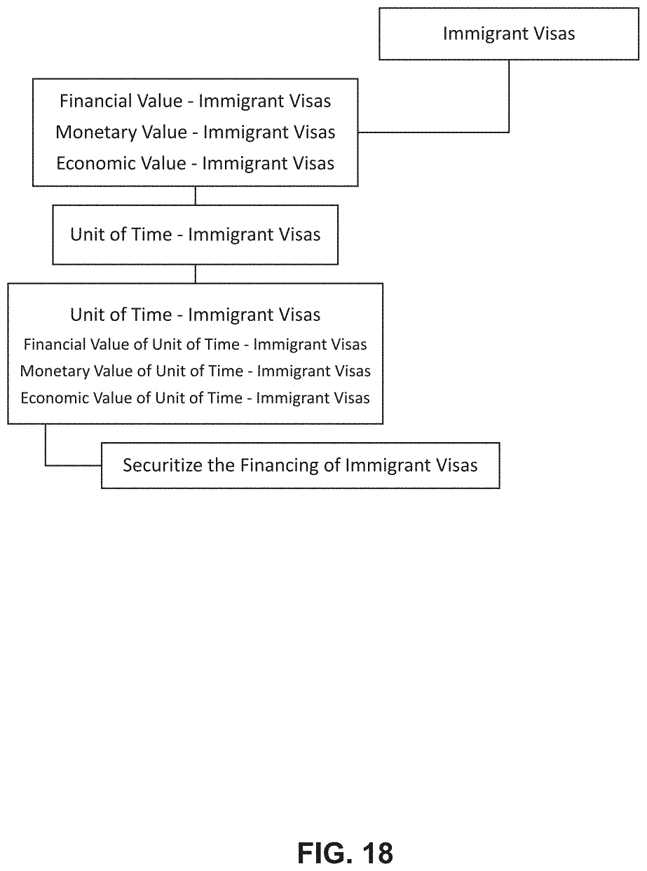

FIG. 18 illustrates a monetization structure and/or financial structure using immigrant visas investment for an immigrant visa unit of time to securitize the financing of immigrant visas for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

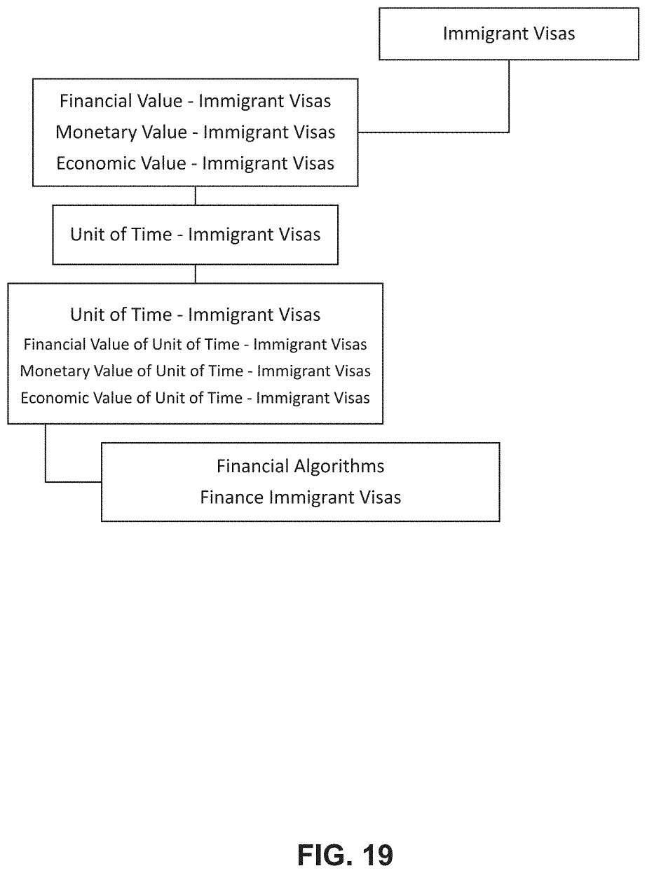

FIG. 19 illustrates a monetization structure and/or financial structure using immigrant visas financial algorithms for the financing of immigrant visas to securitize the financing of immigrant visas for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

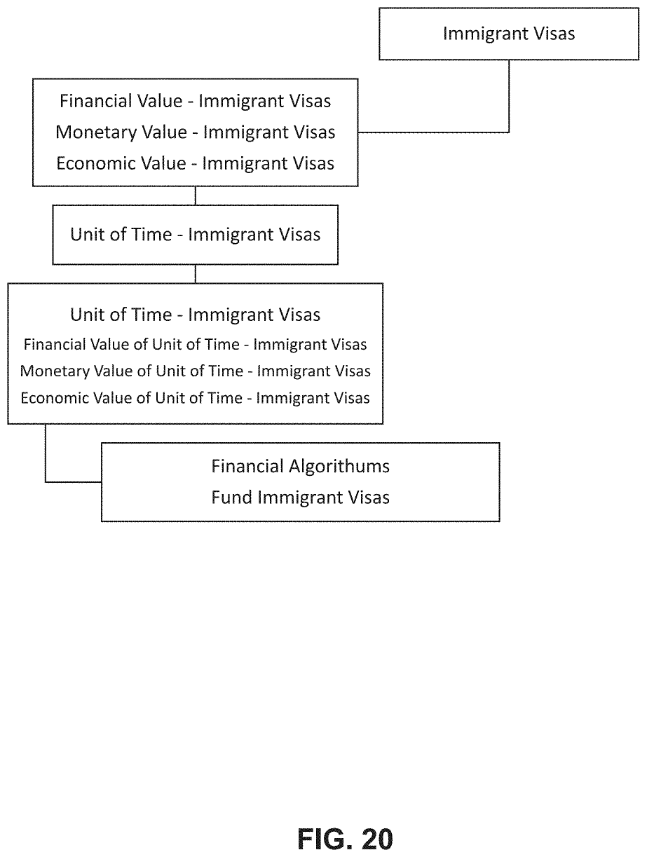

FIG. 20 illustrates a monetization structure and/or financial structure using immigrant visas financial algorithms for the funding of immigrant visas to securitize the financing of immigrant visas for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

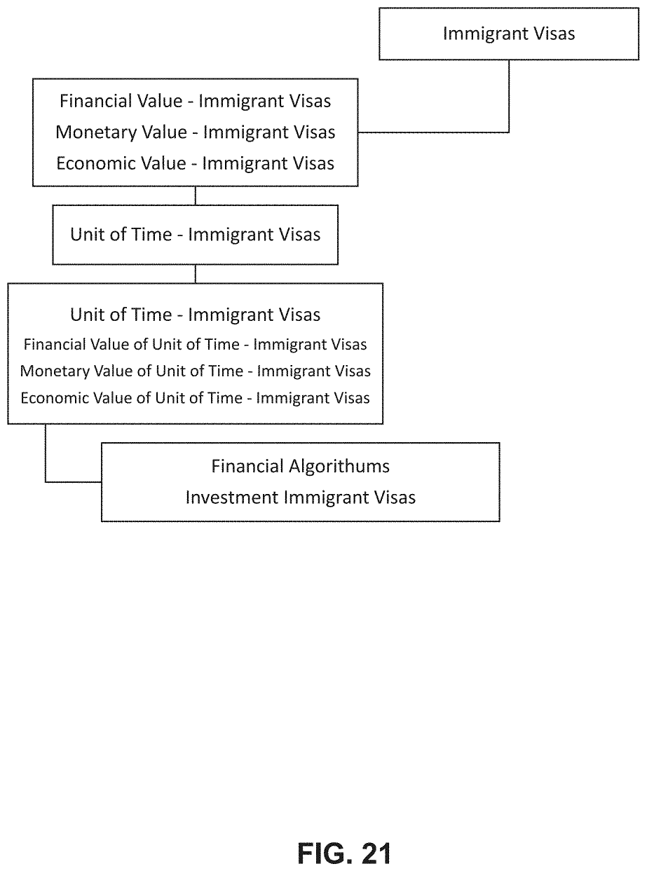

FIG. 21 illustrates a monetization structure and/or financial structure using immigrant visas financial algorithms for investment involving immigrant visas to securitize the financing of immigrant visas for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

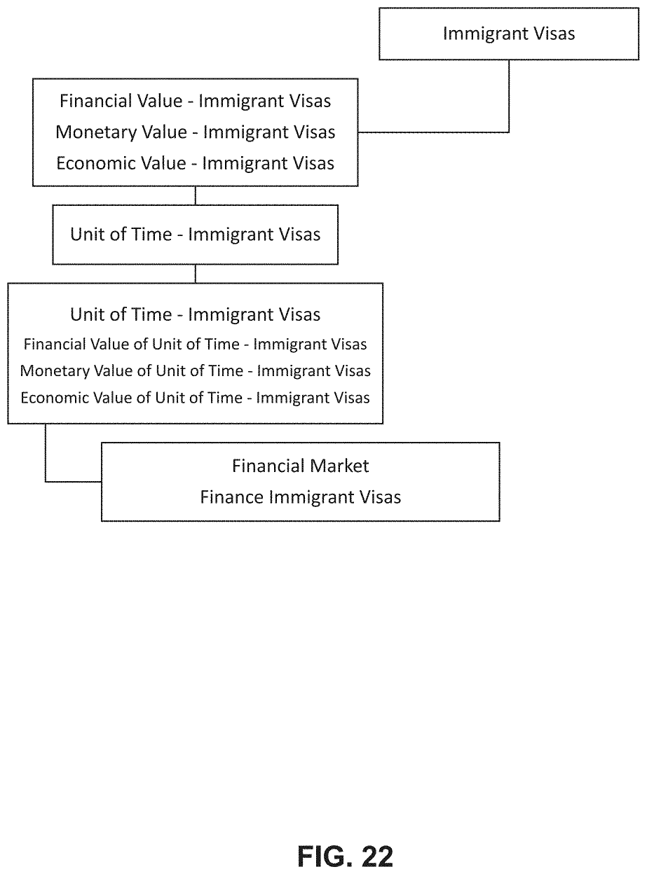

FIG. 22 illustrates a monetization structure and/or financial structure using an immigrant visas financial market to finance immigrant visas for job creation and economic in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

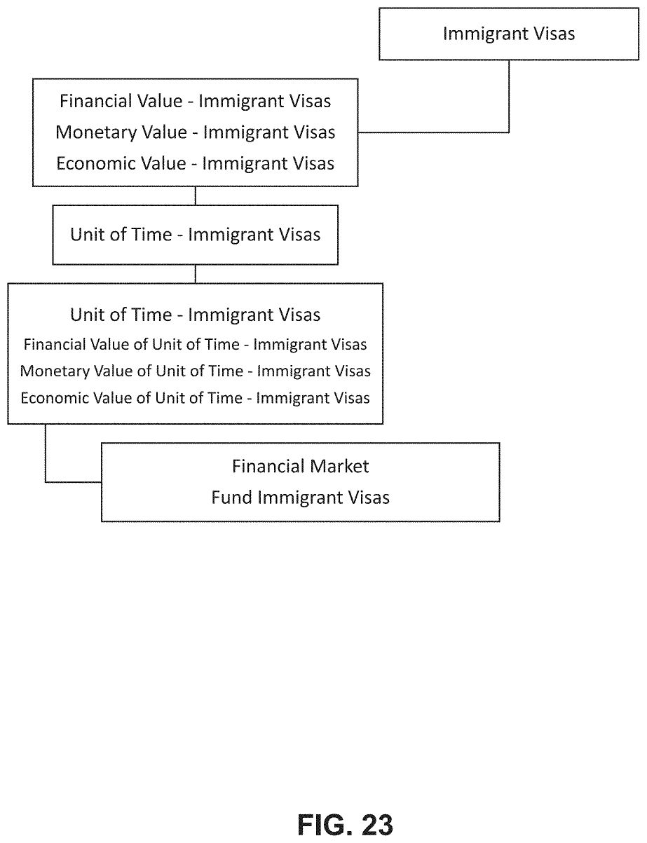

FIG. 23 illustrates a monetization structure and/or financial structure using an immigrant visas financial market fund immigrant visas for job creation and economic in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

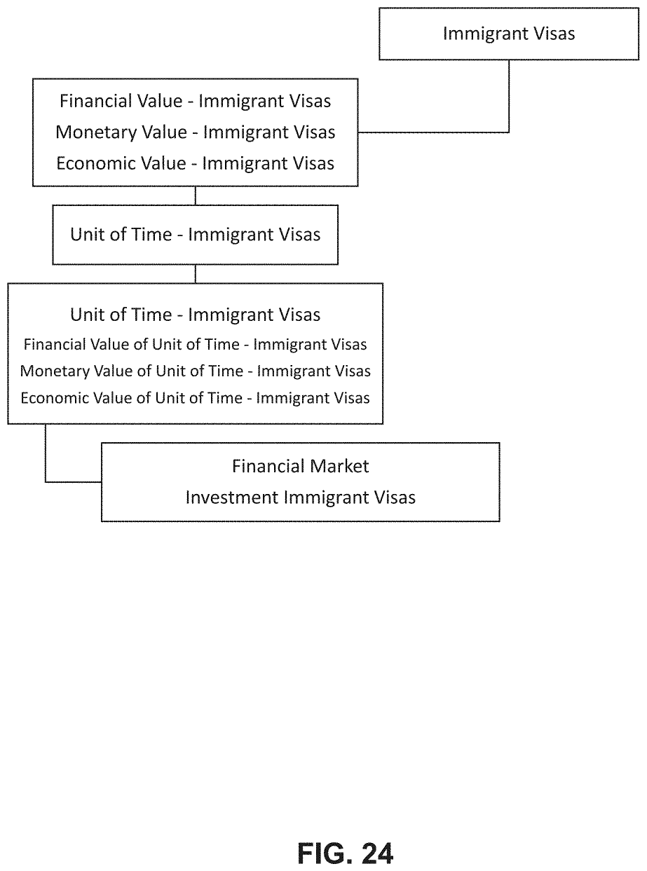

FIG. 24 illustrates a monetization structure and/or financial structure using an immigrant visas financial market for investments involving immigrant visas for job creation and economic in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

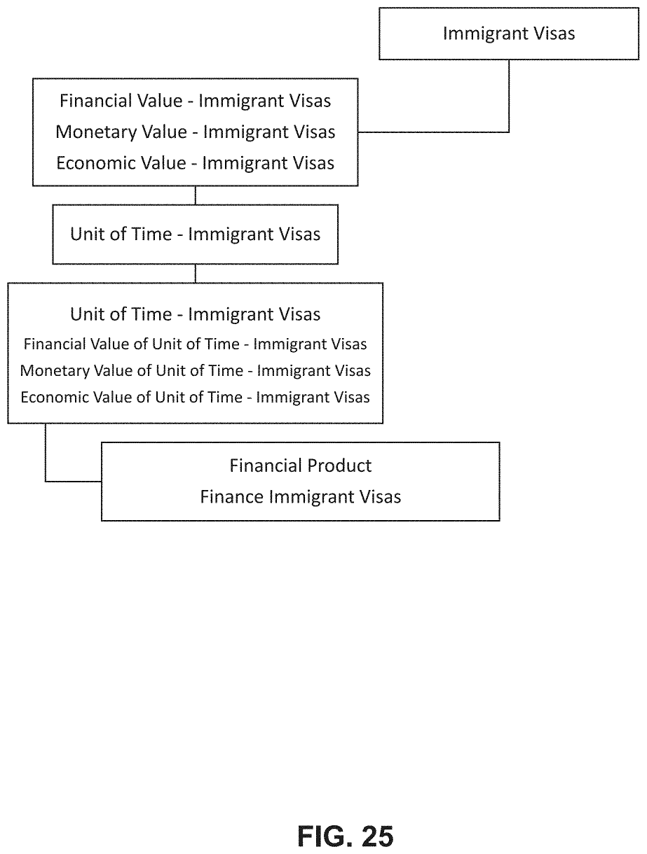

FIG. 25 illustrates a monetization structure and/or financial structure using an immigrant visas financial product to finance immigrant visas for job creation and economic in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

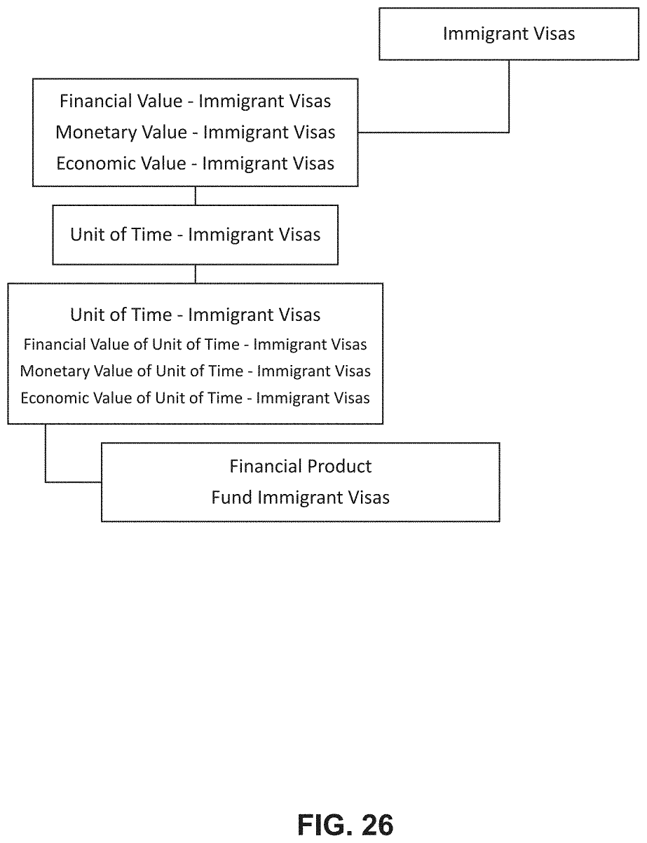

FIG. 26 illustrates a monetization structure and/or financial structure using an immigrant visas financial product fund immigrant visas for job creation and economic in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

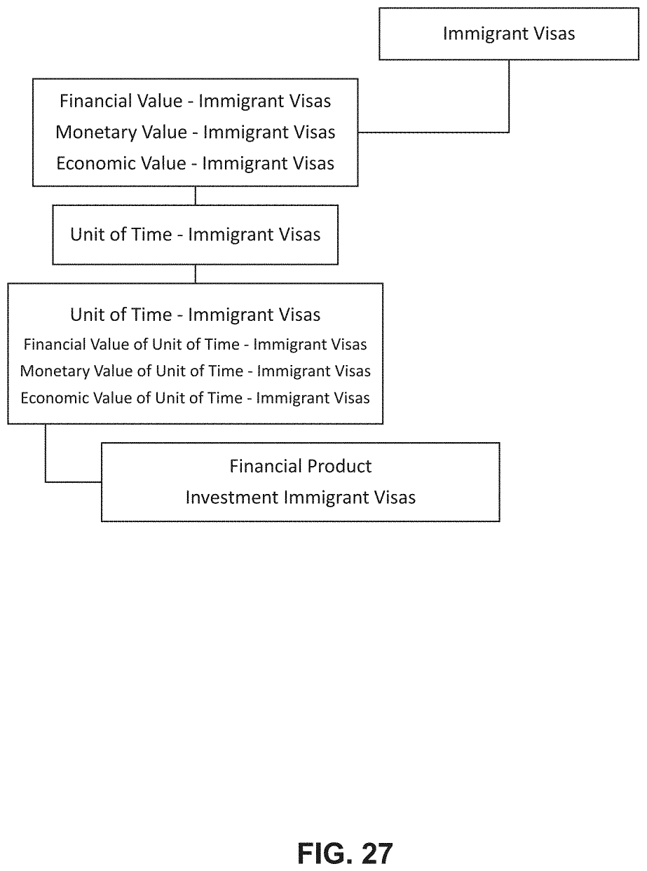

FIG. 27 illustrates a monetization structure and/or financial structure using an immigrant visas financial product for investments involving immigrant visas for job creation and economic in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

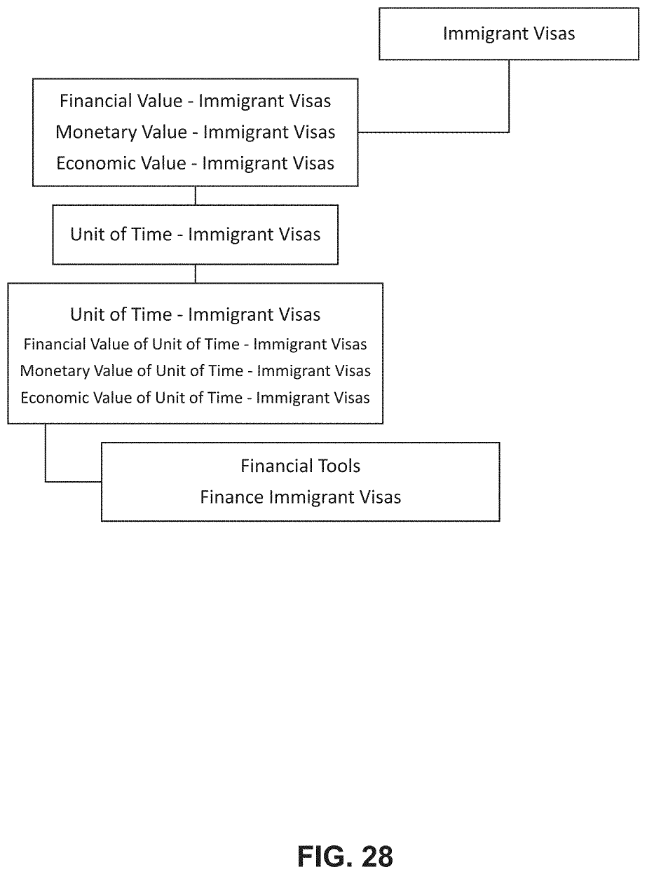

FIG. 28 illustrates a monetization structure and/or financial structure using immigrant visas financial tools to finance immigrant visas for job creation and economic in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

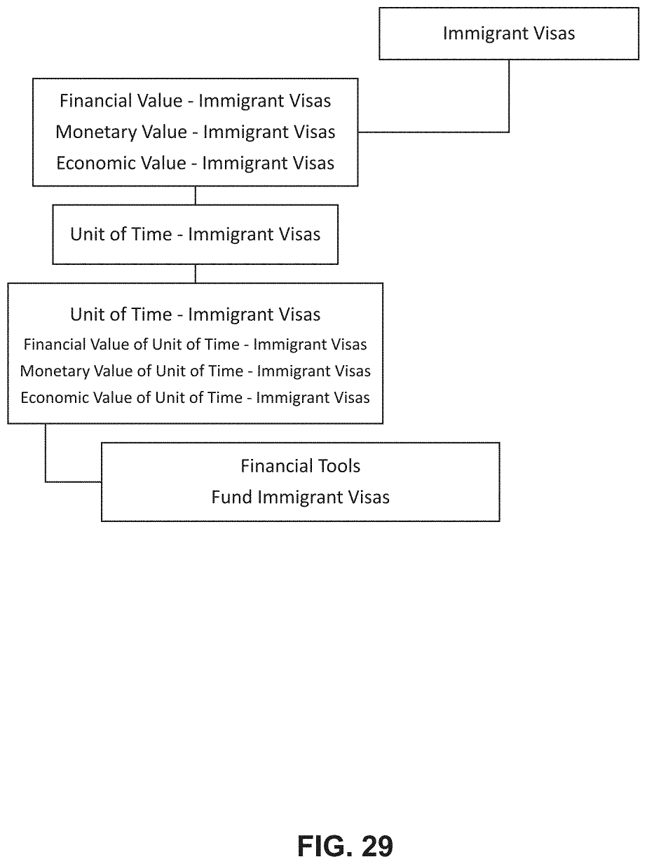

FIG. 29 illustrates a monetization structure and/or financial structure using immigrant visas financial tools to fund immigrant visas for job creation and economic in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

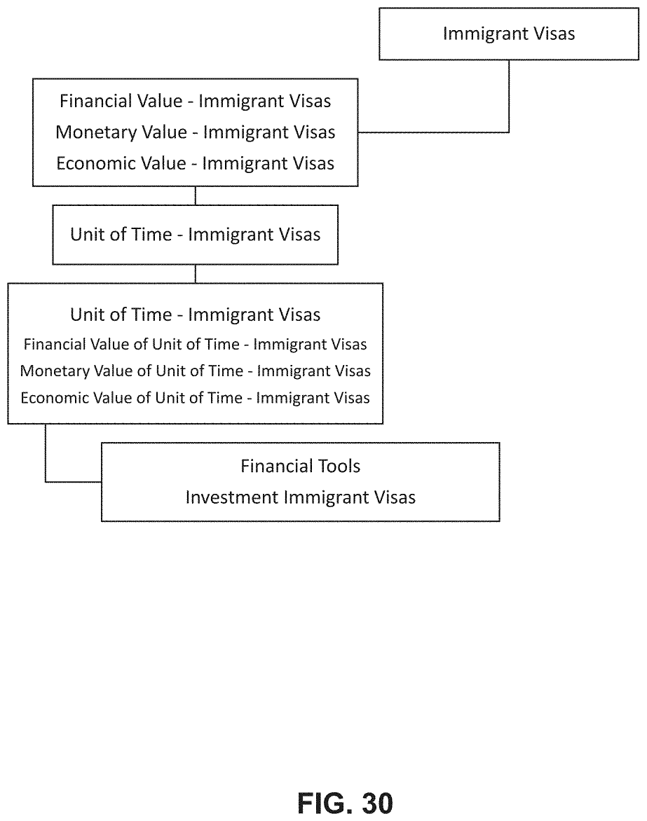

FIG. 30 illustrates a monetization structure and/or financial structure using immigrant visas financial tools for investment involving immigrant visas for job creation and economic in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

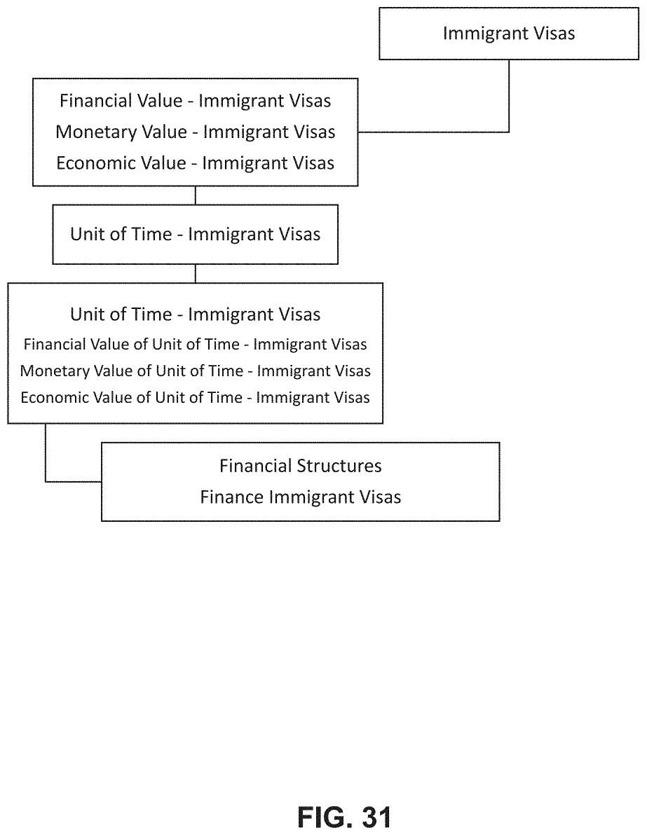

FIG. 31 illustrates a monetization structure and/or financial structure using immigrant visas financial structures to finance immigrant visas for job creation and economic in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

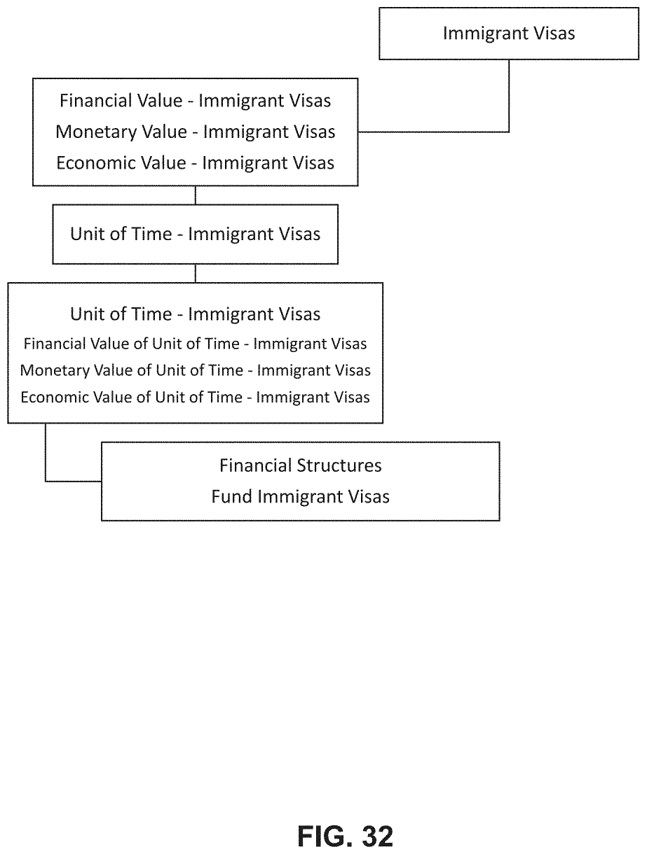

FIG. 32 illustrates a monetization structure and/or financial structure using immigrant visas financial structures to fund immigrant visas for job creation and economic in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

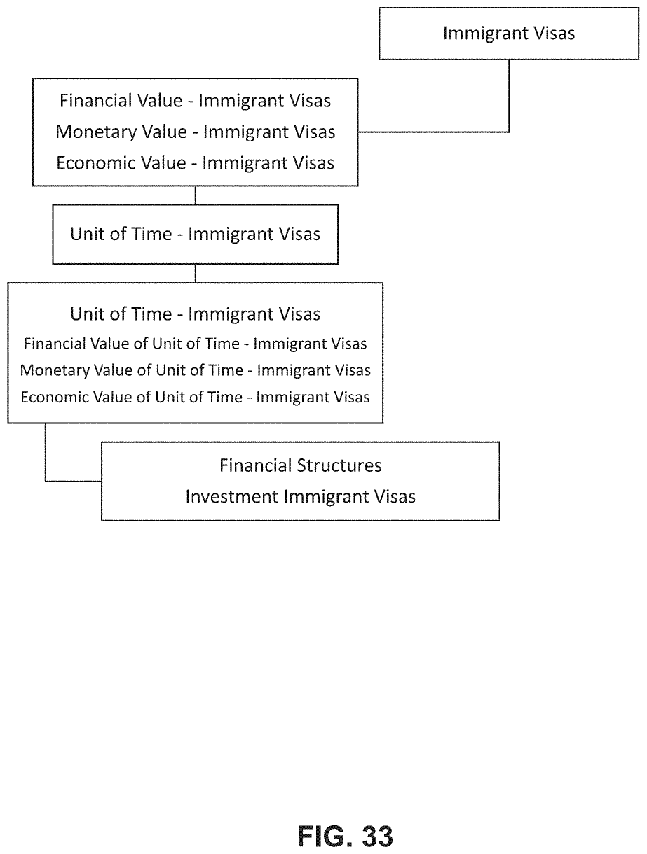

FIG. 33 illustrates a monetization structure and/or financial structure using immigrant visas financial structures for investment involving immigrant visas for job creation and economic in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

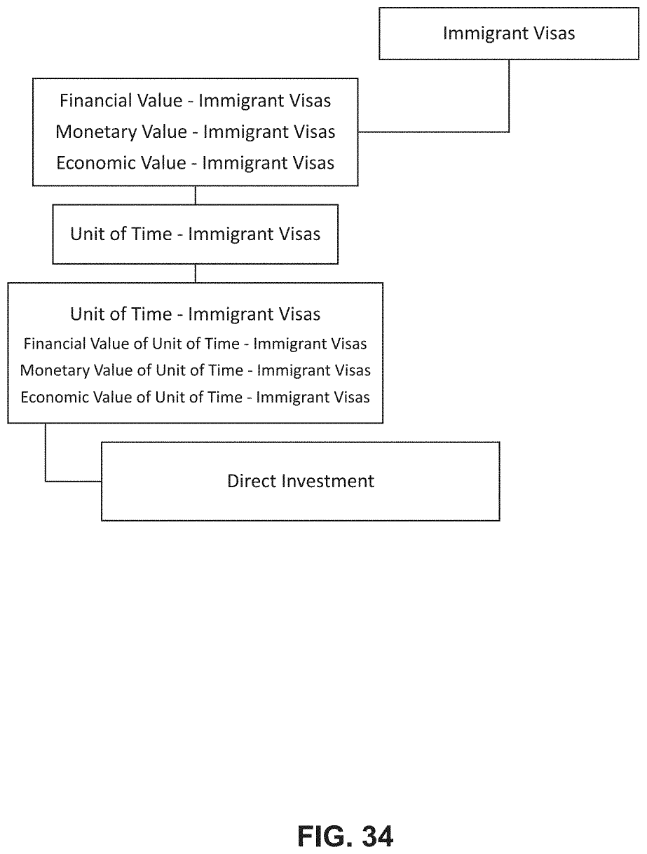

FIG. 34 illustrates a monetization structure and/or financial structure using immigrant visas for financing, funding and/or investment using direct investment for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

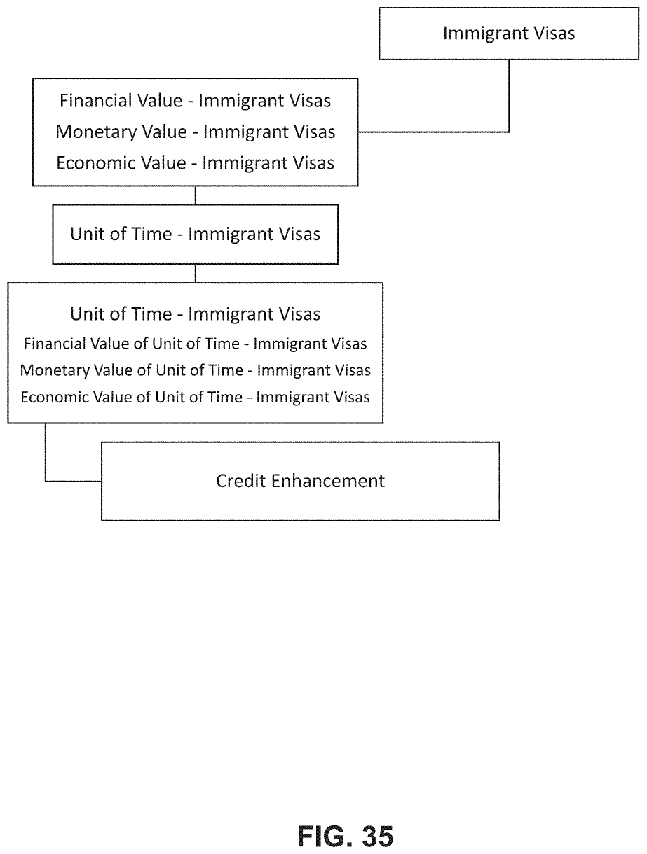

FIG. 35 illustrates a monetization structure and/or financial structure using immigrant visas for financing, funding and/or investment using credit enhancement for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

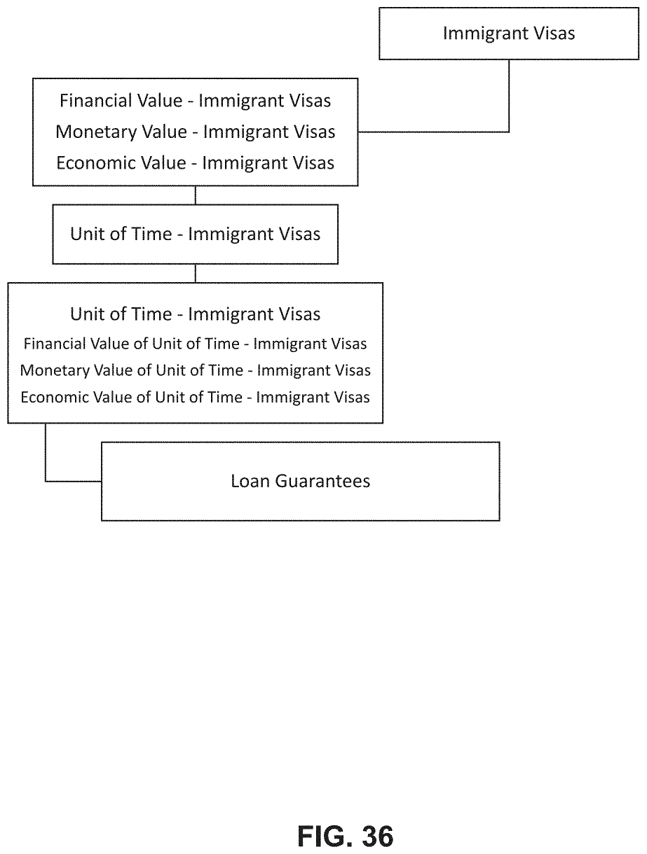

FIG. 36 illustrates a monetization structure and/or financial structure using immigrant visas for financing, funding and/or investment using loan guarantees for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

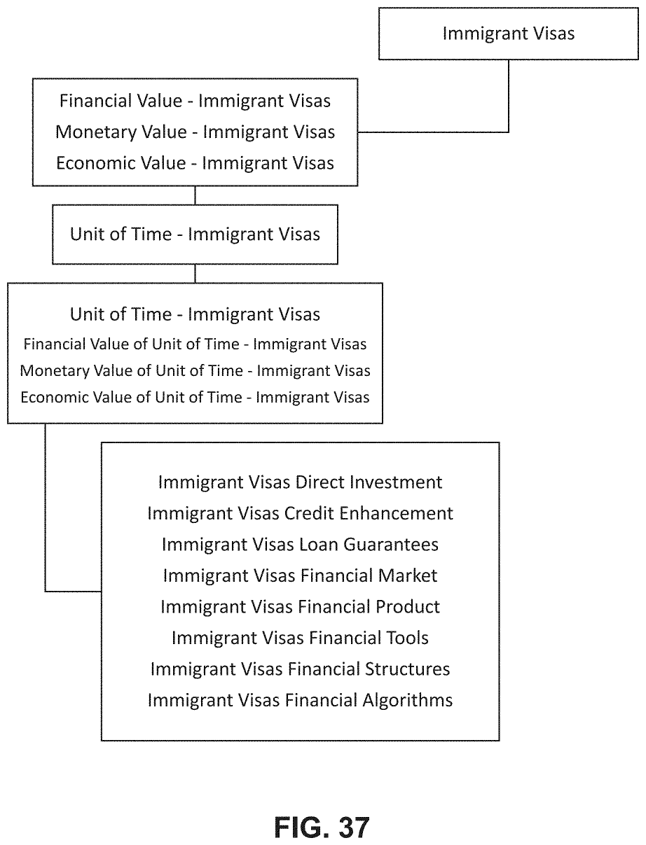

FIG. 37 illustrates a monetization structure and/or financial structure using immigrant visas for financing, funding and/or investment using direct investment, credit enhancement, loan guarantee, financial market, financial product, financial tools, financial structures, financial algorithms for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

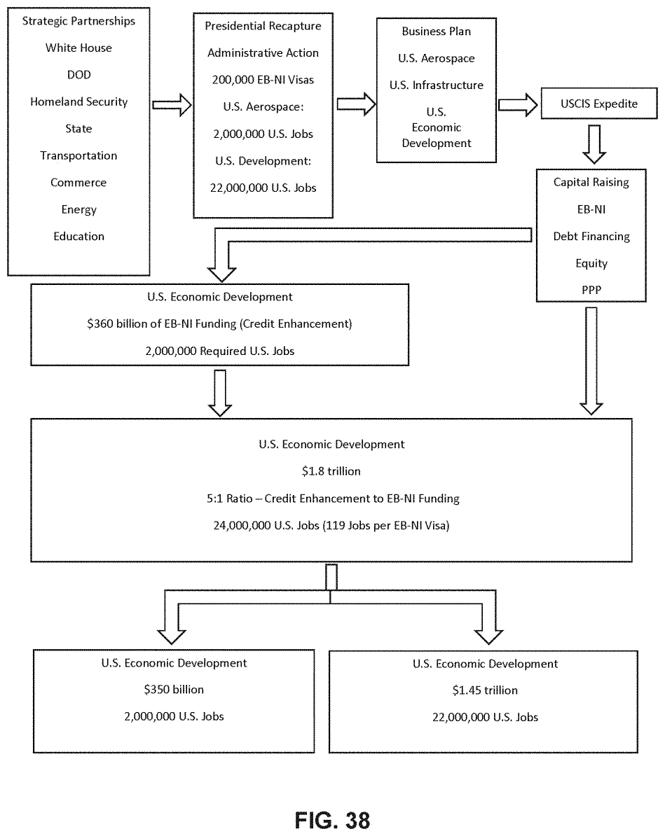

FIG. 38 illustrates a strategic overview an immigrant visa program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

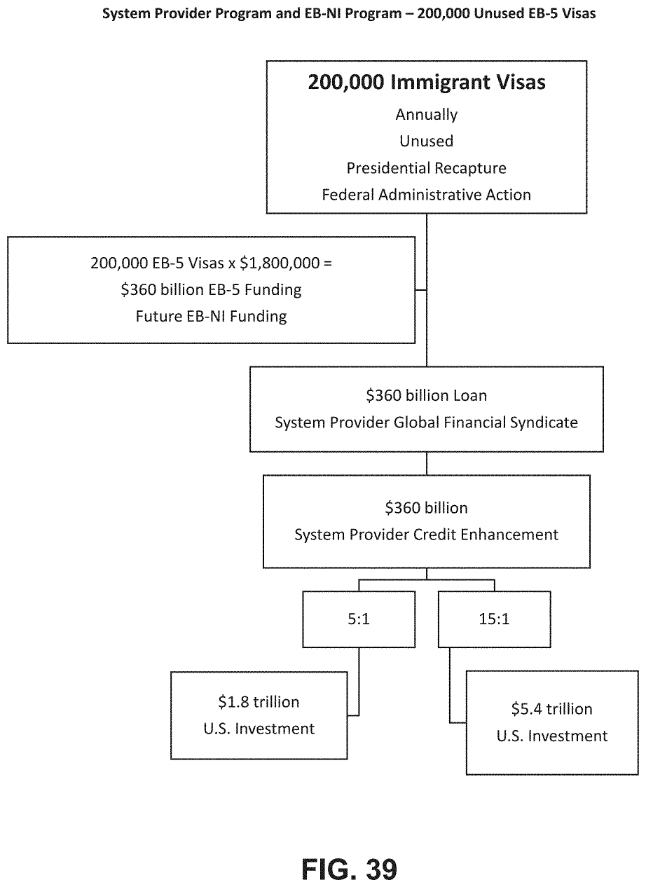

FIG. 39 illustrates a strategic overview an immigrant visa program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

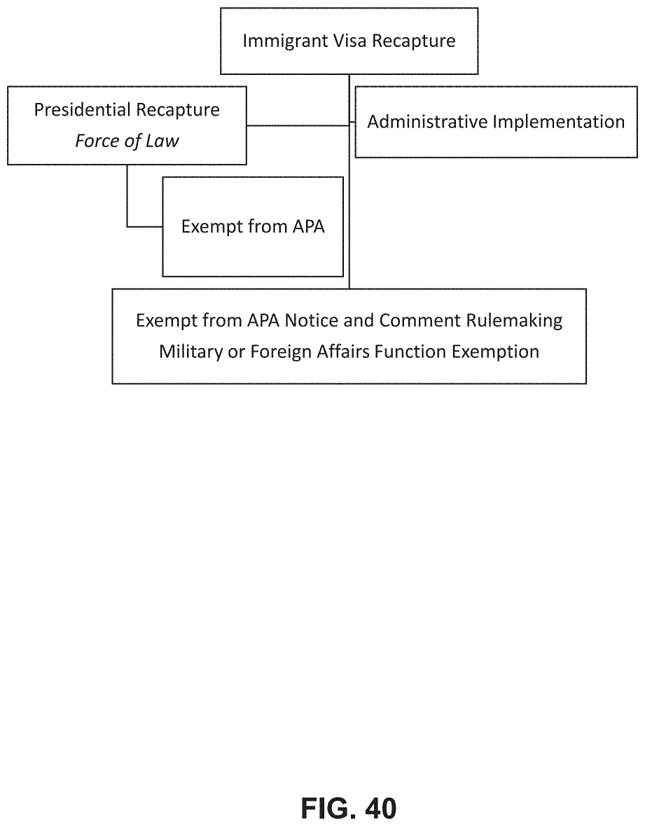

FIG. 40 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

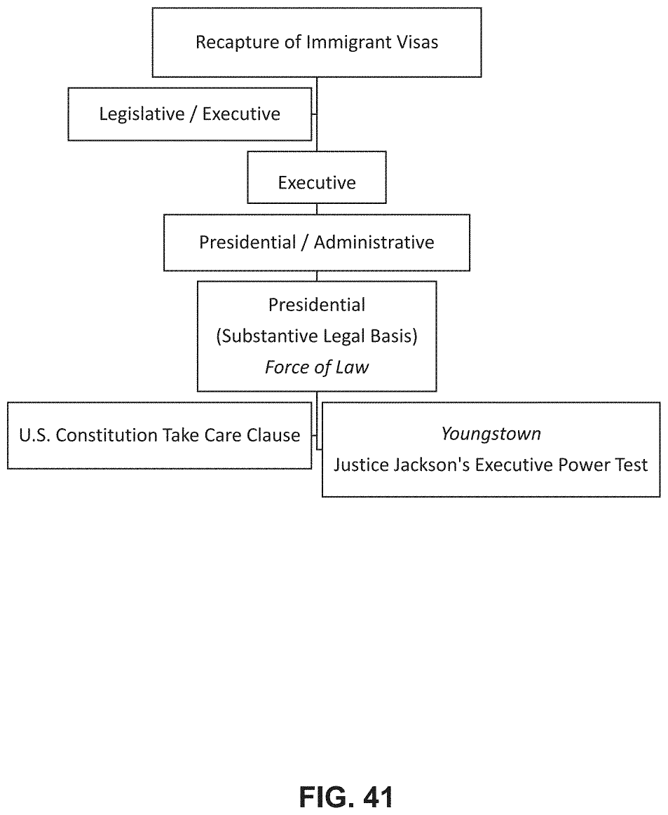

FIG. 41 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

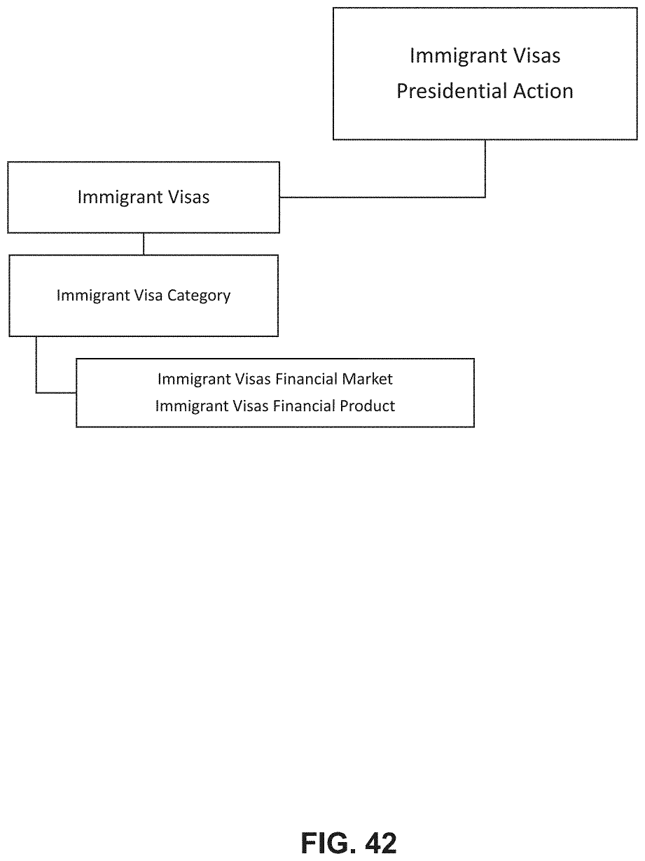

FIG. 42 illustrates a strategic overview an immigrant visa program enabled implementation with presidential action in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

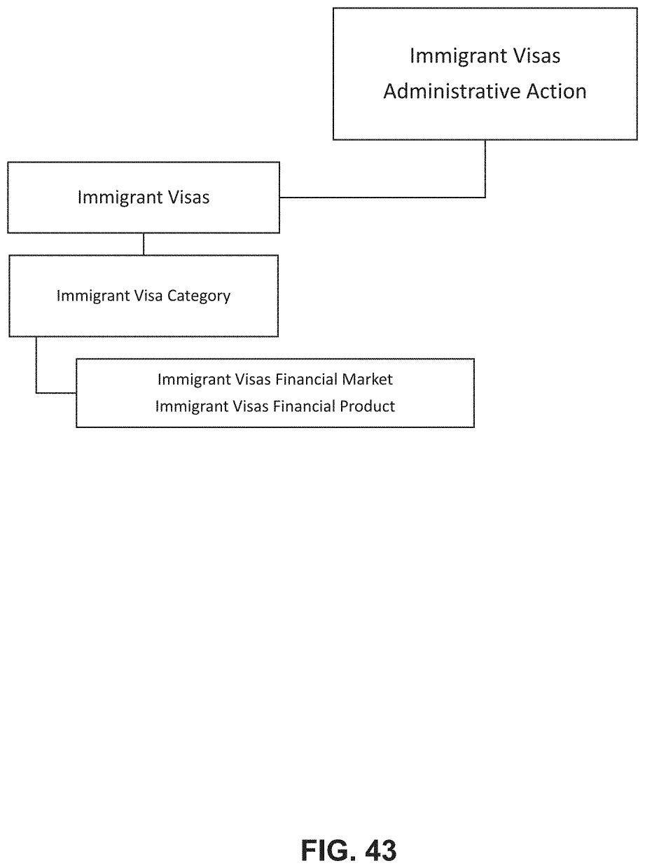

FIG. 43 illustrates a strategic overview an immigrant visa program enabled implementation with administrative action in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

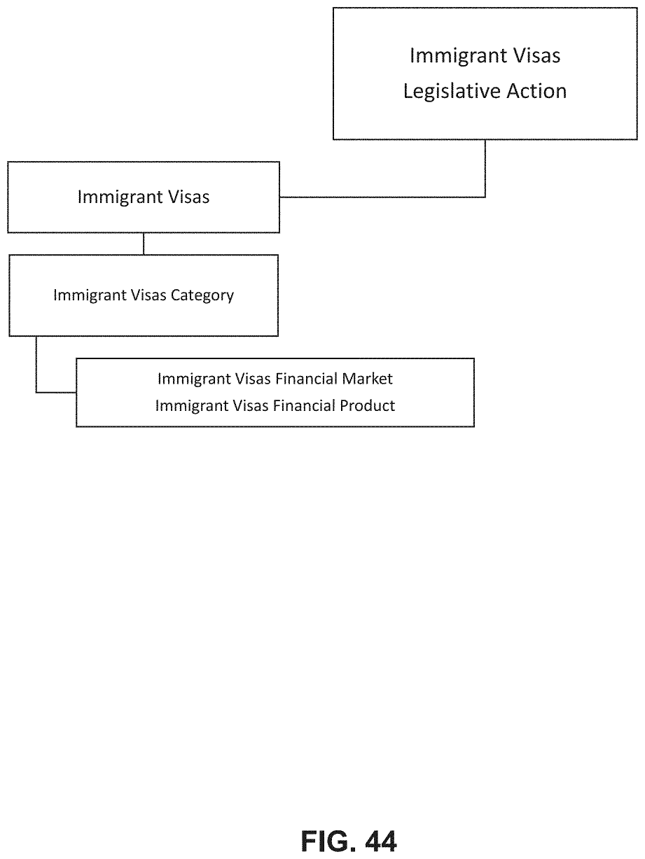

FIG. 44 illustrates a strategic overview an immigrant visa program enabled implementation with legislative action in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

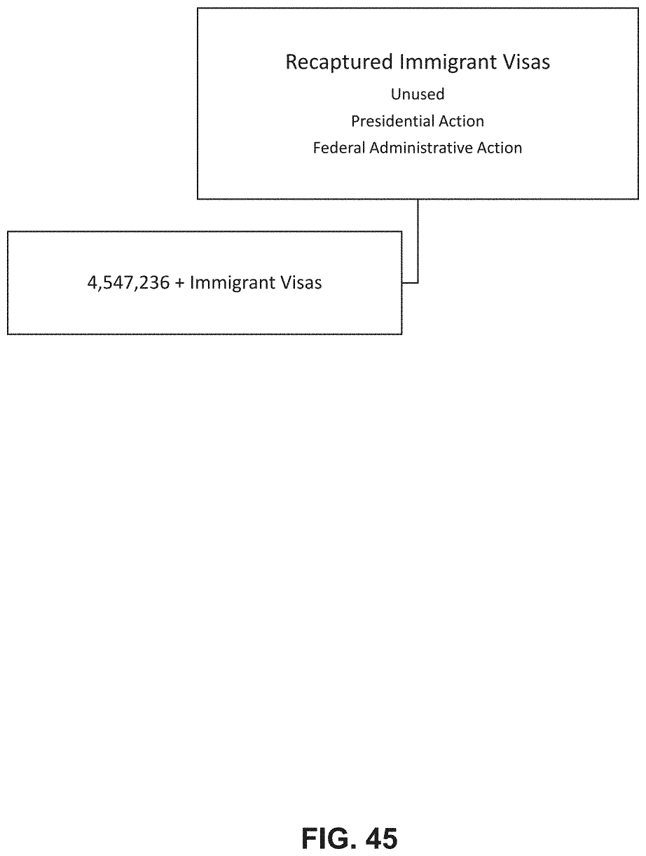

FIG. 45 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

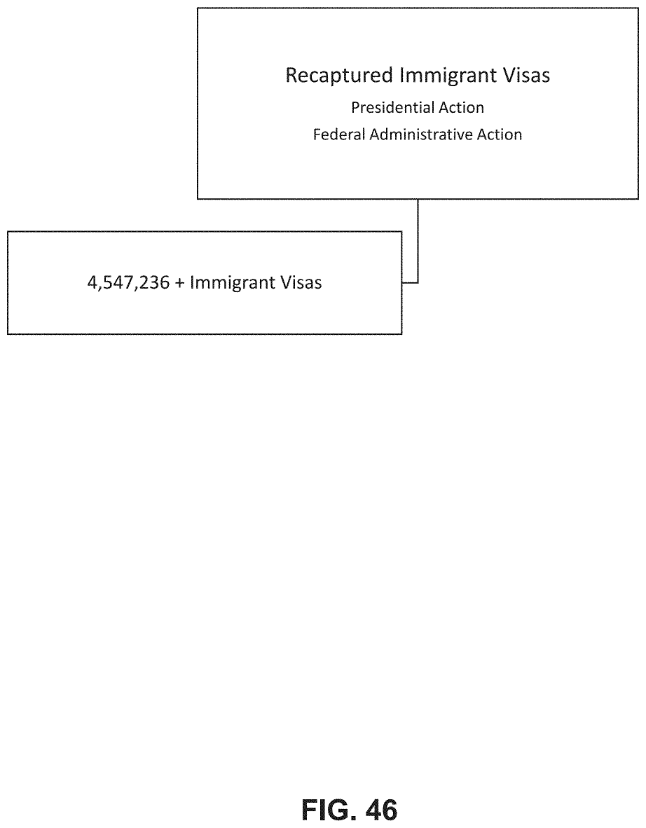

FIG. 46 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

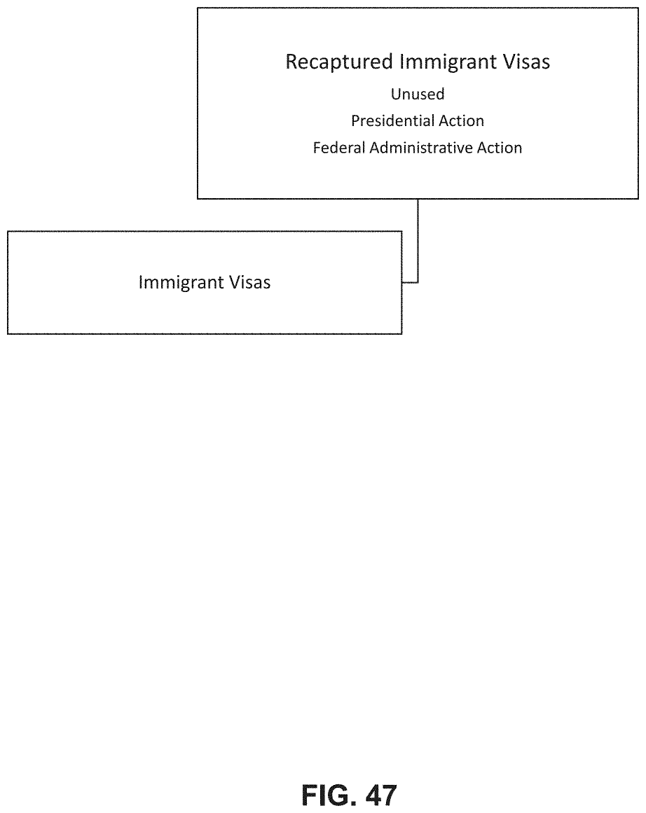

FIG. 47 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

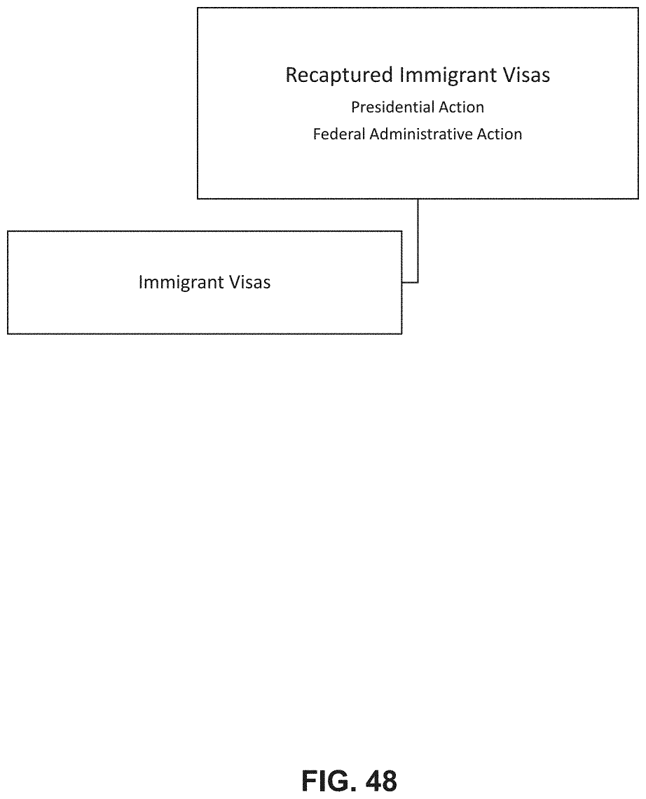

FIG. 48 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

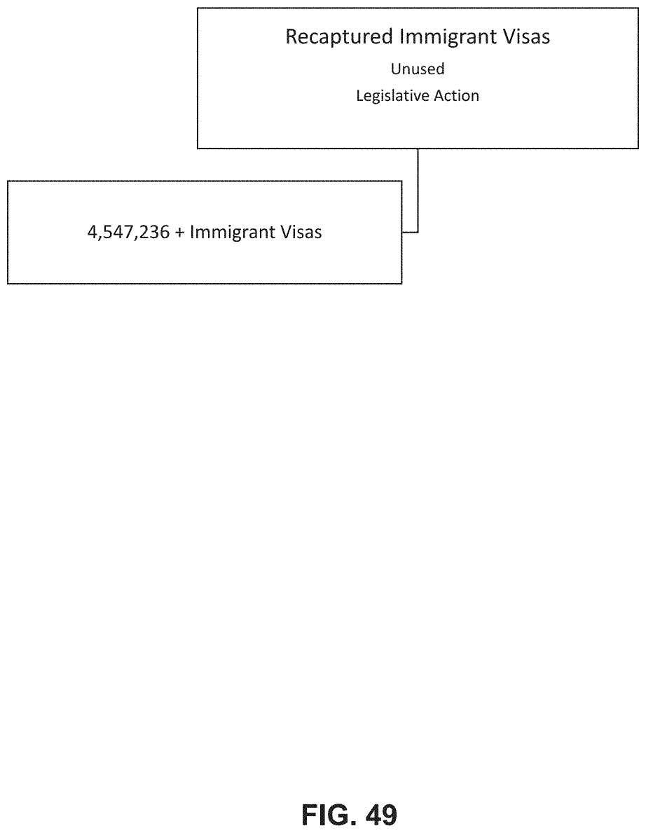

FIG. 49 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

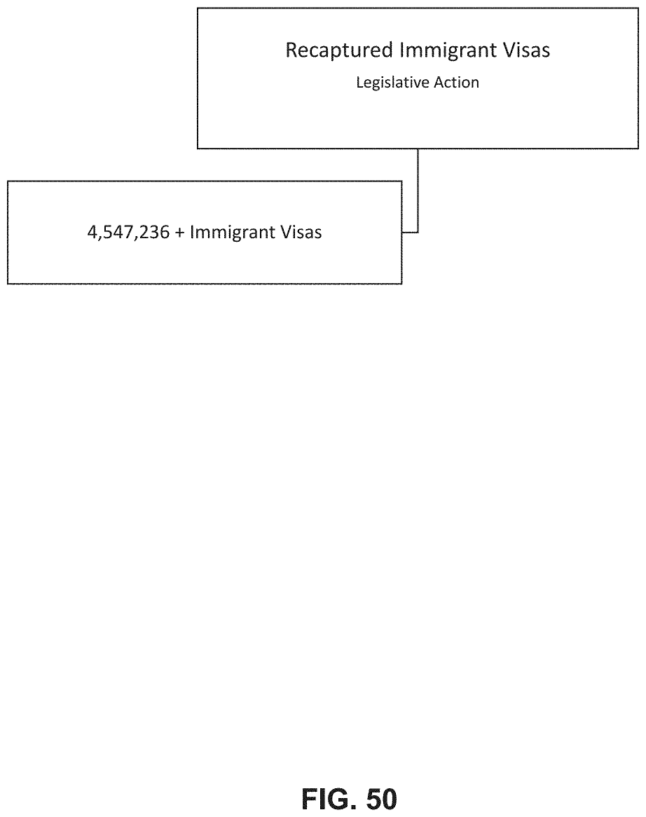

FIG. 50 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

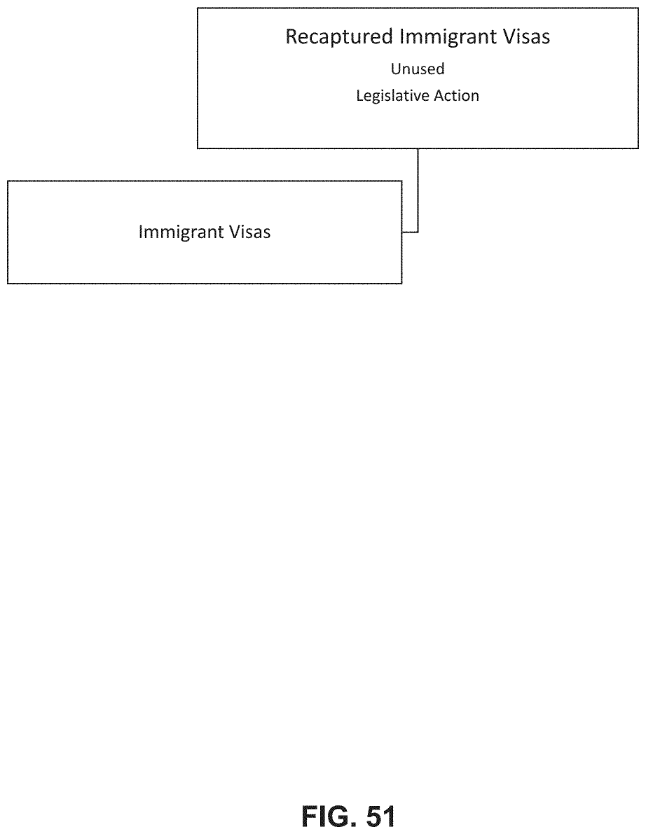

FIG. 51 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

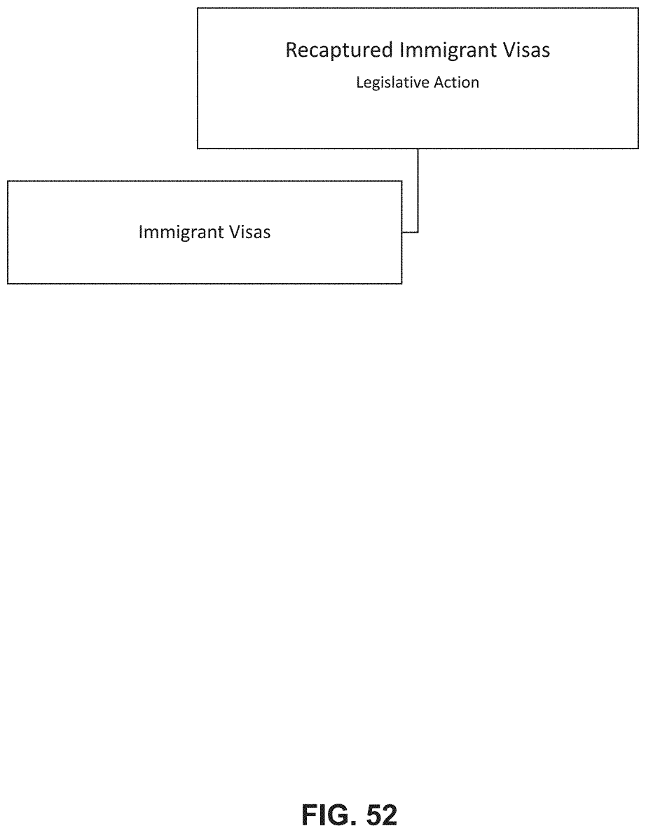

FIG. 52 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

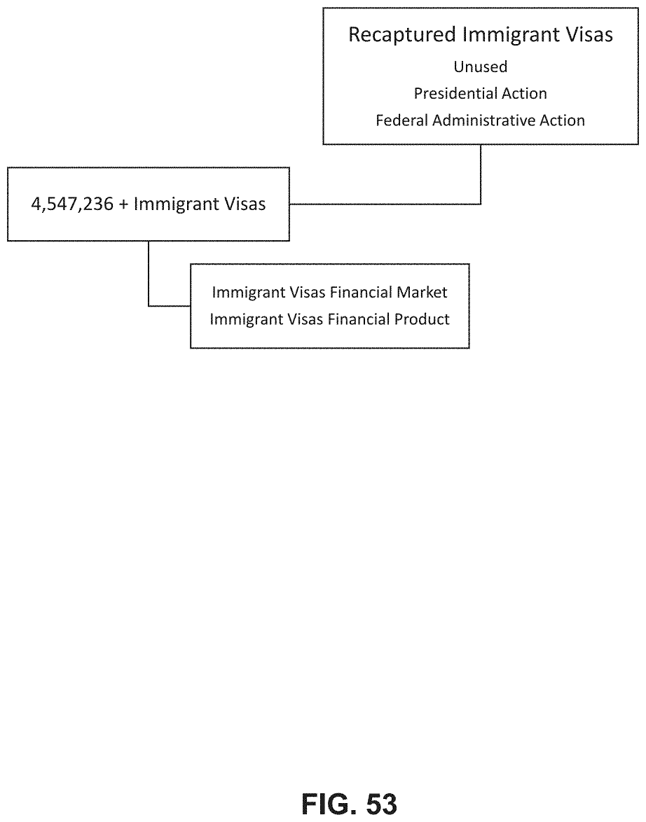

FIG. 53 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

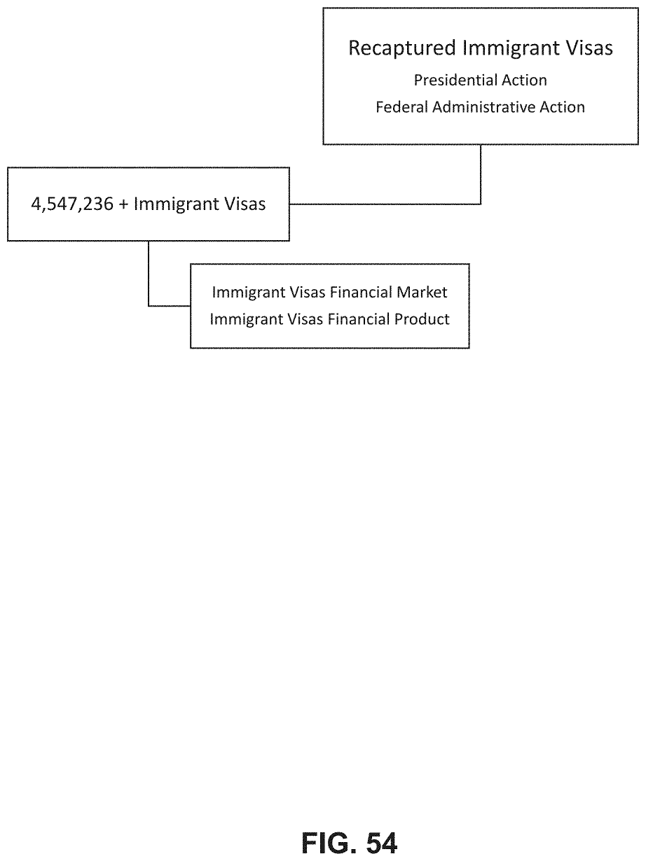

FIG. 54 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

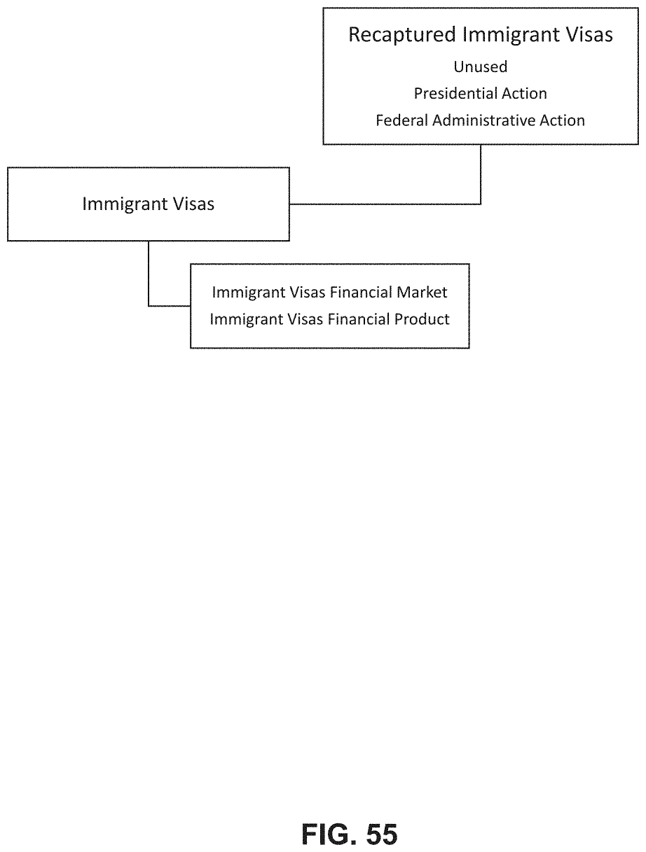

FIG. 55 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

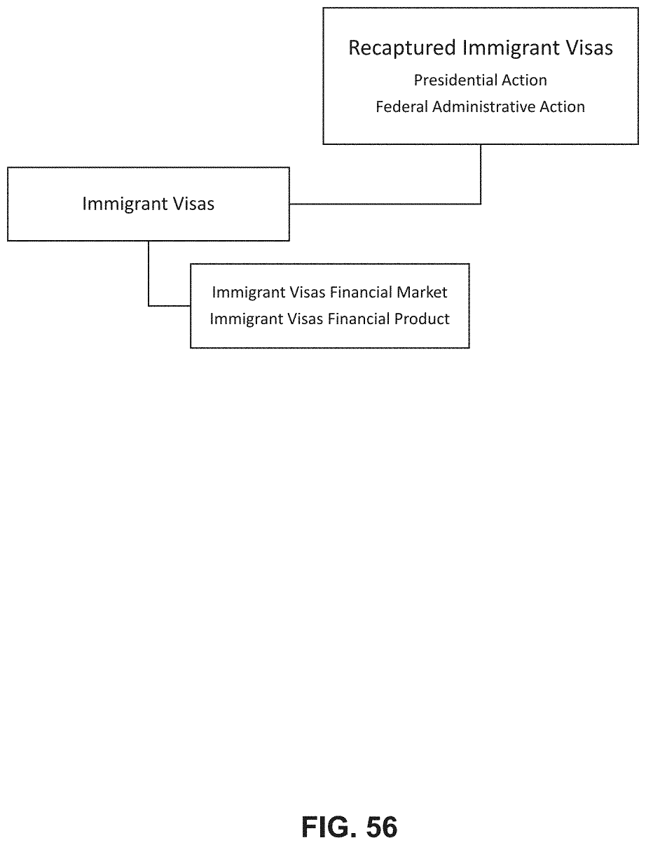

FIG. 56 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

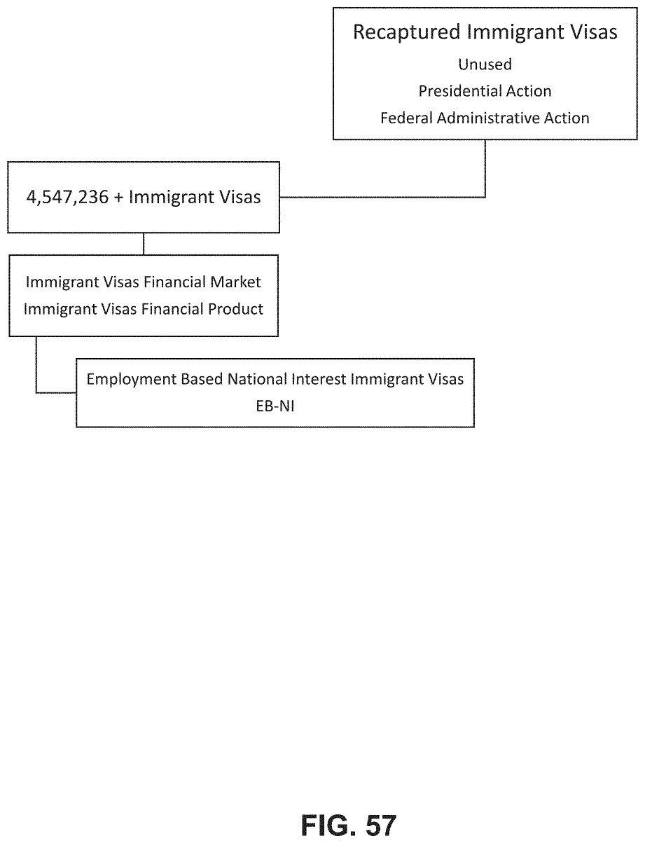

FIG. 57 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

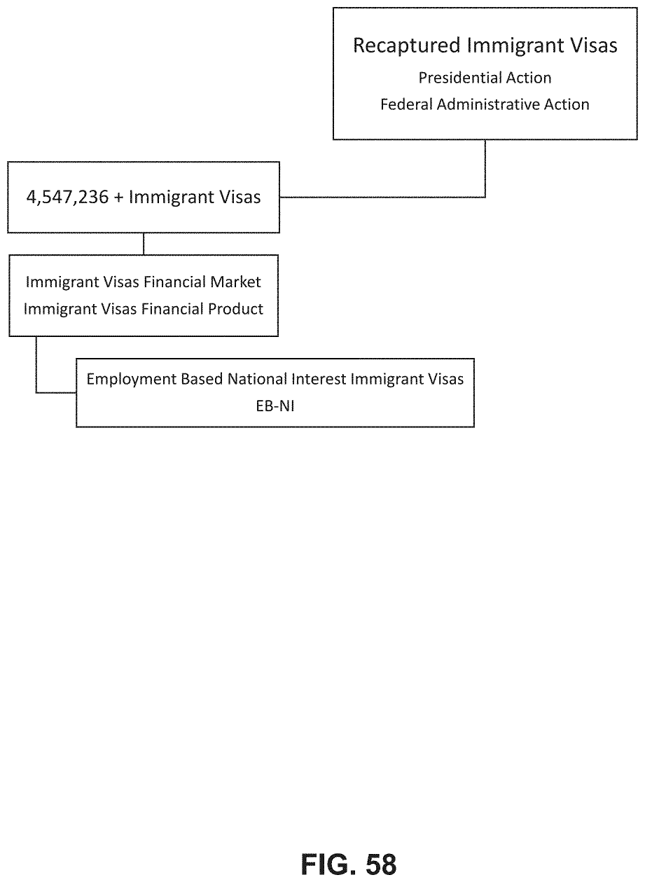

FIG. 58 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

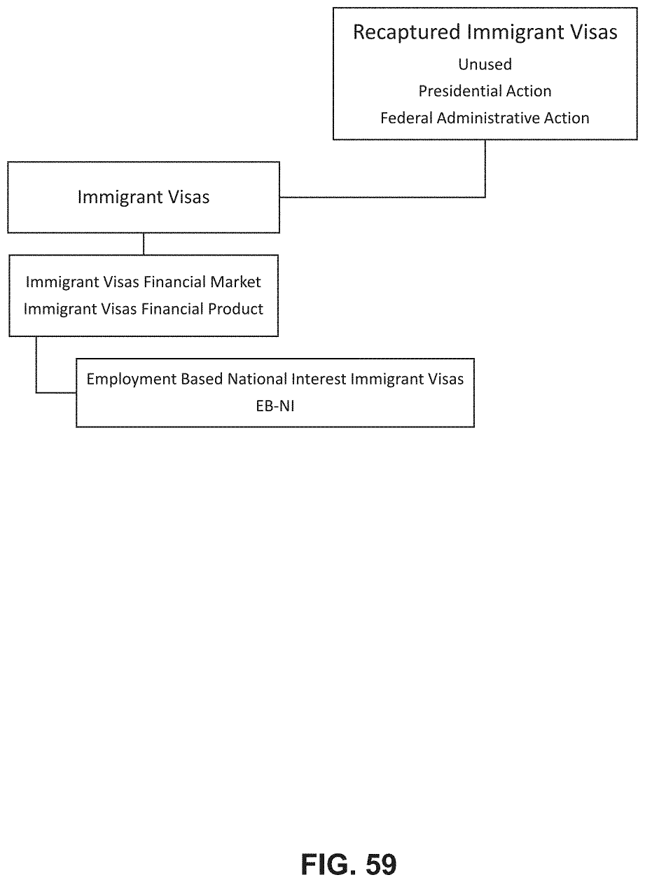

FIG. 59 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

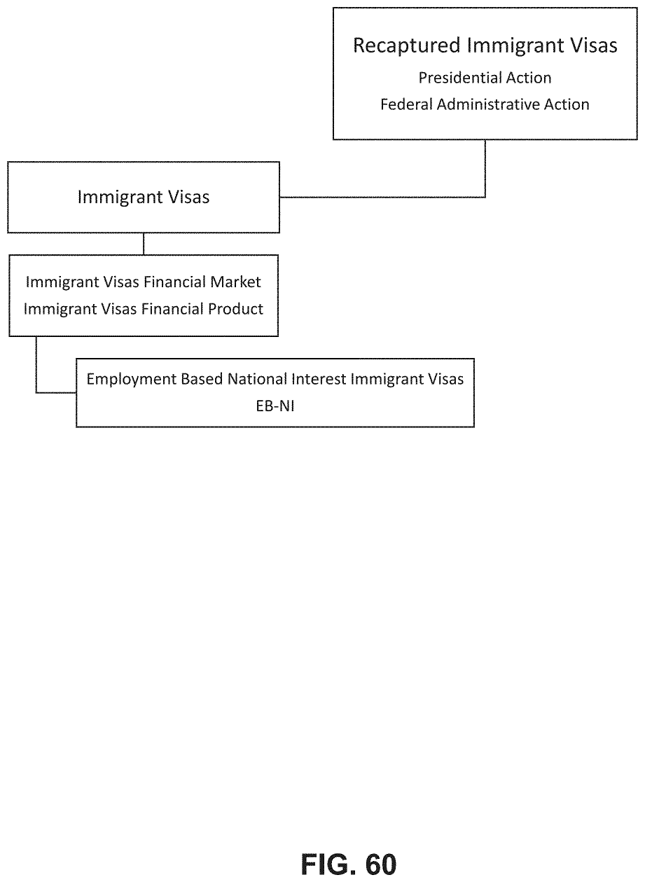

FIG. 60 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

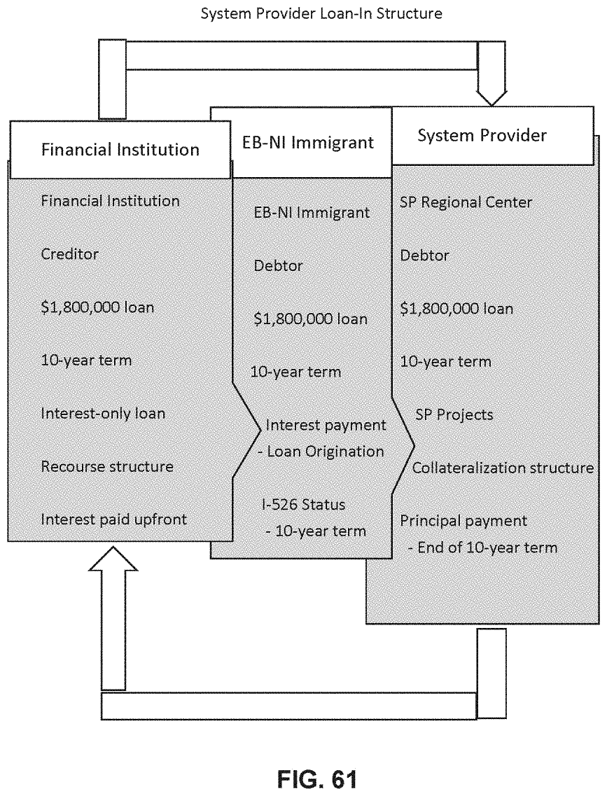

FIG. 61 illustrates a monetization structure and/or financial structure using immigrant visas for financing, funding and/or investment using a financing and loan model for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

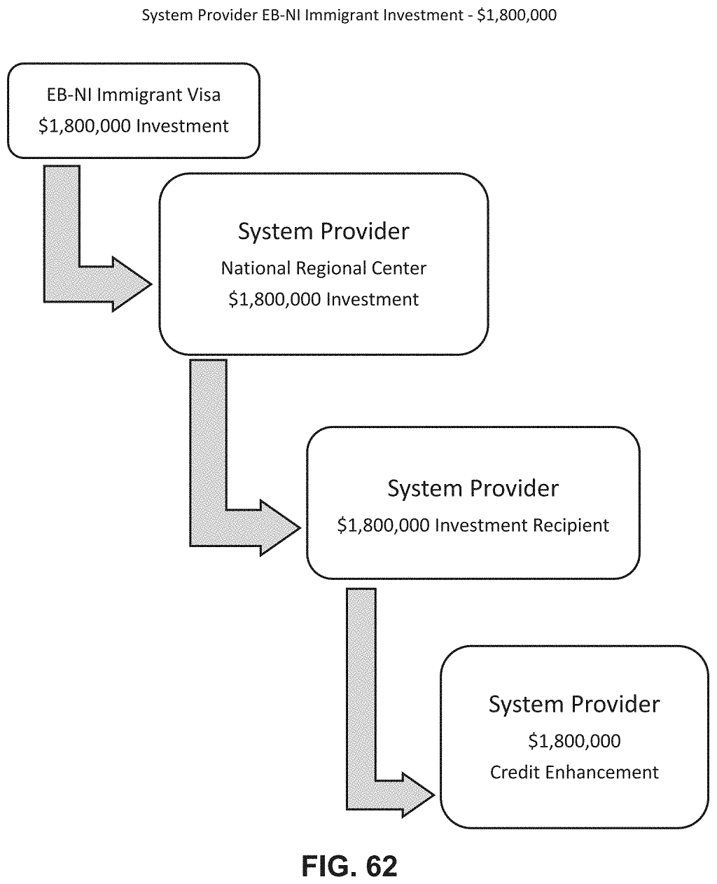

FIG. 62 illustrates a monetization structure and/or financial structure using immigrant visas for financing, funding and/or investment for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

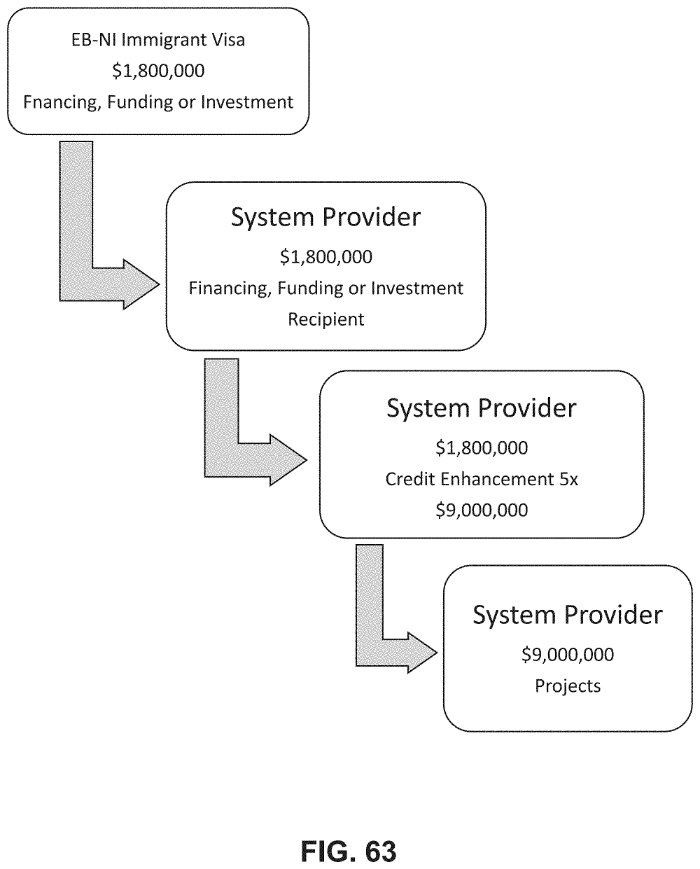

FIG. 63 illustrates a monetization structure and/or financial structure using immigrant visas for financing, funding and/or investment for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

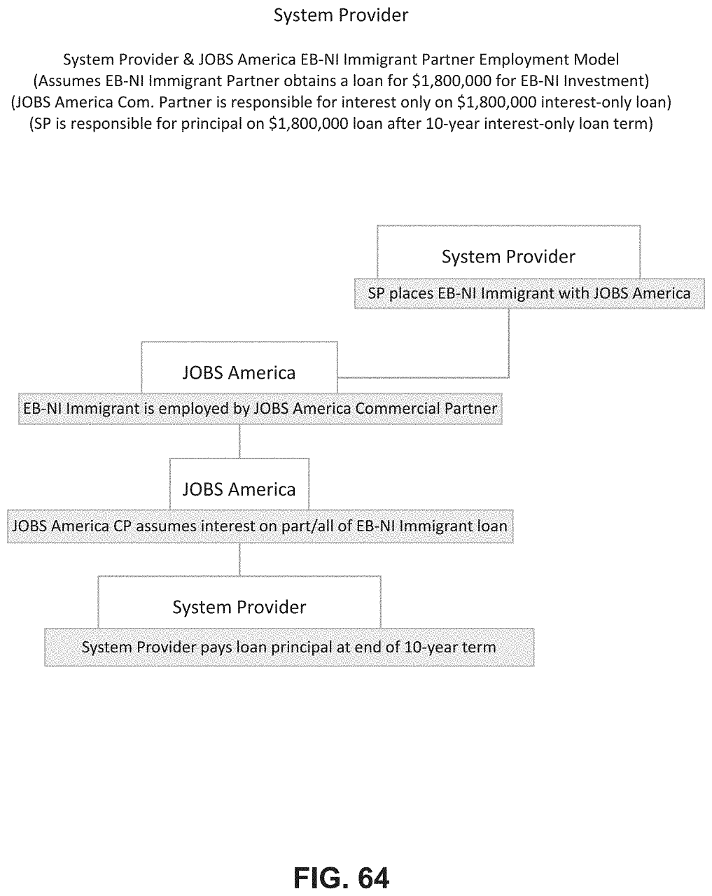

FIG. 64 illustrates a strategic overview of an immigrant visa program enabled implementation and job creation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

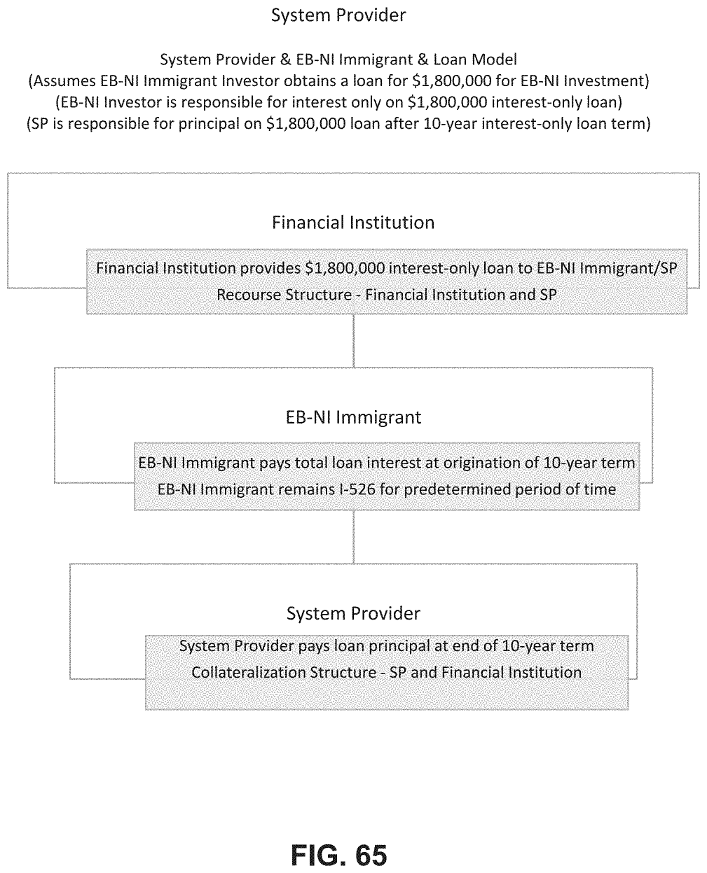

FIG. 65 illustrates a strategic overview of an immigrant visa program enabled implementation and job creation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

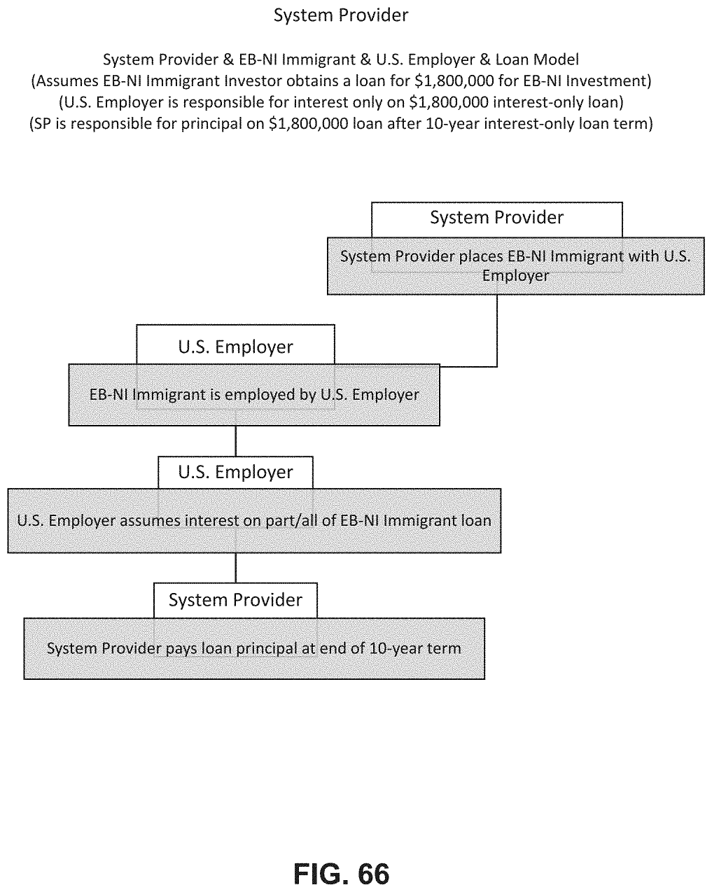

FIG. 66 illustrates a strategic overview of an immigrant visa program enabled implementation and job creation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

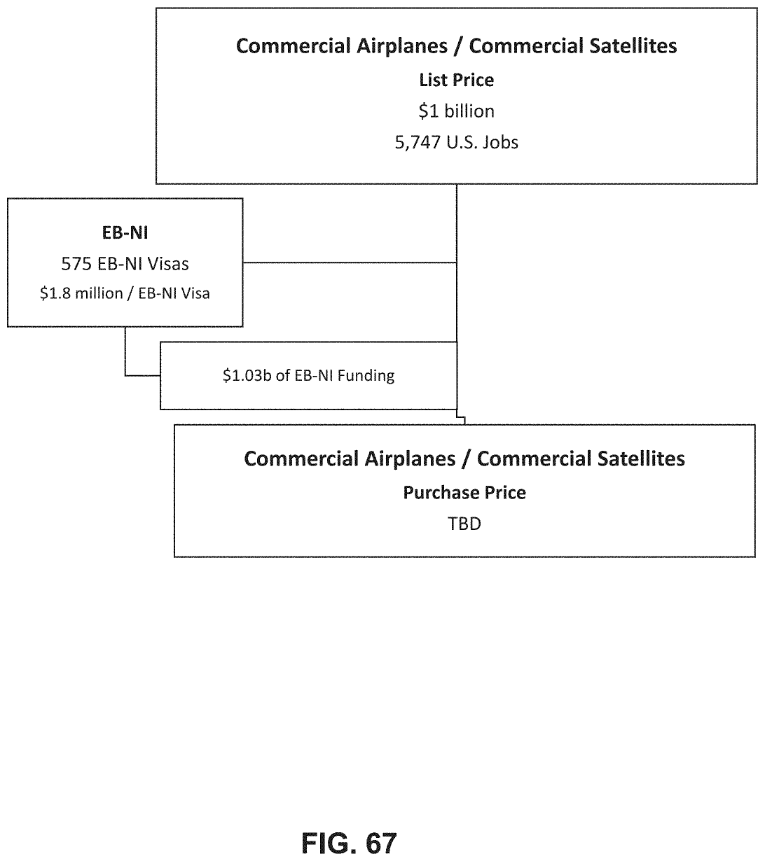

FIG. 67 illustrates a strategic overview of an immigrant visa program enabled implementation and job creation using commercial airplanes or commercial satellites in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

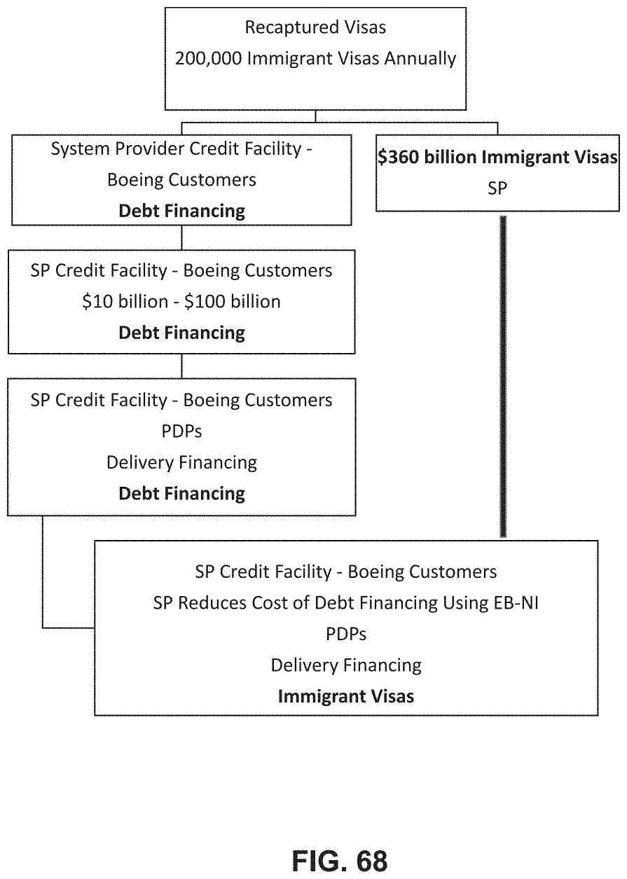

FIG. 68 illustrates a monetization structure and/or financial structure using immigrant visas for financing, funding and/or investment for job creation and economic development using Boeing® products and Boeing® customers in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

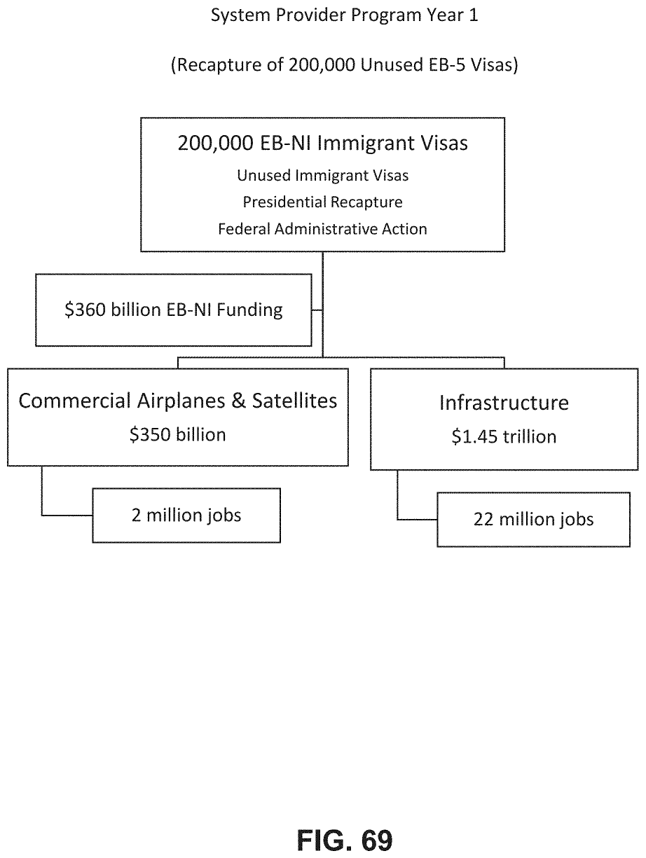

FIG. 69 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

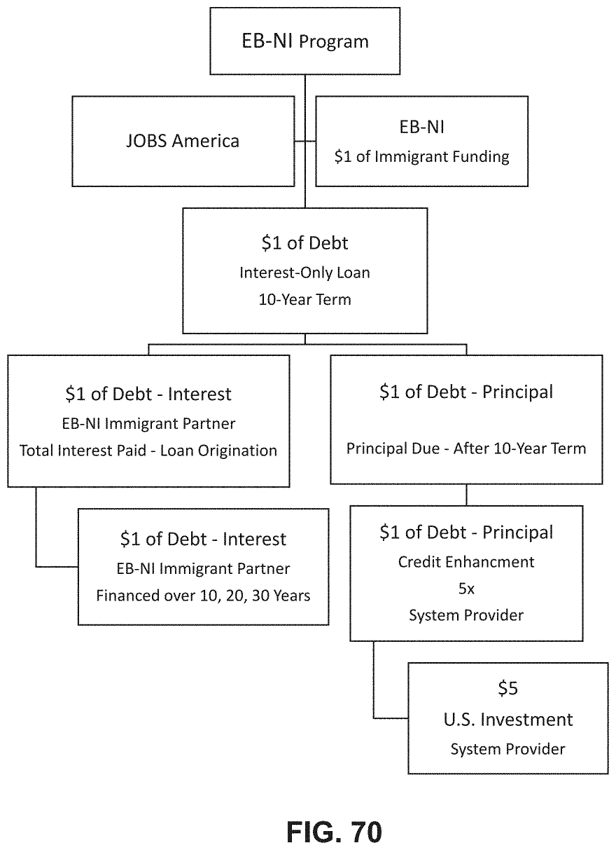

FIG. 70 illustrates a monetization structure and/or financial structure using immigrant visas for financing, funding and/or investment for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

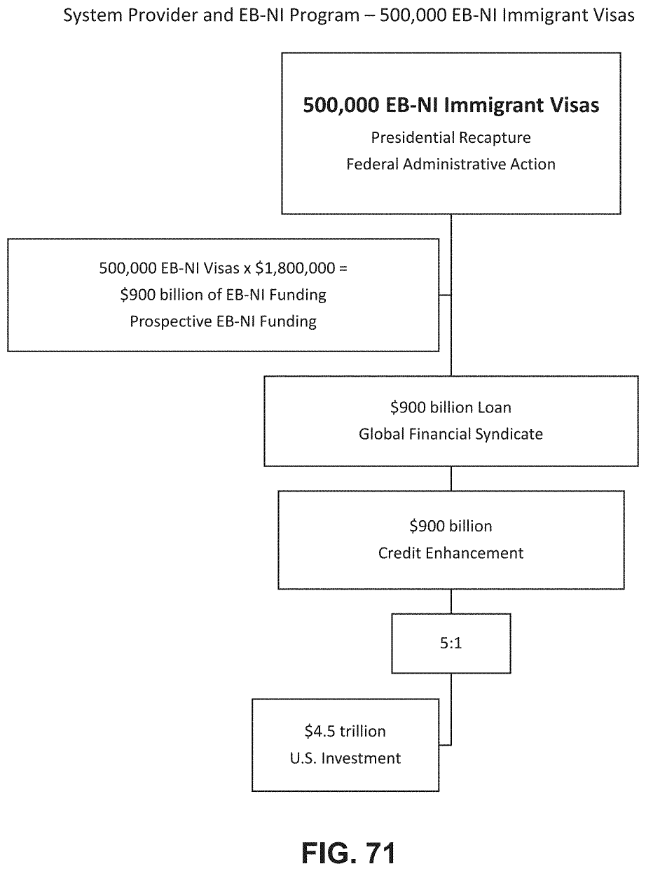

FIG. 71 illustrates a monetization structure and/or financial structure using immigrant visas for financing, funding and/or investment for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

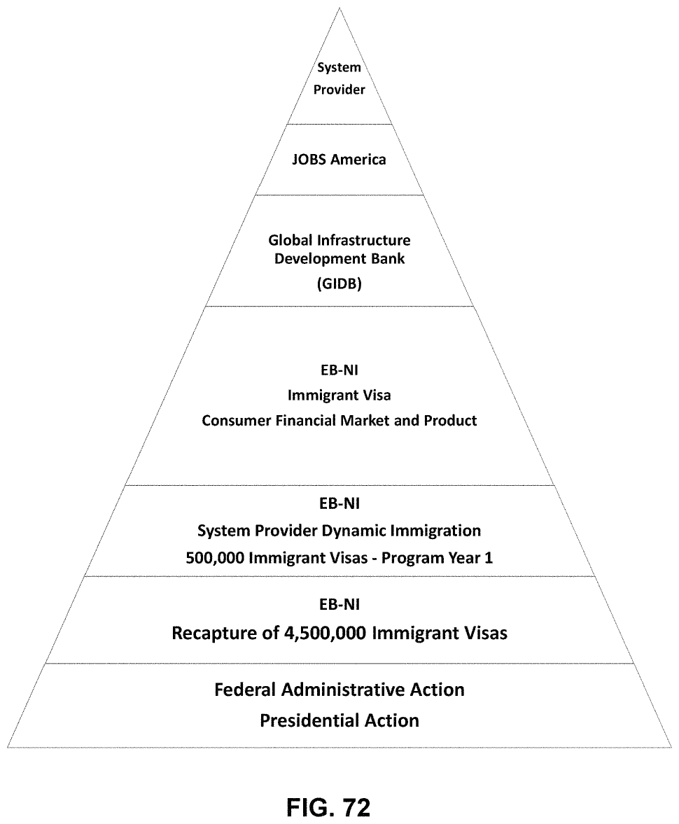

FIG. 72 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

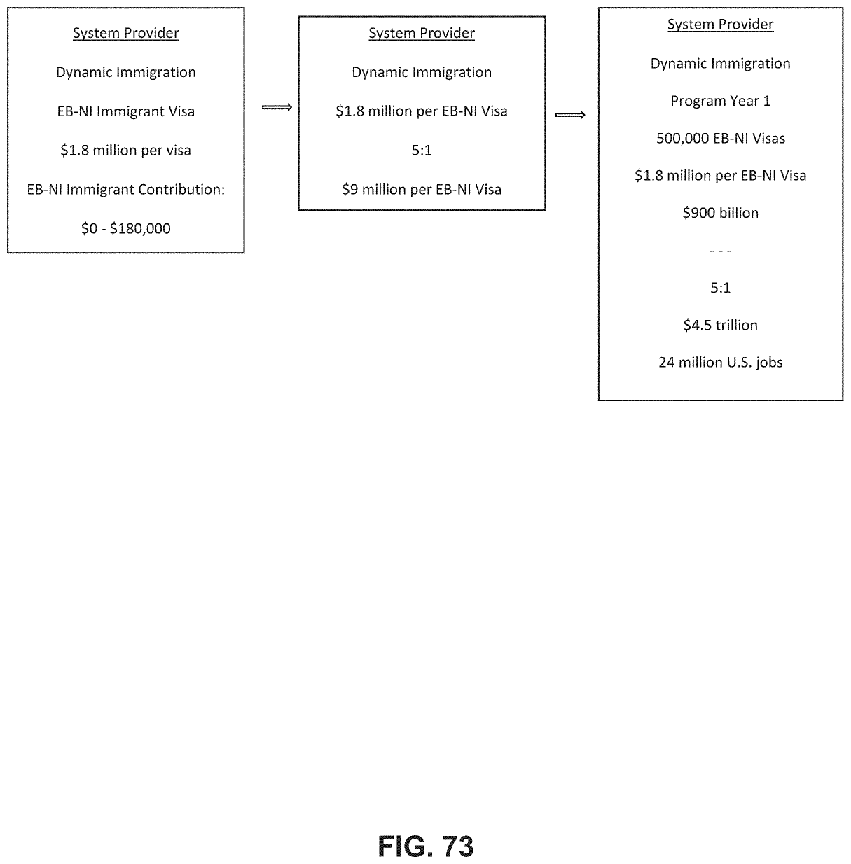

FIG. 73 illustrates a monetization structure and/or financial structure using immigrant visas for financing, funding and/or investment for job creation and economic development in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

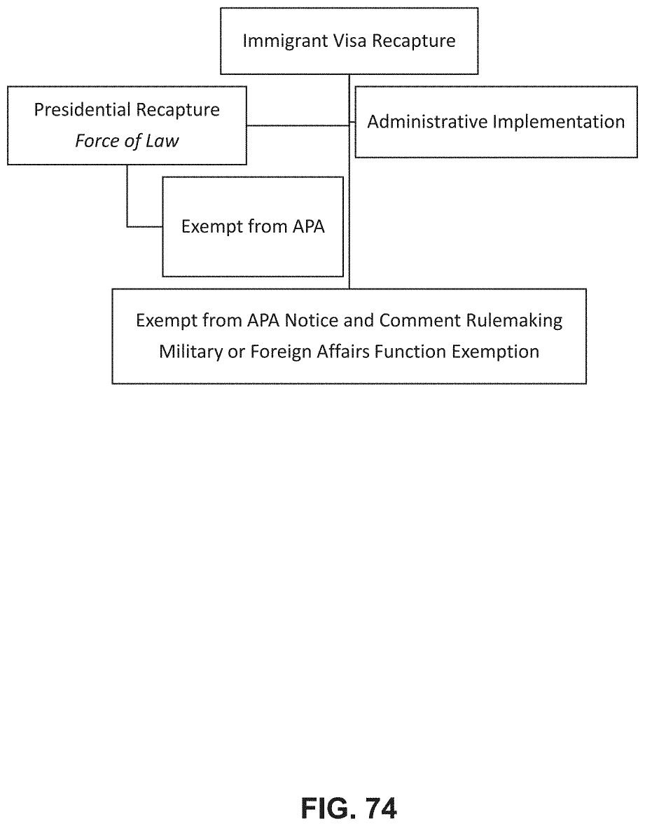

FIG. 74 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

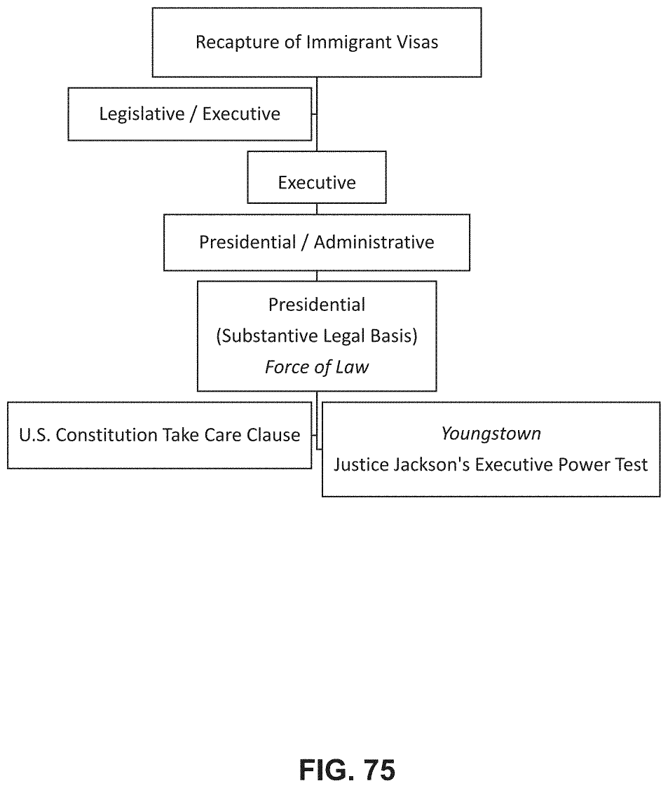

FIG. 75 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

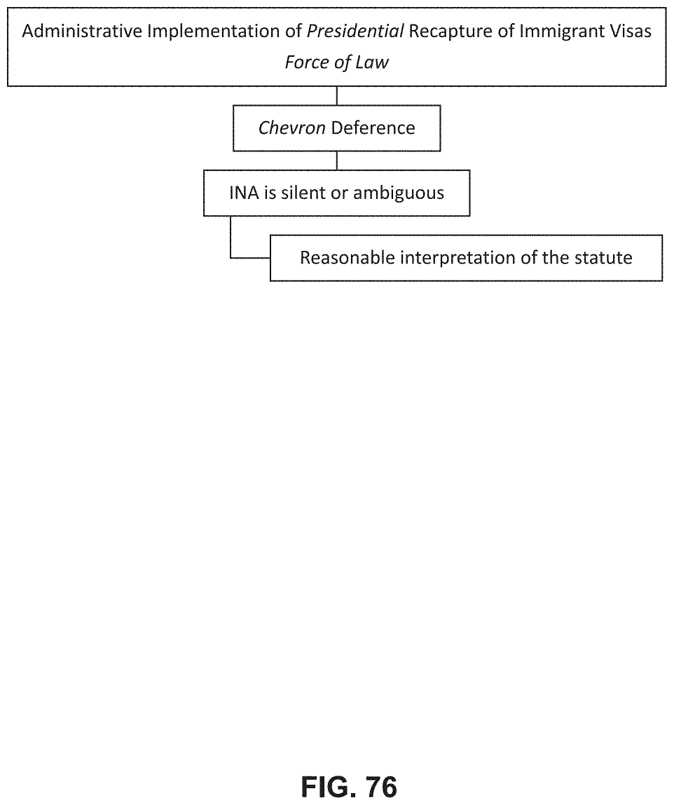

FIG. 76 illustrates a strategic overview an immigrant visa recapture program enabled implementation in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

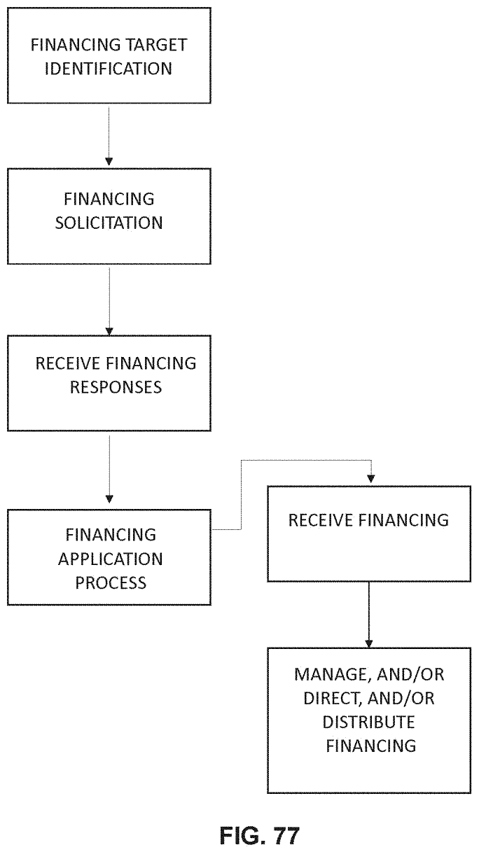

FIG. 77 illustrates a financing system process in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

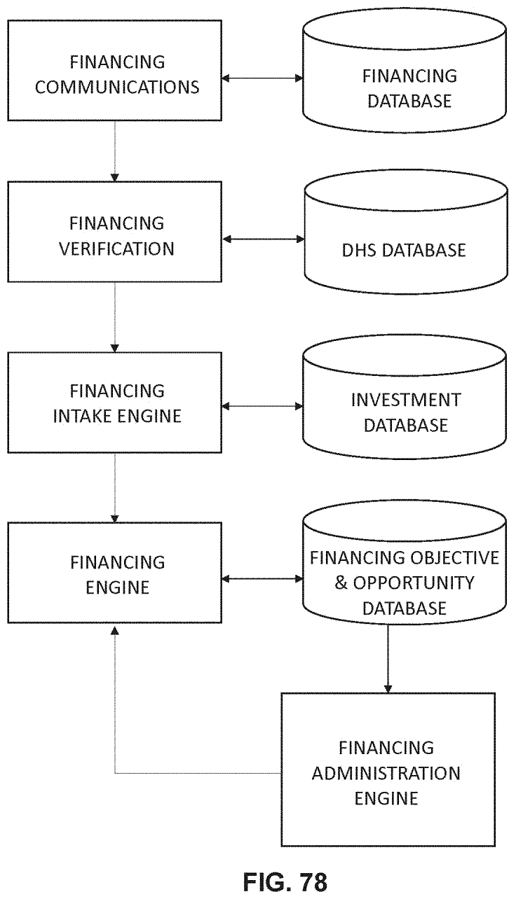

FIG. 78 illustrates a financing system process in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

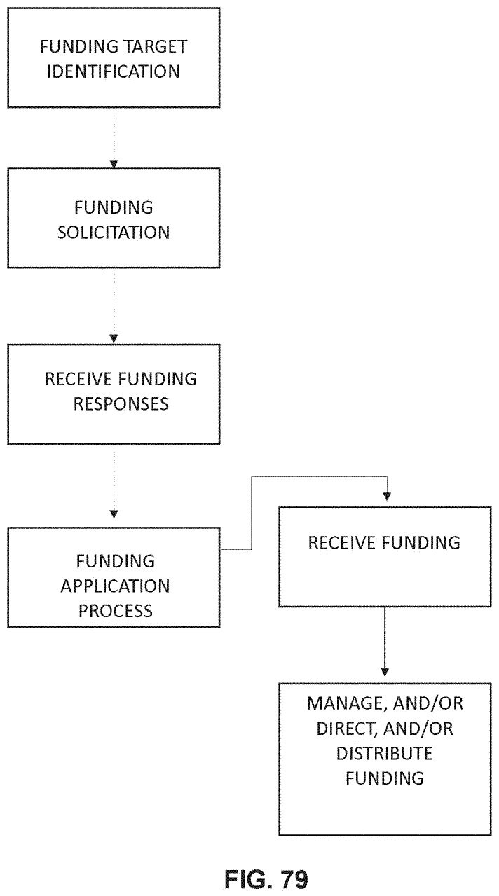

FIG. 79 illustrates a funding system process in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

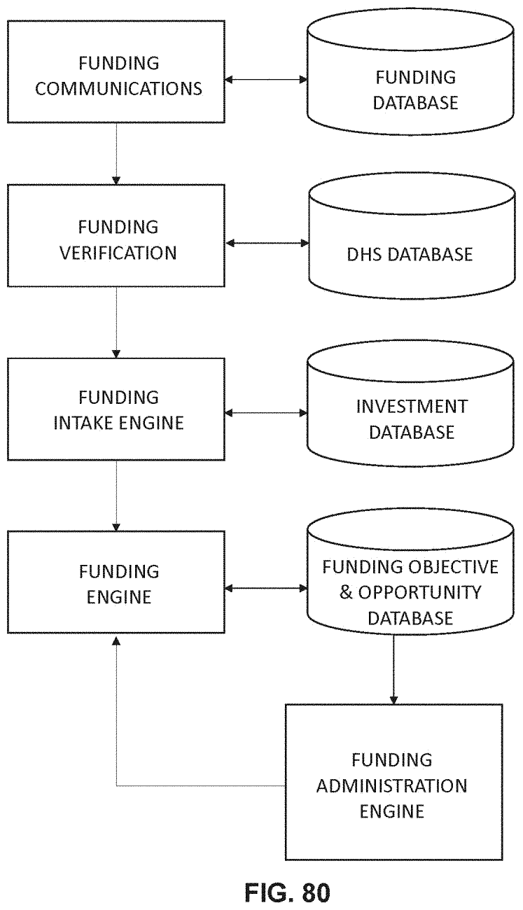

FIG. 80 illustrates a funding system process in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

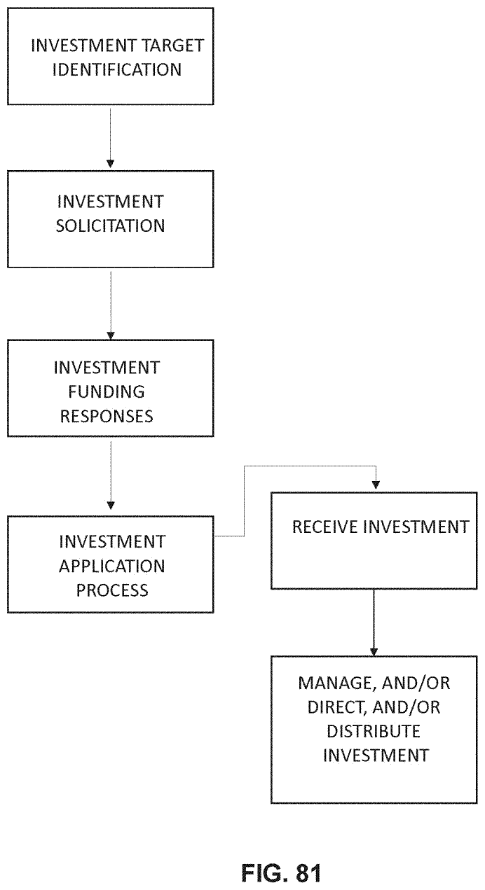

FIG. 81 illustrates an investor system process in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

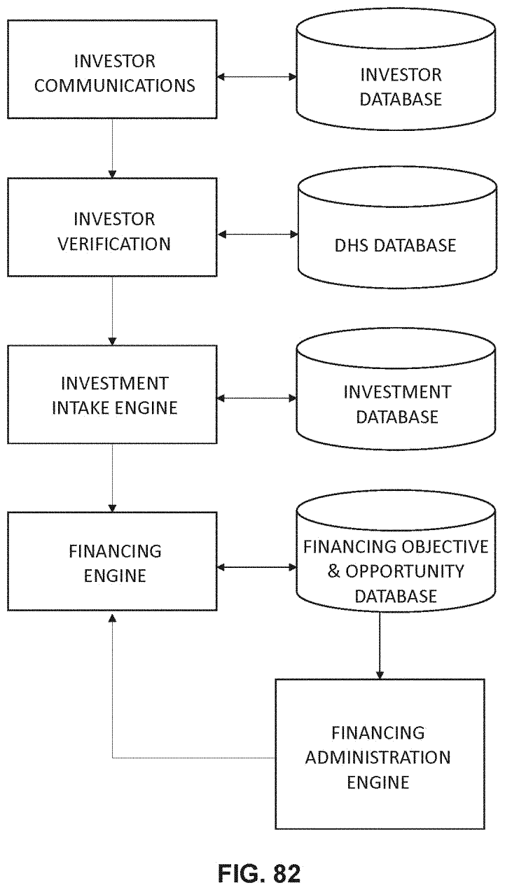

FIG. 82 illustrates an investor system process in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

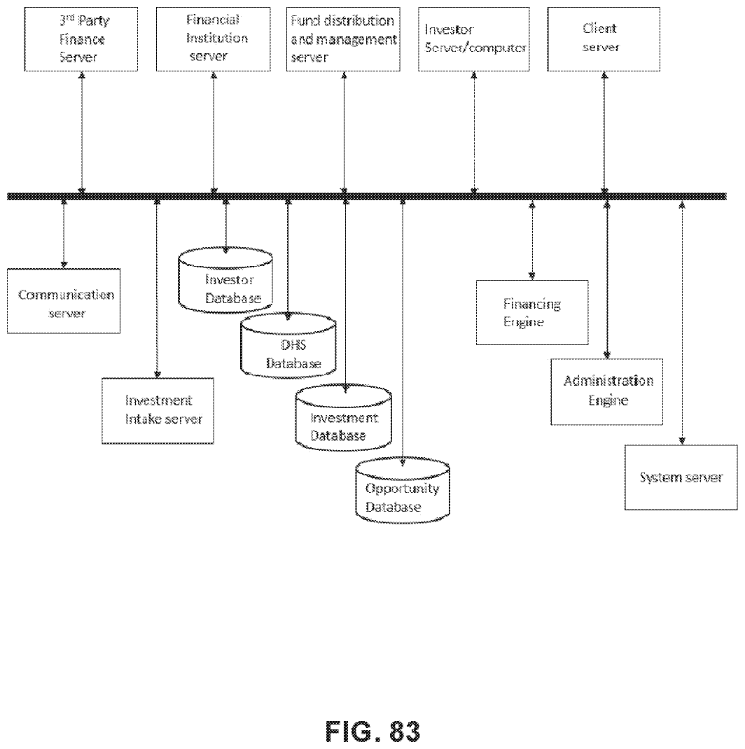

FIG. 83 illustrates a system network for performing the processes of FIGS. 74-79 in accordance with some embodiments of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

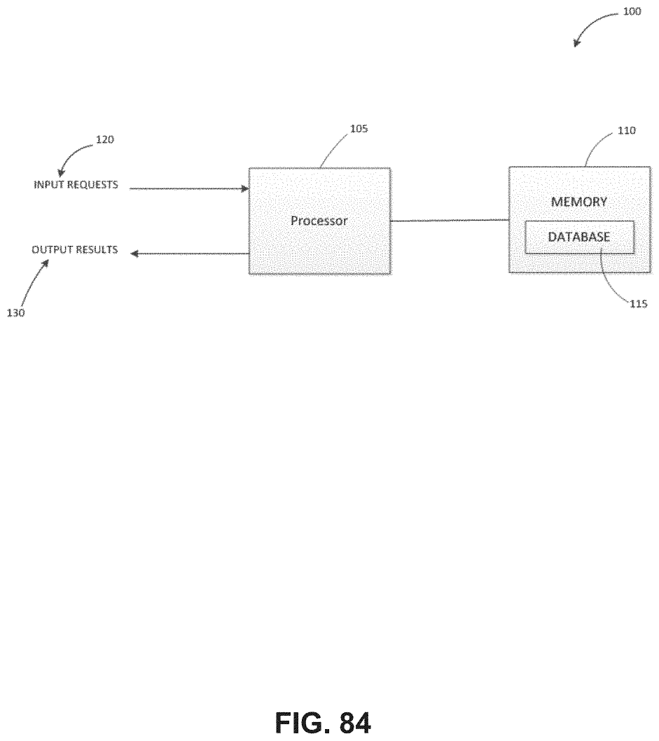

FIG. 84 shows a block diagram of a server system for implementing or operating any of the processes or methods of the invention. The figure illustrates one or more steps implemented by the system for a monetization structure and/or a financial structure involving immigrant visas for financing, funding or investment for job creation and economic development in accordance with some embodiments. In some embodiments, the system is configured to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas and fund immigrant visas. In some embodiments, the system is configured to aggregate, collect, process, store, and track immigrant visas. In some embodiments, the system is configured to identify one or more projects which match criteria and/or rules associated with immigrant visas.

Some embodiments include a computer-implemented system to automate and process the monetization of immigrant visas and/or non-immigrant visas and/or the financial structuring of immigrant visas and/or non-immigrant visas to develop, construct and support the legal and financial structuring of immigrant visas and non-immigrant visas for immigrant and non-immigrant visa financial markets, immigrant and non-immigrant visa financial products, immigrant and non-immigrant visa financial tools, immigrant and non-immigrant visa financial structures, and/or immigrant and non-immigrant visa financial algorithms to support economic development, job creation, direct investment, indirect investment, credit enhancement and/or loan guarantees to support immigrant visa-based and/or non-immigrant visa-based financing, funding and/or investment in multiple industry sectors in the United States and on a global basis.

Some embodiments include a computer-implemented system to modernize, mechanize and monetize immigrant visas.

Some embodiments include a computer-implemented system to automate and process the monetization of immigrant visas and/or the financial structuring of immigrant visas.

Some embodiments include a computer-implemented system to automate and process the monetization of immigrant visas and/or the financial structuring of immigrant visas for financing, funding and/or investment for job creation and economic development.

Some embodiments include a computer-implemented system to aggregate, manage and track immigrant visas.

Some embodiments include a computer-implemented system to aggregate, manage and track immigrant visas for financing, funding and/or investment.

Some embodiments include a computer-implemented system to apply financing, funding and/or investment criteria to immigrant visas.

Some embodiments include a computer-implemented system to develop, construct and support the monetization of immigrant visas to support immigrant visa financial markets, immigrant visa financial products, immigrant visa financial tools, immigrant visa financial structures, and/or immigrant visa financial algorithms to support economic development, job creation, direct investment, indirect investment, credit enhancement, loan guarantees and/or immigrant visa-based financing, funding and/or investment in multiple industry sectors in the United States and on a global basis.

Some embodiments include a computer-implemented system to develop, construct and support the financial structuring of immigrant visas to support immigrant visa financial markets, immigrant visa financial products, immigrant visa financial tools, immigrant visa financial structures, and/or immigrant visa financial algorithms to support economic development, job creation, direct investment, indirect investment, credit enhancement, loan guarantees and/or immigrant visa-based financing, funding and/or investment in multiple industry sectors in the United States and on a global basis.

Some embodiments include a computer-implemented system to apply monetization structuring to some or all immigrant visas, recaptured immigrant visas, recaptured unused immigrant visas and/or unused immigrant visas that can be implemented as a result of Presidential action, federal administrative action and/or legislative action.

Some embodiments include a computer-implemented system to apply financial structuring to some or all immigrant visas, recaptured immigrant visas, recaptured unused immigrant visas and/or unused immigrant visas that can be implemented as a result of Presidential action, federal administrative action and/or legislative action.

Some embodiments include a computer-implemented system to apply financing, funding and/or investment criteria to some or all immigrant visas, recaptured immigrant visas, recaptured unused immigrant visas and/or unused immigrant visas that can be implemented as a result of Presidential action, federal administrative action and/or legislative action.

Some embodiments include a computer-implemented system, server and method that aggregates, manages and tracks immigrant visas and/or investments in furtherance of immigrant visas and/or job creation in furtherance of immigrant visas and/or immigrant visa employment opportunities in furtherance of immigrant visas including, but not limited to, immigrant visas, recaptured immigrant visas for use in subsequent fiscal years, unused immigrant visas recaptured for use in subsequent fiscal years, prospective immigrant visas for use in a specific fiscal year and prospective immigrant visas for use in subsequent fiscal years. In some embodiments, the system includes the ability to modernize immigrant visas, mechanize immigrant visas, monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas, fund immigrant visas, finance immigrant visas, collateralize immigrant visas, collateralize the financing of immigrant visas, securitize immigrant visas, securitize the financing of immigrant visas, create financial algorithms for immigrant visas, create financial algorithms for the funding of immigrant visas, create financial algorithms for the financing of immigrant visas, create a market for immigrant visas, create a market for the funding of immigrant visas, create a market for the financing of immigrant visas, create financial products for immigrant visas, create financial products for the funding of immigrant visas, create financial products for the financing of immigrant visas, create financial tools for immigrant visas, create financial tools for the funding of immigrant visas, create financial tools for the financing of immigrant visas, create financial structures for immigrant visas, create financial structures for the funding of immigrant visas, create financial structures for the financing of immigrant visas, accept and process visa applications, accept and process expedited visa applications, authenticate investment source of funds, enable background check processing, enable national security related screening and processing, track visa processing, track legal compliance, track securities law compliance, track national security law compliance, suggest investments, track job creation, track investment performance, suggest and place immigrants with job creation entities, suggest and place immigrants with employment opportunities and/or monitor investments for fraud. In some embodiments, the system significantly increases the likelihood of obtaining an immigrant visa while mitigating risk associated with obtaining an immigrant visa.

Some embodiments include a computer-implemented system to aggregate, manage, and track immigrant visas to develop, construct and support financial algorithms, financial products, financial tools and financial structures to support direct investment, credit enhancement, loan guarantees and other economic development in multiple industry sectors in the United States and on a global basis.

Some embodiments include a computer-implemented system that includes at least specifically programming at least one computer system to aggregate, manage, track and monetize immigrant visas.

Some embodiments include a computer-implemented system that includes at least specifically programming at least one computer system to process the executive, administrative and/or legislative recapture up to or over 4,547,236 immigrant visas and for these recaptured immigrant visas to be aggregated, managed and tracked.

Some embodiments include a computer-implemented system that includes at least specifically programming at least one computer system or a portion of at least one computer system to aggregate, manage and track immigrant investor visas and/or immigrant investor visas funding including, but not limited to, recaptured immigrant visas to be used for financing investment and/or financing, funding and/or investment and/or credit enhancement for financing, funding or investment.

Some embodiments include a computer-implemented system to modernize, mechanize and monetize non-non-immigrant visas.

Some embodiments include a computer-implemented system to automate and process the monetization of non-immigrant visas and/or the financial structuring of non-immigrant visas.

Some embodiments include a computer-implemented system to automate and process the monetization of non-immigrant visas and/or the financial structuring of non-immigrant visas for financing, funding and/or investment for job creation and economic development.

Some embodiments include a computer-implemented system to aggregate, manage and track non-immigrant visas.

Some embodiments include a computer-implemented system to aggregate, manage and track non-immigrant visas for financing, funding and/or investment.

Some embodiments include a computer-implemented system to apply financing, funding and/or investment criteria to non-immigrant visas.

Some embodiments include a computer-implemented system to develop, construct and support the monetization of non-immigrant visas to support immigrant visa financial markets, immigrant visa financial products, immigrant visa financial tools, immigrant visa financial structures, and/or immigrant visa financial algorithms to support economic development, job creation, direct investment, indirect investment, credit enhancement, loan guarantees and/or immigrant visa-based financing, funding and/or investment in multiple industry sectors in the United States and on a global basis.

Some embodiments include a computer-implemented system to develop, construct and support the financial structuring of non-immigrant visas to support immigrant visa financial markets, immigrant visa financial products, immigrant visa financial tools, immigrant visa financial structures, and/or immigrant visa financial algorithms to support economic development, job creation, direct investment, indirect investment, credit enhancement, loan guarantees and/or immigrant visa-based financing, funding and/or investment in multiple industry sectors in the United States and on a global basis.

Some embodiments include a computer-implemented system to apply monetization structuring to some or all non-immigrant visas, recaptured non-immigrant visas, recaptured unused non-immigrant visas and/or unused non-immigrant visas that can be implemented as a result of Presidential action, federal administrative action and/or legislative action.

Some embodiments include a computer-implemented system to apply financial structuring to some or all non-immigrant visas, recaptured non-immigrant visas, recaptured unused non-immigrant visas and/or unused non-immigrant visas that can be implemented as a result of Presidential action, federal administrative action and/or legislative action.

Some embodiments include a computer-implemented system to apply financing, funding and/or investment criteria to some or all non-immigrant visas, recaptured non-immigrant visas, recaptured unused non-immigrant visas and/or unused non-immigrant visas that can be implemented as a result of Presidential action, federal administrative action and/or legislative action.

Some embodiments include a computer-implemented system, server and method that aggregates, manages and tracks non-immigrant visas and/or investments in furtherance of non-immigrant visas and/or job creation in furtherance of non-immigrant visas and/or immigrant visa employment opportunities in furtherance of non-immigrant visas including, but not limited to, non-immigrant visas, recaptured non-immigrant visas for use in subsequent fiscal years, unused non-immigrant visas recaptured for use in subsequent fiscal years, prospective non-immigrant visas for use in a specific fiscal year and prospective non-immigrant visas for use in subsequent fiscal years. In some embodiments, the system includes the ability to modernize non-immigrant visas, mechanize non-immigrant visas, monetize non-immigrant visas, attribute a financial value to non-immigrant visas, attribute a monetary value to non-immigrant visas, attribute an economic value to non-immigrant visas, attribute a unit of time to non-immigrant visas, attribute a monetary value to a unit of time to non-immigrant visas, attribute a financial value to a unit of time to non-immigrant visas, attribute an economic value to a unit of time to non-immigrant visas, fund non-immigrant visas, finance non-immigrant visas, collateralize non-immigrant visas, collateralize the financing of non-immigrant visas, securitize non-immigrant visas, securitize the financing of non-immigrant visas, create financial algorithms for non-immigrant visas, create financial algorithms for the funding of non-immigrant visas, create financial algorithms for the financing of non-immigrant visas, create a market for non-immigrant visas, create a market for the funding of non-immigrant visas, create a market for the financing of non-immigrant visas, create financial products for non-immigrant visas, create financial products for the funding of non-immigrant visas, create financial products for the financing of non-immigrant visas, create financial tools for non-immigrant visas, create financial tools for the funding of non-immigrant visas, create financial tools for the financing of non-immigrant visas, create financial structures for non-immigrant visas, create financial structures for the funding of non-immigrant visas, create financial structures for the financing of non-immigrant visas, accept and process visa applications, accept and process expedited visa applications, authenticate investment source of funds, enable background check processing, enable national security related screening and processing, track visa processing, track legal compliance, track securities law compliance, track national security law compliance, suggest investments, track job creation, track investment performance, suggest and place immigrants with job creation entities, suggest and place immigrants with employment opportunities and/or monitor investments for fraud. In some embodiments, the system significantly increases the likelihood of obtaining an immigrant visa while mitigating risk associated with obtaining an immigrant visa.

Some embodiments include a computer-implemented system to aggregate, manage, and track non-immigrant visas to develop, construct and support financial algorithms, financial products, financial tools and financial structures to support direct investment, credit enhancement, loan guarantees and other economic development in multiple industry sectors in the United States and on a global basis.

Some embodiments include a computer-implemented system that includes at least specifically programming at least one computer system to aggregate, manage, track and monetize non-immigrant visas.

Some embodiments include a computer-implemented system that includes at least specifically programming at least one computer system to process the executive, administrative and/or legislative recapture up non-immigrant visas and for these recaptured non-immigrant visas to be aggregated, managed and tracked.

Some embodiments include a computer-implemented system that includes at least specifically programming at least one computer system or a portion of at least one computer system to aggregate, manage and track immigrant investor visas and/or immigrant investor visas funding including, but not limited to, recaptured non-immigrant visas to be used for financing investment and/or financing, funding and/or investment and/or credit enhancement for financing, funding or investment.

Some embodiments include a system, server and method to aggregate, manage and track the recapture of immigrant visas from (i) Emergency Quota Act; (ii) Immigration Act of 1924; (iii) Immigration and Nationality Act of 1952; (iv) Immigration and Nationality Act of 1965; (v) Immigration Act of 1990.

Some embodiments include a computer-implemented system that modernizes, mechanizes and monetizes immigrant visas and/or investments in furtherance of immigrant visas and/or job creation in furtherance of immigrant visas and/or immigrant visa employment opportunities in furtherance of immigrant visas including, but not limited to, recaptured immigrant visas for use in subsequent fiscal years, unused immigrant visas recaptured for use in subsequent fiscal years, prospective immigrant visas for use in a specific fiscal year and prospective immigrant visas for use in subsequent fiscal years. In some embodiments, the system includes the ability to monetize immigrant visas, attribute a financial value to immigrant visas, attribute a monetary value to immigrant visas, attribute an economic value to immigrant visas, attribute a unit of time to immigrant visas, attribute a monetary value to a unit of time to immigrant visas, attribute a financial value to a unit of time to immigrant visas, attribute an economic value to a unit of time to immigrant visas, fund immigrant visas, finance immigrant visas, collateralize immigrant visas, collateralize the financing of immigrant visas, securitize immigrant visas, securitize the financing of immigrant visas, create financial algorithms for immigrant visas, create financial algorithms for the funding of immigrant visas, create financial algorithms for the financing of immigrant visas, create a market for immigrant visas, create a market for the funding of immigrant visas, create a market for the financing of immigrant visas, create financial products for immigrant visas, create financial products for the funding of immigrant visas, create financial products for the financing of immigrant visas, create financial tools for immigrant visas, create financial tools for the funding of immigrant visas, create financial tools for the financing of immigrant visas, create financial structures for immigrant visas, create financial structures for the funding of immigrant visas, create financial structures for the financing of immigrant visas, accept and process visa applications, accept and process expedited visa applications, authenticate investment source of funds, enable background check processing, enable national security related screening and processing, track visa processing, track legal compliance, track securities law compliance, track national security law compliance, suggest investments, track job creation, track investment performance, suggest and place immigrants with job creation entities, suggest and place immigrants with employment opportunities and/or monitor investments for fraud. In some embodiments, the system significantly increases the likelihood of obtaining an immigrant visa while mitigating risk associated with obtaining an immigrant visa.

Some embodiments include a computer-implemented system to apply monetization structuring and/or financial structuring to immigrant visas to develop, construct and support financial algorithms, financial products, financial tools and financial structures to support direct investment, credit enhancement, loan guarantees and other economic development in multiple industry sectors in the United States and on a global basis.

Some embodiments include a computer-implemented system to apply monetization structuring and/or financial structuring to non-immigrant visas to develop, construct and support financial algorithms, financial products, financial tools and financial structures to support direct investment, credit enhancement, loan guarantees and other economic development in multiple industry sectors in the United States and on a global basis.

Some embodiments include a computer-implemented system that includes at least specifically programming at least one computer system or a portion of at least one computer system to aggregate, manage and track immigrant investor visas and/or immigrant investor visas funding including, but not limited to, recaptured immigrant visas to be used for financing investment and/or financing, funding and/or investment and/or credit enhancement to finance certain investment. Some embodiments include a computer-implemented system that includes at least specifically programming at least one computer system or a portion of at least one computer system to aggregate, manage and track immigrant investor visas and/or immigrant investor visas funding including, but not limited to, recaptured immigrant visas to be used for financing investment and/or financing, funding and/or investment and/or credit enhancement to finance investment.

Some embodiments include a system, server and method to apply monetization structuring and/or financial structuring to immigrant visas to develop, construct and support immigrant visa financial markets, immigrant visa financial products, immigrant visa financial tools, immigrant visa financial structures, and/or immigrant visa financial algorithms to support job creation, direct investment, credit enhancement, loan guarantees and other economic development in multiple industry sectors in the United States and on a global basis.

Some embodiments include a system, server and method to apply monetization structuring and/or financial structuring to non-immigrant visas to develop, construct and support non-immigrant visa financial markets, non-immigrant visa financial products, non-immigrant visa financial tools, non-immigrant visa financial structures, and/or non-immigrant visa financial algorithms to support job creation, direct investment, credit enhancement, loan guarantees and other economic development in multiple industry sectors in the United States and on a global basis.

Some embodiments include a computer-implemented system that includes at least specifically programming at least one computer system or a portion of at least one computer system to aggregate, manage and track immigrant investor visas and/or immigrant investor visas funding including, but not limited to, recaptured immigrant visas to be used for financing investment and/or financing, funding and/or investment and/or credit enhancement to finance certain investment. Some embodiments include a computer-implemented system that includes at least specifically programming at least one computer system or a portion of at least one computer system to aggregate, manage and track immigrant investor visas and/or immigrant investor visas funding including, but not limited to, recaptured immigrant visas to be used for financing investment and/or financing, funding and/or investment and/or credit enhancement to finance investment.

Some embodiments include a system, server and method to apply monetization structuring and/or financial structuring to immigrant visas by applying the former $1,800,000 EB-5 and/or $900,000 targeted employment area (TEA) EB-5 investment and EB-5 job creation requirements and/or criteria and/or other financial amount to some or all recaptured immigrant visas and/or recaptured unused immigrant visas and/or unused immigrant visas that can be recaptured by Presidential action and/or federal administrative action.

In some embodiments the recapture of unused immigrant visas for use in subsequent fiscal years is silent or ambiguous on the face of the Emergency Quota Act, Immigration Act of 1924, Immigration and Nationality Act of 1952, Immigration and Nationality Act of 1965 and Immigration Act of 1990. There is ample legal, legislative, regulatory, and policy precedent to support the position that all unused immigrant visa numbers are legally viable and should be recaptured for use in subsequent fiscal years and this recapture can be done presidentially and/or administratively and without requiring an act of Congress or Congressional approval. This measure would realize the intent of Congress, represent a proper exercise of Executive authority, and substantively address existing immigrant visa backlogs without negatively impacting U.S. workers. Moreover, the current immigration system and statutory framework allows and, indeed, requires the full and fair allocation of all available immigrant visa numbers; such an initiative would effect Congressional intent, relieve long-standing immigrant visa backlogs, responsibly align visa demand with visa availability, and would not be in conflict with the Worldwide Levels of Immigration in the Immigration Act of 1990. The President of the United States has the legal authority to require that recaptured immigrant visas for use in subsequent fiscal years comply with certain restrictions and limitations.

Some embodiments include a computer-implemented system that includes at least specifically programming at least one computer system to process the executive, administrative and/or legislative recapture up to or over 4,547,236 immigrant visas and for these recaptured immigrant visas to apply monetization structuring and/or financial structuring to the immigrant visas.

Some embodiments include a computer-implemented system that includes at least specifically programming at least one computer system to aggregate, manage and track 4,547,236 unused immigrant visas to apply monetization structuring and/or financial structuring to the immigrant visas.

The United States Citizenship and Immigration Service (“USCIS”) Employment-Based Fifth Preference Immigrant Investor Funding Program (“EB-5 Program” or “EB-5”) is the current immigrant investor program in the United States. The EB-5 Program was established by Congress in 1990 to stimulate the United States economy through job creation and capital investment by foreign investors and is administered by the USCIS within the United States Department of Homeland Security (“DHS”). The EB-5 Program establishes a path to permanent residency for up to 10,000 immigrants (and immediate family members) annually who invest in an existing or new business in the United States and create or preserve at least 10 U.S. jobs. As of Apr. 22, 2022, to obtain an EB-5 visa, foreign investors must invest $1,50,000 (or at least $800,000 in a “Targeted Employment Area”, defined as an area with high unemployment and/or a rural area), and create or preserve at least 10 jobs for United States workers excluding the investor and their immediate family. The EB-5 investment amount has changed over the course of the EB-5 program and is subject to change in the future.

Some embodiments include a system, server and method to apply monetization structuring and/or financial structuring to immigrant visas by applying up to or over the $1,050,000 EB-5 and/or up to or over the $800,000 targeted employment area (TEA) EB-5 investment and EB-5 job creation requirements and/or criteria to some or all recaptured immigrant visas and/or recaptured unused immigrant visas and/or unused immigrant visas that can be recaptured by Presidential action and/or federal administrative action.

Some embodiments include a system, server and method to apply monetization structuring and/or financial structuring to immigrant visas by applying a dollar amount including, but not limited to, $1,050,000 and/or $800,000 financing, funding or investment criteria to some or all recaptured immigrant visas and/or recaptured unused immigrant visas and/or unused immigrant visas that can be recaptured and/or used by Presidential action, federal administrative action and/or legislative action.

Some embodiments include a system, server and method for the System and multiple industry-leading business consortiums to apply monetization structuring and/or financial structuring to U.S. immigration policy to support America's values as a nation of immigrants while advancing the national interest and national security of the United States.

From 1921 until 2019, the United States Congress granted 25,294,990 immigrant visas under United States law. During this time, the U.S. Government only issued 20,567,754 immigrant visas counted against immigrant visa numerical limits. Recapturing all historically unused immigrant visas, minus 180,000 immigrant visas recaptured with special legislation, would result in 4,547,236 immigrant visas.

The recapture of all unused immigrant visas for use in subsequent fiscal years to advance the national interest or national security of the United States will support strong employment for Americans and will strengthen economic recovery for the United States following the COVID-19 outbreak.

Some embodiments include a system, server and method for a novel and transformational system to recapture up to or over 4,547,236 immigrant visas and for these recaptured immigrant visas to apply monetization structuring and/or financial structuring to the immigrant visas.

Some embodiments include a system, server and method for a novel and transformational system that includes a computer-implemented system to apply monetization structuring and/or financial structuring to immigrant visas and non-immigrant visas to develop, construct and support financial algorithms, financial products, financial tools and financial structures to support direct investment, credit enhancement, loan guarantees and other economic development in multiple industry sectors in the United States and on a global basis.

Some embodiments include a system, server and method for the System Provider to provide a legal and financial structure over 20 years for System Provider to acquire hundreds of billions of dollars of Commercial Airplanes, Commercial Satellites and Spacecraft and, as a related matter, for System Provider to finance and develop trillions of dollars of infrastructure, shipbuilding, transportation, energy, technology, healthcare, education, real estate, manufacturing, and other sectors in the United States. Further, the ability to utilize a funded balance sheet and coordinate investments across multiple interrelated verticals enables System Provider to mitigate low-equity returns and financing risk.

Some embodiments include a system, server and method for System Provider to implement the System Provider Three-Legged Stool involving (i) legal; (ii) economic; (iii) political to apply monetization structuring and/or financial structuring to financing, funding and/or investment involving immigrant and non-immigrant visas.

System Provider—Legal: some embodiments include a system, server and method for System Provider to lead the recapture of 4,500,000 unused immigrant visas for use in subsequent fiscal years; Development of Employment-Based National Interest Immigrant Visa Program (EB-NI Program), JOBS America and System Provider Dynamic Immigration; Each EB-NI visa is valued at $1.8 million. EB-NI immigrant contributes $180,000

System Provider—Economic: some embodiments include a system, server and method for business-focused System Provider Coalition of Consortiums—trillions of dollars annually to U.S. economy; System Provider and System Provider, JOBS America and U.S. Chamber of Commerce; Coalition of U.S. industry and business consortiums; investment in defense to childcare and in-between; System Provider—Financial: institutional financing of System Provider investments—trillions of dollars for U.S. economy; financing of EB-NI immigrant visas using System Provider Dynamic Immigration; Development of System Provider Immigrant Visa Consumer Financial Market; development of System Provider Immigrant Visa Consumer Financial Product; System Provider Strategic: Commercial Airplanes, Satellites, Spacecraft provides financial foundation for financing of System Provider institutional investments to support System Provider Dynamic Immigration; System Provider financing, funding and/or investment: U.S. infrastructure and other sectors; Commercial Airplanes, Satellites, Spacecraft provides financial foundation for development of System Provider Immigrant Visa Consumer Financial Market; Commercial Airplanes, Satellites, Spacecraft provides financial foundation for development of System Provider Immigrant Visa Consumer Financial Product

System Provider Political: some embodiments include a system, server and method for System Provider to implement combined workings of System Provider legal and System Provider economic is employed to advance United States national interest (legislative and non-legislative) including JOBS America; trillions of dollars of private economic development in the United State; economic development in all 50 states and 5 territories—JOBS America; hundreds of billions of dollars of economic development in Mexico, Northern Triangle of Central America (El Salvador, Guatemala, Honduras) and throughout the Americas—JOBS World; address root causes of migration—economic development; trillions of dollars for global climate change-related initiatives and jobs; a globally integrated approach to address climate change—JOBS World; EB-NI Program in Canada, European Union, U.K., Australia, New Zealand; address root causes of migration globally—economic development.

Some embodiments include a system, server and method for System Provider to exist at the intersection of U.S. Immigration Policy, Finance and U.S. Economic Development.

Some embodiments include a system, server and method for System Provider to develop a System Provider Immigrant Visa Consumer Financial Market and System Provider Immigrant Visa Consumer Financial Product to support trillions of dollars of investment in United States infrastructure and other sectors of the United States economy without being reliant on federal taxpayer dollars.

Some embodiments include a system, server and method to apply monetization structuring and/or financial structuring to U.S. immigration policy to advance the national interest and national security of the United States.

Some embodiments include a system, server and method to apply monetization structuring and/or financial structuring to System Provider Dynamic Immigration which exists at the intersection of United States immigration policy, finance and economic development.

Some embodiments include a system, server and method to apply monetization structuring and/or financial structuring to System Provider Dynamic Immigration as a whole-of-government public private partnership with System Provider.

Some embodiments include a system, server and method to apply monetization structuring and/or financial structuring for System Provider Dynamic Immigration to (i) enhance the flow of credit to targeted sectors of the United States economy; (ii) make those segments of the capital market more efficient and transparent; (iii) reduce the risk to investors and other suppliers of capital to finance and develop those sectors.

Some embodiments include a system, server and method to apply monetization structuring and/or financial structuring to System Provider Dynamic Immigration with the objective that funding, including but not limited to, the $1.8 million funding from each EB-NI immigrant visa will be deployed as a credit enhancement and leveraged at, including but not limited to, a 5:1 ratio (System Provider Credit Enhancement to System Provider EB-NI Funding) to raise $9 million of funding per EB-NI immigrant visa for investment in the United States and the creation or preservation of at least 120 U.S. jobs.

Some embodiments include a system, server and method to apply monetization structuring and/or financial structuring for System Provider component of the EB-NI Program to engages the System Provider opportunity, including but not limited to, 500,000 times to raise $900 billion of unlevered funding ($1.8 million×500,000 EB-NI immigrant visas=$900 billion) during System Provider Year 1 and 200,000 times to raise $360 billion of unlevered funding ($1.8 million×200,000 EB-NI immigrant visas=$360 billion) on an annual basis during System Provider Program Years 2-21 (20 years).

Some embodiments include a system, server and method to apply monetization structuring and/or financial structuring for System Provider to raise up to or over $900 billon of EB-NI funding that is intended to be leveraged at, including but not limited do, a 5:1 ratio to raise $4.5 trillion of funding (System Provider Credit Enhancement to System Provider EB-NI Funding) during System Provider Program Year 1 and the $360 billion of EB-NI funding is intended to be leveraged at, including but not limited to, a 5:1 ratio to raise $1.8 trillion of funding annually (System Provider Credit Enhancement to System Provider EB-NI Funding) during System Provider Program Years 2-21 (20 years) for public-private partnership investment in U.S. aerospace, shipbuilding, transportation, energy, technology, healthcare, education, real estate, manufacturing, infrastructure, and other sectors in the United States to create or preserve over 24 million U.S. jobs on an annual basis for 21 years.

Some embodiments include a system, server and method to apply monetization structuring and/or financial structuring for System Provider Dynamic Immigration to include institutional financing of, including but not limited to, $1.8 million EB-NI immigrant visas through a System Provider Immigrant Visa Consumer Financial Market and System Provider Immigrant Visa Consumer Financial Product.

Some embodiments include a system, server and method to apply monetization structuring and/or financial structuring for System Provider Employment-Based National Interest Immigrant Visa Program.

Some embodiments include a system, server and method to apply monetization structuring and/or financial structuring for System Provider U.S. Government Employment-Based National Interest Immigrant Visa Program (“EB-NI Program”) (proposed) will be informed by the EB-5 Program investment and job creation criteria.

Some embodiments include a system, server and method to apply monetization structuring and/or financial structuring to immigrant visas including but not limited to EB-NI Program visas.

Some embodiments include a system, server and method to apply monetization structuring and/or financial structuring for the United States Citizenship and Immigration Services (“USCIS”) to administer the EB-NI Program.

Some embodiments include a system, server and method to apply monetization structuring and/or financial structuring with the EB-NI Program, for certain foreign nationals (and their spouses and unmarried children under 21) to be eligible to apply for a Green Gard (lawful permanent residence).

Some embodiments include a system, server and method to apply monetization structuring and/or financial structuring for EB-NI immigrant visas to result in, but not limited to, a $1,800,000 financing, funding or investment in an existing or new commercial enterprise in the United States.

Some embodiments include a system, server and method to apply monetization structuring and/or financial structuring for the EB-NI immigrant to contribute from $0 to $180,000 towards the $1,800,000 financing, funding or investment of each EB-NI immigrant visa.

Some embodiments include a system, server and method to apply monetization structuring and/or financial structuring for each EB-NI immigrant visa to create or preserve at least 10 permanent full-time jobs for qualified U.S. workers within two years or a reasonable period of time.

Some embodiments include a system, server and method to apply monetization structuring and/or financial structuring for System Provider to collaborate with the U.S. Government to establish EB-NI Program and JOBS America (Joint Opportunity to Build and Strengthen America) to modernize, mechanize and monetize up to or over hundreds of thousands of immigrant visas and/or unused immigrant visas on an annual basis and to provide up to or over Some embodiments include a system, server and method to apply monetization structuring and/or financial structuring for System Provider Some embodiments include a system, server and method to apply monetization structuring and/or financial structuring for System Provider trillions of dollars of non-taxpayer funding for investment into the United States economy on an annual basis.

Some embodiments include a system, server and method to apply monetization structuring and/or financial structuring for System Provider to finance System Provider Dynamic Immigration Visas.

Some embodiments include a system, server and method to apply monetization structuring and/or financial structuring for System Provider to fund System Provider Dynamic Immigration Visas.

Some embodiments include a system, server and method to apply monetization structuring and/or financial structuring for System Provider to invest in System Provider Dynamic Immigration Visas.

Some embodiments include a system, server and method to apply monetization structuring and/or financial structuring for System Provider to finance System Provider Dynamic Immigration to provide a legal structure for System Provider to finance, including but not limited to, the $1,800,000 required for an EB-NI immigrant visa investment, as opposed to a cash investment by an immigrant, and the creation of System Provider Immigrant Visa Consumer Financial Market and System Provider Immigrant Visa Consumer Financial Product.

Some embodiments include a system, server and method to apply monetization structuring and/or financial structuring for System Provider to support a System Provider Immigrant Visa Consumer Financial Market and System Provider Immigrant Visa Consumer Financial Product.

Some embodiments include a system, server and method to apply monetization structuring and/or financial structuring to U.S. immigration policy to support America's values as a nation of immigrants while advancing the national interest and national security of the United States.

Some embodiments include a system, server and method to apply monetization structuring and/or financial structuring the System Provider program to develop a System Provider Immigrant Consumer Financial Market and System Provider Immigrant Consumer Financial Product to facilitate the financing of EB-NI immigrant visas and/or alternative immigrant visas and/or non-immigrant visas.

Some embodiments include a system, server and method to apply monetization structuring and/or financial structuring the System Provider program to develop a System Provider Immigrant Consumer Financial Market and System Provider Immigrant Consumer Financial Product to facilitate the financing of up to or over 500,000 EB-NI immigrant visas and/or alternative immigrant visas and/or non-immigrant visas during System provider Program Year 1 and 200,000 EB-NI immigrant visas during System Provider Program Years 2-21 (20 years).

Some embodiments include a system, server and method to apply monetization structuring and/or financial structuring to structure, develop and support an immigrant visa and/or non-immigrant visa consumer financial market that will parallel and be analogous to major consumer financial markets, including mortgage lending, student loans, automobile loans, credit cards and payments, payday loans and other credit alternative financial products, and checking accounts and substitutes.

Some embodiments include a system, server and method to apply monetization structuring and/or financial structuring to develop and support an immigrant visa and/or non-immigrant visa consumer financial product that will parallel and be analogous to major consumer financial markets, including mortgage lending, student loans, automobile loans, credit cards and payments, payday loans and other credit alternative financial products, and checking accounts and substitutes.

Some embodiments include a system, server and method to apply monetization structuring and/or financial structuring to JOBS America (Joint Opportunity to Build and Strengthen America) which is an intended U.S. Government-wide Initiative to facilitate investment and job creation in the United States by Americans and qualified foreigners including citizens of foreign nations that obtain an EB-NI immigrant visa.

Some embodiments include a system, server and method that JOBS America is intended to be housed in the U.S. Department of Commerce.

In some embodiments, the system includes a communications module configured to receive investment data and immigration data from one or more databases in or from JOBS America.

In some embodiments, the system includes a System Provider public private partnership with JOBS America to employ, place and/or staff EB-NI immigrants and/or other immigrant or non-immigrants with businesses or other entities across the United States.

In some embodiments, the system includes a communication module for JOBS America will play an integral role for the System Provider to develop and support monetization structuring and/or financial structuring of immigrant visas and/or non-immigrant visas.

In some embodiments, the system includes a communication module for System Provider to collaborate with JOBS America to employ, place and/or staff hundreds of thousands of EB-NI immigrants and/or other immigrants and/or non-immigrants as medical doctors, nurses, engineers, computer programmers, information technology professionals, biologists, teachers, professors, professional educators, and in other occupations across America, in various industries and sectors.

In some embodiments, the system includes a communication module between System Provider and JOBS America for a predetermined number of EB-NI immigrant visas and/or other immigrant visas and/or other non-immigrant visas to be allocated to undergraduate and graduate students with an emphasis towards science, technology, engineering and mathematics (STEM).

In some embodiments, the system includes a communication module for JOBS America to establish criteria for businesses, non-profit organizations and other entities to qualify for and participate in JOBS America as JOBS America Commercial Partners or JOBS America Non-Profit Partners and all JOBS America Commercial Partners or JOBS America Non-Profit Partners which must advance the national interest or national security and military or foreign affairs function of the United States.

In some embodiments, the system includes a communication module between System Provider and Global Infrastructure Development Bank (GIDB), a private national infrastructure bank focused on infrastructure development in the United States and globally.

In some embodiments, the system includes a communication module for System Provider and/or GIDB to partner with all fifty states and all five permanent territories of the United States to finance and develop infrastructure at the national, regional, state and local level.

In some embodiments, the system includes developing various forms of external credit enhancement to provide support to both Commercial Airplane leases and infrastructure project cash flows during the life of both asset classes and other asset classes.

In some embodiments, the system includes a System Provider Credit Enhancement structure to augment the ability for both a Commercial Airplane lease and infrastructure project to ultimately retire debt by enhancing the ability of both asset classes to meet debt service requirements.

In some embodiments, the system includes a System Provider Credit Enhancement structure to augment the ability for System Provider project to ultimately retire debt by enhancing the ability to meet debt service requirements.

Some embodiments include a system, server and method for System Provider to (i) enhance the flow of credit to targeted sectors of the United States economy; (ii) make those segments of the capital market more efficient and transparent; (iii) reduce the risk to investors and other suppliers of capital to finance and develop those sectors.

Some embodiments include a system, server and method to apply monetization structuring and/or financial structuring for the President of the United States to be the Immigration Policy Maker in Chief and for the President to issue an executive order, proclamation or memorandum to recapture unused immigrant visas for use in subsequent fiscal years based on federal law, within the specific context of immigration law, without the need for an act of Congress or Congressional approval. The President can direct the U.S. Department of State (“State Department”) and U.S. Department of Homeland Security (“DHS”) to implement the presidential recapture of unused immigrant visas for use in subsequent fiscal years.

Some embodiments include a system, server and method to apply monetization structuring and/or financial structuring to a series of twentieth-century developments—constitutional, historical, and institutional—have, as a functional matter, given the President tremendous power over the immigrant-screening system: power to determine which immigrants would be permitted to remain in the United States, which would be forced to leave, and which would be allowed to enter. The executive branch has actually helped construct an immigration system over time as it has wielded its enforcement power and decided how to put the Immigration and Nationality Act (“INA”) and its statutory framework into effect, a process that has entailed considerable executive policymaking dynamically related to, but still separate from, congressional policy. This immigration system supports the presidential recapture of unused immigrant visas for use in subsequent fiscal years and its related administrative implementation.

Some embodiments include a system, server and method to apply monetization structuring and/or financial structuring to, in addition to recapturing unused immigrant visas for use in subsequent fiscal years and directing its related administrative implementation, the President can direct the State Department and DHS to establish the Employment-Based National Interest Immigrant Visa Program (EB-NI Program) to modernize, mechanize and monetize U.S. immigration policy to support America's values as a nation of immigrants while advancing the national interest and national security of the United States. The EB-NI Program can support trillions of dollars of investment in U.S. infrastructure and other sectors of the U.S. economy, and support the preservation or creation of tens of millions of American jobs to Build Back Better, without adding to the national debt, without raising corporate income tax, without raising federal income taxes, and without increasing the financial burden to the American taxpayer.

Some embodiments include a system, server and method to apply monetization structuring and/or financial structuring involving Congress having accorded the President broad discretion to suspend or restrict the admission of aliens. Section 1182(f) of Title 8 of the United States Code provides: Whenever the President finds that the entry of any aliens or of any class of aliens into the United States would be detrimental to the interests of the United States, he may by proclamation, and for such period as he shall deem necessary, suspend the entry of all aliens or any class of aliens as immigrants or nonimmigrants, or impose on the entry of aliens any restrictions he may deem to be appropriate. Section 1185(a)(1) of Title 8 further grants the President broad authority to adopt “reasonable rules, regulations, and orders” governing entry or removal of aliens, “subject to such limitations and exceptions as [he] may prescribe.”

As the President has the legal authority to restrict the entry of certain aliens when he deems it in the Nation's interest, the Constitution and Acts of Congress necessarily confer on the President broad authority to allow entry of certain aliens when the President deems it in the Nation's interest.

Section 1182(f) of Title 8 provides that the “President” “may by proclamation” “impose on the entry of aliens any restrictions he may deem to be appropriate.”

As it relates to entry, Section 1185(a)(1) of Title 8 grants the President broad authority to adopt “reasonable rules, regulations, and orders” governing entry of aliens, “subject to such limitations and exceptions as [he] may prescribe.”

Consistent with Section 1185(a)(1) and Section 1182(f) of Title 8, the President can impose, restrict and provide limitations and exceptions that recaptured immigrant visas be allocated to certain aliens pursuant to the EB-NI Program to advance the national interest or national security of the United States.

A legal challenge to the presidential recapture of unused immigrant visas for use in subsequent fiscal years and its related administrative implementation may be based on the U.S. Constitution and the Administrative Procedure Act (APA) (5 USC § 551 et seq. (1946)). A Constitutional challenge will focus on (i) separation-of-powers; (ii) the President's constitutional duty to “take Care that the Laws be faithfully executed” under Article II, Section 3 (U.S. Const. art. II, § 3); (iii) the “equal protection” clause of the Fourteenth Amendment (U.S. Const., Fifth Amendment and U.S. Constitution, Fourteenth Amendment); and (iv) the “due process” clauses of the Fifth and Fourteenth Amendments of the U.S. Constitution. A challenge under the APA will be based on the procedural and substantive application of the APA.

A federal court will have jurisdiction pursuant to 28 U.S.C. § 1331 (federal question jurisdiction), as a civil action arising under the laws of the United States, and 28 U.S.C. § 1346 (United States as defendant). Declaratory judgment will likely be sought pursuant to 28 U.S.C. § 2201-02. The United States will have waived its sovereign immunity pursuant to 5 U.S.C. § 702.

Courts sometimes review the legality of an executive order, proclamation or memorandum. For example, a court may determine whether the President may act at all. In those circumstances, the court will employ a three-part analysis articulated by Justice Robert Jackson in his concurring opinion to the Supreme Court's decision in Youngstown Sheet & Tube Co. v. Sawyer. In other cases, a reviewing court may determine the scope of Congress's delegation of power to the President. To perform that analysis, courts will generally use traditional tools of statutory interpretation. Courts may also be required to determine the scope of the President's action in the executive order, proclamation or memorandum. Courts will begin with the text of the executive order, proclamation or memorandum and may defer to agency interpretation (depending on the circumstances of the particular case). Separately, courts may also review other constitutional issues raised by the executive order, proclamation or memorandum (for example, whether an executive order violates the First Amendment to the U.S. Constitution).

If a Constitutional and APA challenge is made as to the legal viability of a presidential recapture of unused immigrant visas for use in subsequent fiscal years and its related administrative implementation, both Youngstown and Chevron deference (Youngstown Sheet & Tube Co. v. Sawyer, 343 U.S. 579, 610-611 (1952); Chevron U.S.A. Inc. v. Natural Resources Defense Council, Inc., 467 U.S. 837, 842-44 (1984)). will support such presidential and administrative action as the issue involves “contemporary imponderables” (Youngstown) and is “silent or ambiguous” (Chevron) on the face of the INA and, therefore, the presidential recapture of unused immigrant visas for use in subsequent fiscal years and its related administrative implementation can be permissibly construed by the statute.

The need for substantial investment in infrastructure is well documented. The American Society of Civil Engineers (ASCE) estimates that if the 10-year U.S. infrastructure gap of $2 trillion is not addressed, it will cost $3.9 trillion in GDP by 2025. This shortfall affects everyday life: each year, two trillion gallons of drinking water are lost to water-main leaks while 5.5 billion hours are lost to traffic congestion. Americans could soon experience “Thanksgiving-peak” transit volumes at 24 of the 30 largest airports at least once a week. Failure to invest in infrastructure is not just costly, it also impacts personal safety. Almost 10 percent of the bridges over which Americans drive, about 56,000 in total, are structurally deficient, as are 15,500 dams (17% of the total). The infrastructure gap is exacerbated by factors such as climate and technological change.

Public-sector budgets across the developed world are strained. U.S. state and municipal governments face unfunded pension liabilities of more than $1.6 trillion diverting tax revenues away from infrastructure development and maintenance. Moreover, the U.S. municipal bond market, which has funded much public-sector infrastructure, is facing headwinds as lower tax rates and persistently low interest rates make these bonds much less attractive to investors. It is noteworthy that municipal bonds are inefficient for tax-exempt investors, the largest pools of long-term capital, and they cannot be used to fund infrastructure developed by private-sector interests. (The Future of Infrastructure, AECOM).

The Infrastructure Investment and Jobs Act (IIJA) (Bipartisan Infrastructure Deal) contains $550 billion in new spending and $650 billion of continued spending for a total of $1.2 trillion of United States infrastructure spending over the next ten years. Even with the Bipartisan Infrastructure Deal, the United States infrastructure funding deficit continues.

In addition to the federal government, the United States infrastructure funding deficit impacts state and local governments across the United States.

System Provider is dedicated to bridging the United States infrastructure funding deficit and supporting trillions of dollars of additional infrastructure spending at federal, state and local levels.

System Provider is focused on successfully addressing the insufficiency of public and private capital available to finance and develop certain much needed infrastructure projects in the United States.

System Provider's proprietary program and business model includes non-traditional capital structuring and attractive debt financing. System Provider's business model includes a fully capitalized holding company structure maintaining an investment-grade credit rating, ideally from at least two of the three major rating agencies, and serving as guarantor for System Provider's intended infrastructure projects.

System Provider's ability to aggregate and deploy non-traditional sources of capital provides significant competitive advantages, compared with market analogues, in the form of low-cost and patient capital, which has been structured for System Provider to concurrently fund multiple and multi-year capital intensive infrastructure projects with low internal rates of return (“IRRs”).

System Provider's business model utilizes a funded balance sheet and coordinated investments across multiple interrelated verticals, with the objective to mitigate low-equity returns and financing risk to finance and develop underfunded infrastructure projects in the United States and globally.

System Provider U.S. Infrastructure Funding Pilot Program—Municipal Solid Waste to Sustainable Aviation Fuel

Amongst the many underfunded United States infrastructure projects that System Provider is interested in financing and developing is a credible program to decarbonize all of California's civil and commercial airports.

In furthering this objective, System Provider has assembled an industry-leading, best of breed aerospace, aviation, science, construction, engineering, infrastructure, legal, and financial team to process Municipal Solid Waste (MSW) to Sustainable Aviation Fuel (SAF) to create a clean and commercially scalable alternative to fossil-based kerosene jet fuel.

It is System Provider's objective that California becomes the global leader in SAF development and deployment, while setting a benchmark for the entire United States and for the world.

The aforementioned MSW to SAF project is just an example of the type of underfunded infrastructure project that System Provider is interested in financing and developing to benefit the national interest and national security of the United States.

The Critical Problem with Wide-Scale Adoption of MSW to SAF—Lack of Financing

SAF is physically and chemically similar to jet fuel, resulting in categorization of many SAF types as “drop-in fuel”. Despite this advantage, SAF production volumes remain low and account for less than 1% of global jet fuel consumption. A combination of techno-economic factors has been halting further progress. (Clean Skies for Tomorrow: Sustainable Aviation Fuel Policy Toolkit—Insight Report, November 2021, World Economic Form).

Currently, the largest barrier to wider SAF use is cost. SAF production expenses result in market prices 2 to 4 times greater or more than traditional fossil jet fuel, depending on the production pathway used, limiting the potential for market-driven scale-up.

Regulation and fiscal policies will be required to help bridge this cost differential, drive demand, and generate greater certainty for investors and financers.

Theoretically, there is sufficient feedstock globally to power all of aviation by 2030; however, it is necessary to make improvements in feedstock production and collection and in technology allowing for the use of a broad range of feedstock types. New scalable production routes include alcohol-to-jet (AtJ), gasification/Fischer-Tropsch (G/FT), and power-to-liquid (PtL). Critical investments in research, development and demonstration (RD&D) are needed to see these technologies and production pathways mature. (World Economic Forum).

In order to qualify for commercial financing, infrastructure projects, including energy and transportation infrastructure projects, such as MSW to SAF, must satisfy a number of criteria. Two of the most important are a secure revenue stream and relative certainty that the systems will perform as designed.

Various SAF stakeholders have successfully focused on the latter criteria and much progress has been made towards the RD&D of MSW to SAF.

The former criteria, a secure MSW to SAF revenue stream to support project financing, is currently problematic. System Provider is focused on solving this problem.

System Provider recognizes that MSW to SAF revenue streams will be significantly constrained during the foreseeable future.

The timely build-out of facilities and infrastructure needed to enable wide-scale adoption of MSW to SAF as an energy and transportation solution will require a steady flow of private capital into the sector.

Realizing the necessary capital flow will require that prospective investors foresee the opportunity to achieve an acceptable return on investment while accounting for risk and uncertainty.

In addition, transparent and well-functioning markets are critical to the long-term success of the sector for investors and consumers. Factors that facilitate this include a broad and diverse array of market participants, low barriers to entry, ready access to market information such as pricing and effective mechanism for connecting buyers and sellers across the value chain (such as commodity exchanges and procurement platforms). Although the private sector must play a primary role in achieving these goals, governments must also play an important role. (University of California, Irvine, Advanced Power and Energy Program).

System Provider MSW to SAF—Financial Vehicles

System Provider has developed two credible programs to fund MSW to SAF, both of which involve financial vehicles, to support a steady flow of private capital into the MSW to SAF sector while accounting for risk and uncertainty.

The first financial vehicle intends to result in $100 billion of funding for MSW to SAF processing in the United States and globally. System Provider is currently assembling a global consortium of capital sources focused on establishing a dedicated fund to raise $10 billion of annual funding for ten years, for a total of $100 billion, to process MSW to SAF.

The second financial vehicle intends to result in $1 trillion of funding for MSW to SAF processing in the United States and globally within two years. The second financial vehicle, resulting in $1 trillion of funding for MSW to SAF processing, requires increased U.S. Government coordination compared to the $100 billion financial vehicle but is System Provider's preferred funding option.

The System Provider MSW to SAF financing vehicles are credible and executable and it is estimated that both of these financial vehicles can be funded within two years of System Provider program implementation.

Immigrant investor visa programs or citizenship-by-investment programs are programs designed to attract foreign capital and/or foreign nationals into a selected country by providing the right of residence and/or citizenship in the selected country as an incentive for investment.

The United States Citizenship and Immigration Service (“USCIS”) Employment-Based Fifth Preference Immigrant Investor Funding Program (“EB-5 Program” or “EB-5”) is the current immigrant investor program in the United States. The EB-5 Program was established by Congress in 1990 to stimulate the United States economy through job creation and capital investment by foreign investors and is administered by the USCIS within the United States Department of Homeland Security (“DHS”). The EB-5 Program establishes a path to permanent residency for up to 10,000 immigrants (and immediate family members) annually who invest in an existing or new business in the United States and create or preserve at least 10 U.S. jobs. To obtain an EB-5 visa, foreign investors must invest $1,800,000 (or at least $900,000 in a “Targeted Employment Area”, defined as an area with high unemployment and/or a rural area), and create or preserve at least 10 jobs for United States workers excluding the investor and their immediate family. The EB-5 investment amount has changed over the course of the EB-5 program and is subject to change in the future. The EB-5 Program establishes a path to permanent residency for immigrants (and immediate family members) who invest in an existing or new business in the United States and create or preserve at least 10 United States jobs.

The United States Government has the executive and administrative authority to recapture all unused immigrant visas in the national interest, within the specific context of immigration law, supported by legal, legislative, regulatory and policy precedent, without the need for an act of Congress or Congressional approval.

The United States Congress has the authority to recapture immigrant visas.

Immigration is essential to who we are as a nation, our core values, and our aspirations for our future. The United States can and should create an immigration policy to support America's values as a nation of immigrants while advancing the national interest and national security of the United States.

Established by Immigration Acts of 1921 and 1924, the national origins quota system numerically limited immigration to the United States.

Congress re-codified and combined all previous immigration and naturalization law into the Immigration and Nationality Act (INA) of 1952.

In 1965 amendments to the 1952 immigration law, Congress replaced the national origins system with a preference system designed to reunite immigrant families and attract skilled immigrants to the United States. This change to national policy responded to changes in the sources of immigration since 1924.

The Immigration Act of 1990 (IMMACT 90), Pub. L. No. 101-649, retooled the immigrant selection system once again. IMMACT 90 increased the annual levels of total worldwide legal immigration to the United States and revised the preference categories governing permanent legal immigration. Immigrant visas were divided into three separate categories specific to a given fiscal year: family-sponsored, employment-based, and “diversity” immigrants selected by lottery from countries with low immigration volumes.

The INA and IMMACT 90 are silent with regards to the recapture of unused immigrant visas for use in subsequent fiscal years and annual levels of worldwide immigration to the United States.

IMMACT 90 created a new preference allocation of visas for immigrants who have invested, or are in the process of investing, a designated amount of lawfully obtained capital in a commercial enterprise, and can demonstrate that the investment will create ten or more jobs for qualified U.S. workers. Under the Employment-Based Fifth Preference Immigrant Investor Program (EB-5 Program), qualified immigrant investors may obtain lawful permanent resident status in the United States for themselves and their derivatives.

The EB-5 Program is intended to attract foreign capital, encourage economic development, promote job creation in a new enterprise or job retention in the case of a “troubled business,” and generally benefit the U.S. economy and labor market. To qualify for an EB-5 visa, an applicant must invest the requisite amount of capital in a “new commercial enterprise” which creates fulltime employment of 35 hours per week for ten or more qualifying U.S. workers.

The United States Citizenship and Immigration Services (“USCIS”) has authority to approve in its discretion USCIS Form I-526, Immigration Petition by Alien Entrepreneur (“Form I-526”) and USCIS Form I-829, Petition by Investor to Remove Conditions on Permanent Resident Status (“Form I-829”) involving the EB-5 Program.

From 1921 until 2019, Congress granted 25,294,990 immigrant visas under United States law. During this time, the U.S. Government only issued 20,567,754 immigrant visas counted against immigrant visa numerical limits.

Recapturing all historically unused immigrant visas, minus 180,039 immigrant visas recaptured with special legislation, would result in 4,547,236 immigrant visas.

The recapture of all unused immigrant visas for use in subsequent fiscal years to advance the national interest or national security of the United States will support strong employment for Americans and will strengthen economic recovery for the United States following the COVID-19 outbreak.

Referring to at least FIGS. 1-36, there are up to approximately 4,547,236 unused immigrant visas, from 1921-2021, that can potentially be recaptured in the national interest pursuant to United States law according to some embodiments. In some embodiments, at $1,800,000 per EB-5 Visa, the recapture of 200,000 unused visas annually can result in $360 billion of unlevered funding annually in the national interest; at $900,000 per EB-5 Visa, the recapture of 200,000 unused immigrant visas can result in $180 billion of unlevered funding annually in the national interest. The President of the United States as the executive authority to recapture unuse immigrant visas. The United States Department of State (“State Department”), in conjunction with the DHS, has the administrative authority to recapture unused EB-5 visas in the national interest, within the specific context of immigration law, supported by legal, legislative, regulatory and policy precedent, without the need for an act of Congress or Congressional approval. Moreover, an EB-5 Regional Center application, business plan, and focus on financing and developing infrastructure in the national interest, could provide the procedural basis for the United States government to expedite the recapturing of unused EB-5 visas in the national interest.

There is a need for a system to recapture all historically unused immigrant visas, minus 180,039 immigrant visas recaptured with special legislation, resulting in at least 4,547,236 immigrant visas, and for these immigrant visas to be to apply monetization structuring and/or financial structuring to the immigrant visas to support unprecedented economic development in the United States with the obj ective to preserve or create up to or over 24 million United States jobs on an annual basis for 18 years, resulting in a major expansion of the United States economy, and the potential significant reduction or elimination of the United States National Debt from 12-15 years.

Some embodiments include a computer-implemented system that includes at least specifically programming at least one computer system that the U.S. Government recapture all 4,547,236 immigrant visas over 18 years (an average of 250,000 immigrants per year for 18 years).

Some embodiments include a computer-implemented system that includes at least specifically programming at least one computer system for the aforementioned 250,000 immigrant visas recaptured on an annual basis for 18 years to be part of the proposed U.S. Government Employment-Based National Interest Immigrant Visa Program (EB-NI Program).

Some embodiments include a computer-implemented system that includes at least specifically programming at least one computer system that EB-NI Program immigrant visas will include the EB-5 Program investment and job creation criteria. It is intended that the EB-NI Program will allocate 200,000 EB-NI immigrant visas to System and 50,000 EB-NI immigrant visas to other entities on an annual basis for 18 years.

Some embodiments include a computer-implemented system that includes at least specifically programming at least one computer system for System to qualify for 3,600,000 EB-NI immigrant visas (200,000 immigrant visas annually for 18 years). System will be required to create or preserve 36,000,000 U.S. jobs.

Some embodiments include a computer-implemented system that includes at least specifically programming at least one computer system for System to create or preserve the requisite 36,000,000 U.S. jobs within two years of EB-NI Program implementation.

Some embodiments include a computer-implemented system that includes at least specifically programming at least one computer system for System to secure an agreement with the U.S. Government that System is allocated up to or over 200,000 immigrant visas, and in some instances for these immigrant visas to be EB-NI visas, annually for 18 years or 3,600,000 EB-NI visas in total over 18 years. Other entities will have the potential to receive 50,000 EB-NI visas annually for 18 years or 900,000 EB-NI visas in total over 18 years.

Some embodiments include a computer-implemented system that includes at least specifically programming at least one computer system for System to include a legal and financial structure over 18 years for System to acquire hundreds of billions of dollars of Commercial Airplanes, Commercial Satellites and Spacecraft and, as a related matter, for System to finance and develop trillions of dollars of shipbuilding, transportation, energy, technology, healthcare, education, real estate, manufacturing, infrastructure, and other sectors in the United States. Further, the ability to utilize a funded balance sheet and coordinate investments across multiple interrelated verticals enables System to mitigate low-equity returns and financing risk.

Some embodiments include a computer-implemented system that includes at least specifically programming at least one computer system for System to preserve and create of over 24 million United States jobs on an annual basis for 18 years, resulting in a major expansion of the United States economy, and the potential significant reduction or elimination of the United States National Debt from 12-15 years of EB-NI Program implementation.

Some embodiments include a computer-implemented system that includes at least specifically programming at least one computer system to engage in the recapture of unused immigrant visas using Presidential Action, Federal Administrative Action and Dynamic Immigration.

Some embodiments include a computer-implemented system that includes at least specifically programming at least one computer system or a portion of at least one computer system to aggregate, manage and track immigrant investor visas and/or immigrant investor visas funding including, but not limited to, recaptured immigrant visas to be used for financing investment and/or financing, funding and/or investment and/or credit enhancement to finance certain investment. Some embodiments include a computer-implemented system that includes at least specifically programming at least one computer system or a portion of at least one computer system to aggregate, manage and track immigrant investor visas and/or immigrant investor visas funding including, but not limited to, recaptured immigrant visas to be used for financing investment and/or financing, funding and/or investment and/or credit enhancement to finance investment.

Some embodiments include a computer-implemented system that includes at least specifically programming at least one computer system for the President of the United States to engage in “de facto delegation” and recapture unused immigrant visas for use in subsequent fiscal years based on federal law, within the specific context of immigration law, without the need for an act of Congress or Congressional approval. There is ample legal, legislative, regulatory, and policy precedent to support the position that all unused immigrant visa numbers, including involving the U.S. Citizenship & Immigration Service (“USCIS”) Employment-Based Fifth Preference Immigrant Investor Program, more commonly known as EB-5 (“EB-5” or “EB-5 Program”), can be recaptured for use in subsequent fiscal years and this recapture can be done administratively and without requiring an act of Congress or Congressional approval.

Some embodiments include a computer-implemented system that includes at least specifically programming at least one computer system to realize the intent of Congress, represent a proper exercise of Executive authority, and substantively address existing immigrant visa backlogs without negatively impacting U.S. workers.

Some embodiments include a computer-implemented system that includes at least specifically programming at least one computer system for the current statutory framework to allow and, indeed, require the full and fair allocation of all available immigrant visa numbers; such an initiative would effect Congressional intent, relieve long-standing immigrant visa backlogs, and responsibly align visa demand with visa availability.

Some embodiments include a computer-implemented system that includes at least specifically programming at least one computer system for the President of the United States to issue a Presidential Proclamation or Presidential Proclamations and to direct the U.S. Department of State (“State Department”) and U.S. Department of Homeland Security (“DHS”) to recapture unused immigrant visas for use in subsequent fiscal years based on federal law, within the specific context of immigration law, without the need for an act of Congress or Congressional approval.

Some embodiments include a computer-implemented system that includes at least specifically programming at least one computer system for the President of the United States to direct the State Department and DHS to recapture unused immigrant visas for use in subsequent fiscal years based on federal law, within the specific context of immigration law, without the need for an act of Congress or Congressional approval.

Some embodiments include a computer-implemented system that includes at least specifically programming at least one computer system that the recapture of unused immigrant visas for use in subsequent fiscal years be done presidentially and said recapture, and its attached legal basis, not requiring administrative action to create the substantive legal basis for the recapture but simply administrative action to implement the recapture itself. A legal consequence of this conclusion is that the System proposed Presidential Proclamation for the recapture of unused immigrant visas for use in subsequent fiscal years will provide a legal foundation for both the President and U.S. Citizenship and Immigration Services (USCIS) to be exempted from the notice-and-comment rulemaking requirements of the Administrative Procedure Act (APA) (5 USC § 551 et seq. (1946)), which usually requires advance notice and a period for public comment on proposed new rules or rule amendments. Regardless of the aforementioned conclusion, the Presidential Proclamation and any related administrative action will also be exempted from the APA § 553 notice-and-comment rulemaking requirements as a result of the “military or foreign affairs function of the United States” exclusion in APA § 553 (a)(1) and the “good cause” exclusion in APA § 553 (b)(3)(B).

Some embodiments include a computer-implemented system that includes at least specifically programming at least one computer system that the U.S. Government recapture up to or over 4,547,236 immigrant visas.

Some embodiments include a computer-implemented system that includes at least specifically programming at least one computer system that the U.S. Government recapture up to or over 4,547,236 immigrant visas over 18 years (an average of 250,000 immigrants per year for 18 years).

Some embodiments include a computer-implemented system that includes at least specifically programming at least one computer system for the aforementioned 250,000 immigrant visas recaptured on an annual basis for 18 years to be part of the proposed U.S. Government Employment-Based National Interest Immigrant Visa Program (EB-NI Program).

Some embodiments include a computer-implemented system that includes at least specifically programming at least one computer system that EB-NI Program immigrant visas will include the EB-5 Program investment and job creation criteria. It is intended that the EB-NI Program will allocate 200,000 EB-NI immigrant visas to System and 50,000 EB-NI immigrant visas to other entities on an annual basis for 18 years.

Some embodiments include a computer-implemented system that includes at least specifically programming at least one computer system for System to qualify for 3,600,000 EB-NI immigrant visas (200,000 immigrant visas annually for 18 years). System will be required to create or preserve 36,000,000 U.S. jobs.

Some embodiments include a computer-implemented system that includes at least specifically programming at least one computer system for System to create or preserve the requisite 36,000,000 U.S. jobs within two years of EB-NI Program implementation.

Some embodiments include a computer-implemented system that includes at least specifically programming at least one computer system for System to secure an agreement with the U.S. Government that System is allocated up to or over 200,000 immigrant visas, and in some instances for these immigrant visas to be EB-NI visas, annually for 18 years or 3,600,000 EB-NI visas in total over 18 years. Other entities will have the potential to receive 50,000 EB-NI visas annually for 18 years or 900,000 EB-NI visas in total over 18 years.

Some embodiments include a computer-implemented system that includes at least specifically programming at least one computer system for System to include a legal and financial structure over 18 years for System to acquire hundreds of billions of dollars of Commercial Airplanes, Commercial Satellites and Spacecraft and, as a related matter, for System to finance and develop trillions of dollars of shipbuilding, transportation, energy, technology, healthcare, education, real estate, manufacturing, infrastructure, and other sectors in the United States. Further, the ability to utilize a funded balance sheet and coordinate investments across multiple interrelated verticals enables System to mitigate low-equity returns and financing risk.

Some embodiments include a computer-implemented system that includes at least specifically programming at least one computer system for System to preserve and create of over 24 million United States jobs on an annual basis for 18 years, resulting in a major expansion of the United States economy, and the potential significant reduction or elimination of the United States National Debt from 12-15 years of EB-NI Program implementation.

Some embodiments include a computer-implemented system that includes at least specifically programming at least one computer system to develop a program to apply monetization structuring and/or financial structuring to U.S. immigration policy to advance the national interest and national security of the United States which, in some embodiments, will be known as “System Dynamic Immigration” or “Dynamic Immigration”.

Some embodiments include a computer-implemented system that includes at least specifically programming at least one computer system to develop a program for Dynamic Immigration to exist at the intersection of United States immigration policy and economic development.

Some embodiments include a computer-implemented system that includes at least specifically programming at least one computer system to develop a program that the U.S. Government implement Dynamic Immigration as a whole-of-government public private partnership with System.

Some embodiments include a computer-implemented system that includes at least specifically programming at least one computer system to develop a program that provides that Dynamic Immigration will (i) enhance the flow of credit to targeted sectors of the United States economy; (ii) make those segments of the capital market more efficient and transparent; (iii) reduce the risk to investors and other suppliers of capital to finance and develop those sectors.

Some embodiments include a computer-implemented system that includes at least specifically programming at least one computer system that with Dynamic Immigration, the $1.8 million funding from each EB-NI immigrant visa will be deployed as a credit enhancement and leveraged at a 5:1 ratio (System Credit Enhancement to System EB-NI Funding) to raise up to or over $9 million of funding per EB-NI immigrant visa for investment in the United States and the creation or preservation of up to or over 119 U.S. jobs.

Some embodiments include a computer-implemented system that includes at least specifically programming at least one computer system that the System component of the EB-NI Program engages this opportunity 200,000 times to raise $360 billion of unlevered funding ($1.8 million×200,000 EB-NI immigrant visas=$360 billion) on an annual basis for 18 years.

Some embodiments include a computer-implemented system that includes at least specifically programming at least one computer system that the $360 billion of EB-NI funding is intended to be leveraged at a 5:1 ratio to raise $1.8 trillion of funding (System Credit Enhancement to System EB-NI Funding) for public-private partnership investment in U.S. aerospace, shipbuilding, transportation, energy, technology, healthcare, education, real estate, manufacturing, infrastructure, and other sectors in the United States to create or preserve over 24 million U.S. jobs on an annual basis for 18 years.

Some embodiments include a computer-implemented system that includes at least specifically programming at least one computer system that Dynamic Immigration includes institutional financing of $1.8 million EB-NI immigrant visas through a System Immigrant Visa Consumer Financial Market and System Immigrant Visa Consumer Financial Product.

Some embodiments include a computer-implemented system that includes at least specifically programming at least one computer system to aggregate, manage and track 4,547,236 unused immigrant visas to apply monetization structuring and/or financial structuring to the immigrant visas.

Some embodiments include a computer-implemented system that includes at least specifically programming at least one computer system to aggregate, manage and track 4,547,236 unused immigrant visas to be part of the proposed U.S. Government Employment-Based National Interest Immigrant Visa Program (EB-NI Program) which will include the EB-5 Program investment and job creation criteria.

Some embodiments include a computer-implemented system that includes at least specifically programming at least one computer system to finance immigrant visas.

Some embodiments include a computer-implemented system that includes at least specifically programming at least one computer system to provide a legal structure for to finance the $1,800,000 (the former EB-5 standard minimum investment amount is $1,800,000 and the former minimum investment in a targeted employment area (TEA) is $900,000) required for an EB-NI immigrant visa investment, as opposed to a cash investment by an immigrant, and the creation of a System Immigrant Visa Consumer Financial Market and System Immigrant Visa Consumer Financial Product.

Some embodiments include a computer-implemented system that includes at least specifically programming at least one computer system to develop a System Immigrant Visa Consumer Financial Market and System Immigrant Visa Consumer Financial Product.

Some embodiments include a computer-implemented system that includes at least specifically programming at least one computer system to develop a system to apply monetization structuring and/or financial structuring to U.S. immigration policy to support America's values as a nation of immigrants while advancing the national interest and national security of the United States.

Some embodiments include a computer-implemented system that includes at least specifically programming at least one computer system to develop of a System Immigrant Consumer Financial Market and System Immigrant Consumer Financial Product to facilitate the financing of 200,000 EB-NI immigrant visas on an annual basis for 18 years. The major consumer financial markets include mortgage lending, student loans, automobile loans, credit cards and payments, payday loans and other credit alternative financial products, and checking accounts and substitutes.

Some embodiments include a computer-implemented system that includes at least specifically programming at least one computer system to develop JOBS America to play an integral role for System to apply monetization structuring and/or financial structuring to recaptured unused immigrant visas including, but not limited to, 200,000 EB-NI immigrant visas on an annual basis for 18 years.

Some embodiments include a computer-implemented system that includes at least specifically programming at least one computer system to facilitate the development of a private national infrastructure bank, Global Infrastructure Development Bank (“GIDB”), focused on infrastructure development in the United States and globally.

Some embodiments include a computer-implemented system that includes at least specifically programming at least one computer system for GIDB to partner with all fifty states and all five territories of the United States to finance and develop infrastructure at the national, regional, state and local level. System is uniquely well situated to develop various forms of external credit enhancement to provide support to both Commercial Airplane leases and infrastructure project cash flows during the life of both asset classes. The System Credit Enhancement structure is intended to augment the ability for both a Commercial Airplane lease and infrastructure proj ect to ultimately retire debt by enhancing the ability of both asset classes to meet debt service requirements.

Some embodiments include a computer-implemented system that includes at least specifically programming at least one computer system that, in addition to infrastructure development, for GIDB to finance other projects on a national and international basis.

Some embodiments include a computer-implemented system that includes at least specifically programming at least one computer system for JOBS America (Joint Opportunity to Build and Strengthen America) is an intended U.S. Government-wide Initiative to facilitate investment and job creation in the United States by Americans and qualified foreigners including citizens of foreign nations that obtain an EB-NI immigrant visa.

Some embodiments include a computer-implemented system that includes at least specifically programming at least one computer system for JOBS America to be housed in the U.S. Department of Commerce.

Some embodiments include a computer-implemented system that includes at least specifically programming at least one computer system for System to develop a public private partnership with JOBS America to employ, place and/or staff EB-NI immigrants with businesses or other entities across the United States.

Some embodiments include a computer-implemented system that includes at least specifically programming at least one computer system to collaborate with JOBS America to employ, place and/or staff hundreds of thousands of EB-NI immigrants as medical doctors, nurses, engineers, computer programmers, information technology professionals, biologists, teachers, professors, professional educators, and in other occupations across America, in various industries and sectors.

Some embodiments include a computer-implemented system that includes at least specifically programming at least one computer system for JOBS America to establish criteria for businesses, non-profit organizations and other entities to qualify for and participate in JOBS America as JOBS America Commercial Partners or JOBS America Non-Profit Partners and all JOBS America Commercial Partners or JOBS America Non-Profit Partners must advance the national interest or national security and military or foreign affairs function of the United States.

Some embodiments include a computer-implemented system that includes at least specifically programming at least one computer system for JOBS America immigrants will be known as JOBS America Immigrant Partners (“JOBS America Immigrant Partners” or “Immigrant Partners”) and Immigrant Partners will be an engine of economic development across the United States.

Some embodiments include a computer-implemented system that includes at least specifically programming at least one computer system for Immigrant Partners to be required to be employed, placed and/or staffed by a System-JOBS America public private partnership and/or other entities for a certain predetermined period of time, including up to 10 years, including in underserved geographic and/or employment areas or other geographic and employment areas in the United States.

Some embodiments include a computer-implemented system that includes at least specifically programming at least one computer system for each Immigrant Partner to facilitate up to or over a $9 million investment in the United States and the creation of 119 U.S. jobs.

Some embodiments include a computer-implemented system that includes at least specifically programming at least one computer system for System Global Financial Syndicate to establish relationships with global capital market sources to raise on an annual basis up to or over 18 years (i) up to or over $360 billion of debt capital to serve as a credit enhancement for System projects (“System Global Financial Syndicate Loan 1”); (ii) $36 billion of debt capital to service the interest component of System Global Financial Syndicate Loan 1 (“System Global Financial Syndicate Loan 2”); (iii) $1.8 trillion of debt capital to service System projects (“System Global Financial Syndicate Annual Project Financing”).

Some embodiments include a computer-implemented system that includes at least specifically programming at least one computer system for System Global Financial Syndicate Loan 1−$1,800,000 Loan×200,000 EB-NI Visas=$360 Billion Loan.

Some embodiments include a computer-implemented system that includes at least specifically programming at least one computer system for System Global Financial Syndicate to provide $1,800,000 loan to System for recaptured immigrant visas, including but not limited to EB-NI visas, for a total of 200,000 EB-NI immigrant visas on an annual basis for a total of $360 billion annually for 18 years (System Global Financial Syndicate Loan 1). Foundational credit for System Global Financial Syndicate Loan 1 ($1,800,000 loan) is based upon future receipt of EB-NI immigrant funding.

Some embodiments include a computer-implemented system that includes at least specifically programming at least one computer system for System Global Financial Syndicate Loan 1 to be (i) 10-year term; (ii) interest-only loan; (iii) 1% interest (estimated interest rate) resulting in $180,000 of interest during 10-year term; (iv) System is responsible for 100% of the interest, or $180,000, at loan origination. The future value of $180,000 at 6% interest calculated monthly over 10 years is $327,491 System Global Financial Syndicate obtains a $327,491 future value benefit at origination of System Global Financial Syndicate Loan 1 ($1,800,000 loan to System). System is responsible for $1,800,000 principal at the end of the 10-year term. System will secure System Global Financial Syndicate Loan 1 ($1,800,000 loan) with System collateral including Commercial Airplanes, Commercial Satellites, Spacecraft, other System assets, other System revenue streams.

Some embodiments include a computer-implemented system that includes at least specifically programming at least one computer system for System Global Financial Syndicate Loan 2−$180,00 Loan×200,000 EB-NI Visas=$36 Billion Loan.

Some embodiments include a computer-implemented system that includes at least specifically programming at least one computer system for System Global Financial Syndicate to provide $180,000 loan to System for each allocated EB-NI immigrant visa for a total of 200,00 EB-NI immigrant visas on an annual basis for a total of $36 billion annually for 18 years (System Global Financial Syndicate Loan 2).

Some embodiments include a computer-implemented system that includes at least specifically programming at least one computer system for System to (i) finance $180,000 Interest Payment for System Global Financial Syndicate Loan 2; (ii) System Global Financial Syndicate provides $180,000 loan to System; (iii) 10-year term; (iv) principal and interest; (v) interest rate to be determined; (vi) System will secure System Global Financial Syndicate Loan 2 ($180,000 loan) with System collateral including Commercial Airplanes, Commercial Satellites, Spacecraft, other System assets, other System revenue streams.

Some embodiments include a computer-implemented system that includes at least specifically programming at least one computer system to develop a System Immigrant Financial Product.

Some embodiments include a computer-implemented system that includes at least specifically programming at least one computer system for System Immigrant Financial Product to (i) to involve recaptured immigrant visas, including but not limited to, EB-NI immigrant visas; (ii) will cost $360,000 each; (iii) can be financed over 10 years, 20 years or 30 years; (iv) can be scaled, resulting in up to 200,000 System Immigrant Financial Product transactions annually for 18 years; (v) will be insured and secured by System and; (vi) can result in System financing $72 billion of insured and secured transactions annually for 18 years involving the System Immigrant Financial Product.

Some embodiments include a computer-implemented system that includes at least specifically programming at least one computer system for System Immigrant Visa Financial Product (Insured and Secured Transaction for $360,000) for recaptured immigrant visa to apply monetization structuring and/or financial structuring to the immigrant visas including, but not limited to, EB-NI Immigrant, to finance $360,000 (principal and Interest) and involve (i) 10-year term, 20-year term, 30-year term; (ii) principal and interest; (iii) interest rate to be determined; (iv) $360,000 loan to EB-NI Immigrant; (v) $180,000—Interest payment involving System Global Financial Syndicate Loan 1; (vi) $180,000—Interest payment to System for $1,800,000 loan

Some embodiments include a computer-implemented system that includes at least specifically programming at least one computer system to insure System Immigrant Visa Financial Product ($360,000 loan to EB-NI Immigrant).

Some embodiments include a computer-implemented system that includes at least specifically programming at least one computer system for System to secure System Immigrant Visa Financial Product ($360,000 loan to EB-NI Immigrant) with System collateral including Commercial Airplanes, Commercial Satellites, Spacecraft, other System assets, other System revenue streams.

Some embodiments include a computer-implemented system that includes at least specifically programming at least one computer system for $360,000 loan to EB-NI Immigrant×200,000 EB-NI Immigrants=$72 billion of insured and secured transactions on an annual basis for 18 years.

Some embodiments include a computer-implemented system that includes at least specifically programming at least one computer system for System for possible assignment of $72 billion of insured and secured transactions on an annual basis for 18 years to a third-party financial institution in partnership with System.

In some embodiments, the system is configured to collect, process, store, and track immigrant visas. In some embodiments, the system is configured to identify one or more projects which match criteria and/or rules associated with immigrant visas. As used herein, in some embodiments, the term “aggregate” means “aggregate, manage and/or track”.

Presidential Action and Federal Administrative Action:

In some embodiments, the system to applies monetization structuring and/or financial structuring to the immigrant visas by applying the former $1,800,000 EB-5 and/or former $900,000 targeted employment area (TEA) EB-5 investment and EB-5 job creation requirements to some or all recaptured immigrant visas and/or recaptured unused immigrant visas and/or unused immigrant visas that can be recaptured by Presidential action and/or federal administrative action.

In some embodiments, the system is designed to be in the national interest and national in scope, and offering competitive advantages for investment in commercial airplanes, commercial satellites and spacecraft, infrastructure, shipbuilding, transportation, energy, technology, healthcare, education, real estate, manufacturing, infrastructure, and other sectors in the United States and on a global basis.

In some embodiments, the system utilizes a capitalized holding company structure maintaining an investment-grade credit rating, ideally from at least two of the three major rating agencies to develop, construct and support immigrant visa financial markets, immigrant visa financial products, immigrant visa financial tools, immigrant visa financial structures, and/or immigrant visa financial algorithms to support job creation, direct investment, credit enhancement, loan guarantees and other economic development in multiple industry sectors in the United States and on a global basis.

In December 2019, a novel (new) coronavirus known as SARS-CoV-2 (“COVID-19”) was first detected in Wuhan, Hubei Province, People's Republic of China, causing outbreaks of the coronavirus disease COVID-19 that has now spread globally.

The Secretary of Health and Human Services (HHS) declared a public health emergency on Jan. 31, 2020, under section 319 of the Public Health Service Act (42 U.S.C. 247d), in response to COVID-19.

On Mar. 11, 2020, the World Health Organization announced that the COVID-19 outbreak can be characterized as a pandemic, as the rates of infection continue to rise in many locations around the world and across the United States.

On Mar. 13, 2020, in Proclamation 9994, pursuant to the National Emergencies Act, 50 U.S.C. 1601 et seq., it was declared that the COVID-19 outbreak in the United States constituted a national emergency that posed a threat to our national security (“the national emergency”). It was also determined on that same day that the COVID-19 outbreak constituted an emergency of nationwide scope, pursuant to section 501(b) of the Stafford Act (42 U.S.C. 5191(b)).

COVID-19 has significantly disrupted the lives of Americans. Since this national emergency was declared, the American people have united behind a policy of mitigation strategies, such as social distancing, to reduce the spread of COVID-19.

The result of the COVID-19 outbreak and these necessary mitigation measures has been a dramatic downturn in our economy. National unemployment claims reached historic levels. In the days between the national emergency declaration and May 23, 2020, more than 41 million Americans filed for unemployment, and the unemployment rate reached 14.7 percent.

Since March 2020, United States businesses and their workers have faced extensive disruptions while undertaking certain public health measures necessary to flatten the curve of COVID-19 and reduce the spread of SARS-CoV-2, the virus that causes COVID-19. The overall unemployment rate in the United States nearly quadrupled between February and May of 2020 producing some of the most extreme unemployment ever recorded by the Bureau of Labor Statistics.

The Federal Government must act swiftly and aggressively to combat COVID-19. The national emergency caused by the COVID-19 outbreak in the United States continues to pose a grave threat to our health and security. As of March 1, 2021, the United States had experienced over 28 million confirmed COVID-19 cases and over 500,000 COVID-19 deaths. It is the policy of my Administration to implement science-based public health measures, across all areas of the Federal Government, to prevent further spread of the disease.

The pandemic caused by COVID-19 has led to an economic crisis marked by the closure of small businesses, job loss, food and housing insecurity, and increased challenges for working families balancing jobs and caregiving responsibilities. The current economic crisis has affected Americans throughout the Nation.

The problems are exacerbated because State and local governments are being forced to consider steep cuts to critical programs to address revenue shortfalls the pandemic has caused. In addition, many individuals, families, and small businesses have had difficulties navigating relief programs with varying eligibility requirements, and some are not receiving the intended assistance. The economic crisis resulting from the pandemic must be met by the full resources of the Federal Government.

The economy of the United States has been adversely impacted by the COVID-19 pandemic and our nation must confront a protracted economic recovery with persistent high unemployment.

Immigration is essential to who we are as a nation, our core values, and our aspirations for our future. The United States can and should create an immigration policy to support America's values as a nation of immigrants while advancing the national interest and national security of the United States.

Established by Immigration Acts of 1921 and 1924, the national origins quota system numerically limited immigration to the United States.

Congress re-codified and combined all previous immigration and naturalization law into the Immigration and Nationality Act (INA) of 1952.

In 1965 amendments to the 1952 immigration law, Congress replaced the national origins system with a preference system designed to reunite immigrant families and attract skilled immigrants to the United States. This change to national policy responded to changes in the sources of immigration since 1924.

The Immigration Act of 1990 (IMMACT 90), Pub. L. No. 101-649, retooled the immigrant selection system once again. IMMACT 90 increased the annual levels of total worldwide legal immigration to the United States and revised the preference categories governing permanent legal immigration. Immigrant visas were divided into three separate categories specific to a given fiscal year: family-sponsored, employment-based, and “diversity” immigrants selected by lottery from countries with low immigration volumes.

The INA and IMMACT 90 are silent with regards to the recapture of unused immigrant visas for use in subsequent fiscal years and annual levels of worldwide immigration to the United States.

IMMACT 90 created a new preference allocation of visas for immigrants who have invested, or are in the process of investing, a designated amount of lawfully obtained capital in a commercial enterprise, and can demonstrate that the investment will create ten or more jobs for qualified U.S. workers. Under the Employment-Based Fifth Preference Immigrant Investor Program (EB-5 Program), qualified immigrant investors may obtain lawful permanent resident status in the United States for themselves and their derivatives.

The EB-5 Program is intended to attract foreign capital, encourage economic development, promote job creation in a new enterprise or job retention in the case of a “troubled business,” and generally benefit the U.S. economy and labor market. To qualify for an EB-5 visa, an applicant must invest the requisite amount of capital in a “new commercial enterprise” which creates fulltime employment of 35 hours per week for ten or more qualifying U.S. workers.

The United States Citizenship and Immigration Services (“USCIS”) has authority to approve in its discretion USCIS Form I-526, Immigration Petition by Alien Entrepreneur (“Form I-526”) and USCIS Form I-829, Petition by Investor to Remove Conditions on Permanent Resident Status (“Form I-829”) involving the EB-5 Program.

From 1921 until 2021, Congress granted 25,294,990 immigrant visas under United States law. During this time, the U.S. Government only issued 20,567,754 immigrant visas counted against immigrant visa numerical limits.

Recapturing all historically unused immigrant visas, minus 180,039 immigrant visas recaptured with special legislation, would result in 4,547,236 immigrant visas.

The recapture of all unused immigrant visas for use in subsequent fiscal years to advance the national interest or national security of the United States will support strong employment for Americans and will strengthen economic recovery for the United States following the COVID-19 outbreak.

NOW, THEREFORE, I, JOSEPH R. BIDEN JR., President of the United States, by the authority vested in me by the Constitution and the laws of the United States of America, including the International Emergency Economic Powers Act (50 U.S.C. 1701 et seq.) (IEEPA), the National Emergencies Act (50 U.S.C. 1601 et seq.) (NEA), sections 212(f) and 215(a) of the Immigration and Nationality Act of 1952 (INA), 8 U.S.C. 1182(f) and 1185(a), Immigration Act of 1990 (IMMACT 90), Pub. L. No. 101-649, and section 301 of title 3, United States Code, hereby find and proclaim that the COVID-19 outbreak in the United States and related national emergency constitutes an international emergency and involves an unusual and extraordinary threat, which has its source in whole or substantial part outside the United States, to the national security, foreign policy, or economy of the United States. I also hereby find and proclaim that the entry into the United States of qualified immigrants described in Sections 1-6 of this proclamation be regulated to advance the national interest or national security and foreign affairs function of the United States and that their entry be subject to administrative processing. Pursuant to this declaration, I direct as follows:

Section 1. Emergency Authority. (a) Working in coordination with the Secretary of State and the Attorney General, the Secretary of Homeland Security shall designate U.S. Citizenship and Immigration Services (USCIS) to recapture all unused immigrant visas for use in subsequent fiscal years to advance the national interest or national security of the United States.

(b) Employment-Based National Interest Immigrant Visa Program. There is established Employment-Based National Interest Immigrant Visa Program (EB-NI Program) involving only the recapture of all immigrant visas for use in subsequent fiscal years to advance the national interest or national security of the United States. USCIS shall administer the EB-NI Program to issue EB-NI immigrant visas to qualified immigrants.

(c) EB-NI Program Comprehensive Policy. The Secretary of State, the Attorney General, the Secretary of Homeland Security, and the Secretary of Commerce shall review existing legislation, regulations, orders, guidance documents, policies, and any other similar agency actions to develop a comprehensive policy to regulate and administer the recapture of all immigrant visas for use in subsequent fiscal years to advance the national interest or national security of the United States pursuant to the EB-NI Program.

Section 2. (a) Recapture of Immigrant Visas for Use in Subsequent Fiscal Years. It is the policy of the United States that all unused immigrant visas from prior fiscal years be recaptured for use in subsequent fiscal years to advance the national interest or national security of the United States and that all of these recaptured immigrant visas shall be allocated to the EB-NI Program pursuant to Section 1 herein.

(b) EB-NI Immigrant Visa Investment and Job Creation Criteria. It is the policy of the United States that all EB-NI immigrant visas be allocated to qualified immigrants consistent with the EB-5 Program investment and job creation criteria and all EB-NI immigrant visas (1) receive expedited U.S. Government processing; (2) be aggregated for immigrant investment purposes to advance the national interest or national security of the United States pursuant to Section 1 herein.

(c) United States Citizenship and Immigration Services (USCIS) Processing. Department of Homeland Security shall designate USCIS to administer the processing of all immigrant visas pursuant to Section 1 and Section 2 herein.

Section 3. (a) Recapture of Immigrant Visas and Annual Worldwide Levels of Immigration. It is the policy of the United States that all recaptured immigrant visas pursuant to Section 1 and Section 2 herein and known as EB-NI immigrant visas shall not be subject to the annual numerical limitations for worldwide levels of family-based and employment-based immigration as provided for by the INA and IMMACT 90. It is the policy of the United States that all recaptured immigrant visas pursuant to Section 1 and Section 2 herein and known as EB-NI immigrant visas (1) exempt spouses and children from annual worldwide employment-based immigration limits; (2) exclude per-country visa caps from annual worldwide employment-based immigration limits; (3) exclude employment-based visa caps from annual worldwide employment-based immigration limits.

(b) Annual Limitation on EB-NI Program Immigrant Visas. The annual worldwide level of EB-NI immigrant visas pursuant to Section 1 and Section 2 herein shall not exceed 250,000.

Section 4. Direct and Indirect Jobs. New commercial enterprises involving the recapture of immigrant visas pursuant to Section 1 and Section 2 herein shall qualify for EB-5 Program job creation requirements based on economic projections of either direct or indirect job preservation or creation.

Section 5. JOBS America. (a) There is established JOBS America (Joint Opportunity to Build and Strengthen America), a Government wide Initiative to facilitate investment and job creation in the United States by Americans and qualified foreigners including citizens of foreign nations that obtain an immigrant visa pursuant to Section 1 and Section 2 herein. JOBS America is to be housed in the Department of Commerce.

(b) JOBS America Partners. JOBS America will establish criteria for businesses, non-profit organizations and other entities to qualify for and participate in JOBS America as JOBS America Commercial Partners or JOBS America Non-Profit Partners. Citizens of foreign nations that obtain an immigrant visa pursuant to Section 1 and Section 2 herein who are selected to participate in JOBS America shall be classified as JOBS America Immigrant Partners. The Department of Commerce shall provide funding and administrative support for JOBS America through resources and staff assigned to work on JOBS America, to the extent permitted by law within existing appropriations.

Section 6. Department of Commerce, Department of Homeland Security and Department of State. JOBS America shall coordinate with Department of Commerce, Department of Homeland Security and Department of State to establish uniform and nation-specific policies and procedures for citizens of foreign nations that obtain an immigrant visa pursuant to Section 1 and Section 2 herein to participate in JOBS America to advance the national interest or national security and foreign affairs function of the United States.

Section 7. Notice. In exercising the authority pursuant to Section 1 herein, the Secretary of Homeland Security shall provide written notice to the Congress.

Sec. 8. Severability. It is the policy of the United States to enforce this proclamation to the maximum extent possible to advance the interests of the United States. Accordingly:

(a) if any provision of this proclamation, or the application of any provision to any person or circumstance, is held to be invalid, the remainder of this proclamation and the application of its provisions to any other persons or circumstances shall not be affected thereby; and

(b) if any provision of this proclamation, or the application of any provision to any person or circumstance, is held to be invalid because of the lack of certain procedural requirements, the relevant executive branch officials shall implement those procedural requirements to conform with existing law and with any applicable court orders.

Sec. 9. General Provisions. (a) Nothing in this proclamation shall be construed to impair or otherwise affect:

(i) the authority granted by law to an executive department or agency, or the head thereof; or,

(ii) the functions of the Director of the Office of Management and Budget relating to budgetary, administrative, or legislative proposals.

(b) This proclamation shall be implemented consistent with applicable law.

(c) This proclamation is not intended to, and does not, create any right or benefit, substantive or procedural, enforceable at law or in equity by any party against the United States, its departments, agencies, or entities, its officers, employees, or agents, or any other person.

Immigration National Security and Immigration Foreign Affairs:

The Constitution and Acts of Congress confer on the President broad authority to suspend or restrict the entry of aliens outside the United States when he deems it in the Nation's interest. See United States ex rel. Knauff v. Shaughnessy, 338 U.S. 537, 542 (1950); 8 U.S.C. 1182(f), 1185(a)(1). “The exclusion of aliens is a fundamental act of sovereignty” that lies in the “legislative power” and also “is inherent in the executive power to control the foreign affairs of the nation.” Knauff, 338 U.S. at 542; see Harisiades v. Shaughnessy, 342 U.S. 580, 588-589 (1952) (Control of the Nation's borders is “interwoven” with “the conduct of foreign relations” and “the war power.”).

Congress has addressed admission into the United States in the Immigration and Nationality Act (INA), 8 U.S.C. 1101 et seq., which accords the President broad discretion to suspend or restrict the entry of aliens abroad.

Under the INA, admission into the United States normally requires a valid visa or other valid travel document. See 8 U.S.C. 1181, 1182(a)(7)(A)(i) and (B)(i)(II), 1203. Applying for a visa typically requires an in-person interview and results in a decision by a State Department consular officer. 8 U.S.C. 1201(a)(1), 1202(h), 1204; 22 C.F.R. 42.62. Although a visa normally is necessary for admission, it does not guarantee admission; the alien still must be found admissible upon arriving at a port of entry. 8 U.S.C. 1201(h), 1225(a). Congress has enabled nationals of certain countries to seek temporary admission without a visa under the Visa Waiver Program. 8 U.S.C. 1182(a)(7)(B)(iv); 8 U.S.C. 1187 (2012 & Supp. III 2015). In 2015, Congress excluded from travel under that Program aliens who are dual nationals of or recent visitors to Iraq or Syria, where “[t]he Islamic State of Iraq and the Levant (ISIL) . . . maintain[s] a formidable force”; as well as nationals of and recent visitors to countries designated by the Secretary of State as state sponsors of terrorism (currently Iran, Sudan, and Syria). (U.S. Dep't of State, Country Reports on Terrorism 2015, at 6, 299302 (June 2016), https://goo.gl/40GmOS; see 8 U.S.C. 1187(a)(12)(A)(i) and (ii) (Supp. III 2015); App. 7a n.4.).

Congress also has authorized the Department of Homeland Security (DHS) to designate additional countries of concern, considering whether a country is a “safe haven for terrorists,” “whether a foreign terrorist organization has a significant presence” in the country, and “whether the presence of an alien in the country . . . increases the likelihood that the alien is a credible threat to” U.S. national security. 8 U.S.C. 1187(a)(12)(D)(i) and (ii) (Supp. III 2015).

Applying those criteria, in February 2016, DHS excluded recent visitors to Libya, Somalia, and Yemen from travel under the Visa Waiver Program. (DHS, DHS Announces Further Travel Restrictions for the Visa Waiver Program (Feb. 18, 2016), https://goo.gl/OXTqb5; App. 7a n.4.).

Beyond the Executive's authority to remove nationals of particular countries from the Visa Waiver Program, Congress has accorded the President broad discretion to suspend or restrict the admission of aliens. Section 1182(f) of Title 8 of the United States Code provides:

Whenever the President finds that the entry of any aliens or of any class of aliens into the United States would be detrimental to the interests of the United States, he may by proclamation, and for such period as he shall deem necessary, suspend the entry of all aliens or any class of aliens as immigrants or nonimmigrants, or impose on the entry of aliens any restrictions he may deem to be appropriate.

Section 1185(a)(1) of Title 8 further grants the President broad authority to adopt “reasonable rules, regulations, and orders” governing entry or removal of aliens, “subject to such limitations and exceptions as [he] may prescribe.”

As the President has the legal authority to restrict the entry of certain aliens when he deems it in the Nation's interest, the Constitution and Acts of Congress necessarily confer on the President broad authority to allow entry of certain aliens when the President deems it in the Nation's interest.

Section 1182(f) of Title 8 provides that the “President” “may by proclamation” “impose on the entry of aliens any restrictions he may deem to be appropriate.”

As it relates to entry, Section 1185(a)(1) of Title 8 grants the President broad authority to adopt “reasonable rules, regulations, and orders” governing entry of aliens, “subject to such limitations and exceptions as [he] may prescribe.”

Consistent with Section 1185(a)(1) and Section 1182(f) of Title 8, the President can impose, restrict and provide limitations and exceptions that recaptured EB-5 visas allocated to certain aliens be used only to advance the national interest or national security of the United States.

System has developed a novel and transformational patent pending program for System to utilize recaptured immigrant visas to finance and develop aerospace, shipbuilding, transportation, energy, technology, healthcare, education, real estate, manufacturing, infrastructure, and other sectors in the United States. Further, the ability to utilize a funded balance sheet and coordinate investments across multiple interrelated verticals enables the system to mitigate low-equity returns and financing risk.

The combined workings of (i) National Emergencies Act; (ii) Stafford Act; (iii) International Emergency Economic Powers Act; (iv) Section 1185(a)(1) and Section 1182(f) of Title 8 of the United States Code (Immigration and Nationality Act); (v) Immigration Act of 1990; (vi) Employment-Based Fifth Preference Immigrant Investor Program (EB-5); (vii) Administrative Procedure Act and; (viii) presidential executive power within immigration law provides President Biden the necessary legal authority to authorize the United States Government to recapture 4,500,000 immigrant visas (250,000 immigrant visas annually for approximately 18 consecutive years) and to allocate these immigrant visas to the EB-5 category consistent with the System program to advance the national interest or national security and foreign affairs function of the United States presidentially.

This is precisely what President Biden can accomplish in the Proclamation.

Additionally, the Proclamation provides President Biden the necessary legal authority to recapture unused immigrant visas for use in subsequent fiscal years and to allocate these immigrant visas to the Employment-Based National Interest Immigrant Visa Program (EB-NI Program).

EB-NI Program immigrant visas will include the EB-5 Program investment and job creation criteria.

Immigrant Visa Recapture in the National Interest:

The 2019 novel coronavirus known as SARS-CoV-2, the virus causing outbreaks of the disease COVID-19, has significantly disrupted the lives of Americans. In Proclamation 9994 of Mar. 13, 2020 (Declaring a National Emergency Concerning the Novel Coronavirus Disease (COVID-19) Outbreak), President Trump declared, pursuant to the National Emergencies Act, 50 U.S.C. 1601 et seq., that the COVID-19 outbreak in the United States constituted a national emergency that posed a threat to our national security (“the national emergency”).

President Trump also determined that same day that the COVID-19 outbreak constituted an emergency of nationwide scope, pursuant to section 501(b) of the Stafford Act (42 U.S.C. 5191(b)).

If proclaimed by President Biden in the Proclamation, the current national emergency will also involve an unusual and extraordinary threat to the United States which has its source in whole or substantial part outside the United States, to the national security, foreign policy, or economy of the United State pursuant to the International Emergency Economic Powers Act (IEEPA), Title II of Pub.L. 95-223, 91 Stat. 1626, enacted Oct. 28, 1977.

IEEPA (P.L. 95-223 (Oct. 28, 1977), 91 Stat. 1626, codified as amended at 50 U.S.C. § 1701 et seq. (2018) is one of 123 emergency statutes under the umbrella of the National Emergencies Act (NEA), P.L. 94-412 (Sep. 14, 1976), 90 Stat. 1255, codified as amended at 50 U.S.C. § 1601 et seq. (2018) (“NEA”) and grants the President extensive power to regulate a variety of economic transactions during a state of emergency.

Congress enacted IEEPA in 1977 to rein in the expansive emergency economic powers that it had been delegated to the President under the Trading with the Enemy Act (TWEA). Nevertheless, some scholars argue that judicial and legislative actions subsequent to IEEPA's enactment have made it, like TWEA, a source of expansive and unchecked executive authority in the economic realm. (See, e.g., Patrick Thronson, Toward Comprehensive Reform of America's Emergency Law Regime, Michigan Journal of Law Reform 46, no. 2 (2013), pp. 757-759.) Others, however, argue that Presidents often use IEEPA to implement the will of Congress either as directed by law or as encouraged by congressional activity. (See, e.g., Scheppele, “Small Emergencies,” pp. 845-847) (Statutes like IEEPA show “that emergencies have been brought inside the constitutional order by being normalized in the ordinary legislative process.”).

Under IEEPA, the President may, under such regulations as he may prescribe, by means of instructions, licenses, or otherwise investigate, regulate, or prohibit any transactions in foreign exchange. IEEPA provides President Biden the authority to regulate the recapture of unused immigrant visas for use in subsequent fiscal years to advance the national interest or national security of the United States as EB-5 necessarily involves a transaction in foreign exchange. IEEPA is part of the legal architecture to support the recapture of unused immigrant visas for use in subsequent fiscal years.

This legal architecture also involves the Immigration and Nationality Act and the Immigration Act of 1990.

President—Immigration Policymaker in Chief:

The President of the United States has numerous powers, including those explicitly granted by Article II of the United States Constitution, implied powers, powers granted by Acts of Congress, and the influence and soft power that comes from being President of the United States of America. Within the executive branch itself, the President has broad powers to manage national affairs, foreign affairs and the workings of the government.

The President can issue rules, regulations, and instructions in the form of proclamations, executive orders or executive actions, which have the binding force of law upon federal agencies but do not require congressional approval. They are, however, subject to judicial review and interpretation. Moreover, the executive branch has actually helped construct an immigration system over time as it has wielded its enforcement power and decided how to put the Immigration and Nationality Act (“INA”) and its statutory framework into effect, a process that has entailed considerable executive policymaking dynamically related to, but still separate from, congressional policy.

Federal separation of powers divides power among the executive, legislative, and judicial branches as distinct departments of the United States Government. In the immigration context, the legislative branch has been vested with making laws related to immigration, the executive with its enforcement, and the judicial with its review.

The modern structure of immigration law has enabled the President to exert considerable control over immigration law's core question: which types of noncitizens, and how many, should be permitted to enter and reside in the United States? Whether Congress intended for the President to have such freedom is not certain. What is certain, however, is that the President has considerable authority as it relates to immigration.

The President and Immigration Law, 119 Yale L. J. 458 (2009) and The President and Immigration Law Redux, 125 Yale L. J. 325 (2015) (Adam B. Cox & Cristina M. Rodriguez, The President and Immigration Law, 119 Yale L. J. 458 (2009) and The President and Immigration Law Redux, 125 Yale L. J. 325 (2015)) provide a historical account of the distribution of immigration lawmaking authority between the President and Congress; the core claim of these articles is that a series of twentieth-century developments—constitutional, historical, and institutional—have, as a functional matter, given the President tremendous power over the immigrant-screening system: power to determine which immigrants would be permitted to remain in the United States, which would be forced to leave, and which would be allowed to enter. The President and Immigration Law and The President and Immigration Law Redux label this constellation of developments “de facto delegation” and argue that it constitutes one of the most important features of modern American immigration law.

President Biden has “de facto delegation” and can recapture unused immigrant visas for use in subsequent fiscal years based on federal law, within the specific context of immigration law, without the need for an act of Congress or Congressional approval.

The Proclamation provides for the recapture of unused immigrant visas for use in subsequent fiscal years.

Importantly, the recapture of unused immigrant visas for use in subsequent fiscal years can be done presidentially and said recapture, and its attached legal basis, does not require administrative action to create the substantive legal basis for the recapture but simply administrative action to implement the recapture itself.

A legal consequence of this conclusion is that the Proclamation will provide a legal foundation for both the President and the U.S. Citizenship and Immigration Services (USCIS) to be exempted from the notice-and-comment rulemaking requirements of the Administrative Procedure Act (APA) (5 USC § 551 et seq. (1946)), which usually requires advance notice and a period for public comment on proposed new rules or rule amendments.

The USCIS will be exempted from the notice-and-comment rulemaking requirements of the APA because the relevant new rule (recapture of unused EB-5 visas for use in subsequent fiscal years) will be created by Presidential Proclamation and not created or amended by USCIS.

If USCIS issues a new rule or substantive amendment to an existing rule pursuant to Proclamations 2-9, USCIS will be exempted from the APA § 553 notice-and-comment rulemaking requirements as a result of the “foreign affairs function of the United States” exclusion in APA § 553 (a)(1) and the “good cause” exclusion in APA § 553 (b)(3)(B). APA § 553 (a)(1) and § 553 (b)(3)(B) are implicated in Proclamations 2-9. See System Program EB-5 Visa Recapture Legal Analysis—Memorandum 1 for a detailed analysis of the “foreign affairs function of the United States” exclusion in Administrative Procedure Act § 553 (a)(1).

Supreme Court precedent suggests that presidential actions, such as executive orders, are not reviewable under the APA. But the APA's procedural requirements still apply to agencies when they act to implement any presidential directives, raising the question of when presidential action ends and when agency implementation begins.

When an agency engages in “rule making,” defined as formulating, amending, or repealing a “rule,” the APA generally requires the agency to follow certain procedures. Unless a rule falls within one of the statutory exceptions, the agency is required to undertake notice-and-comment rulemaking. An agency has to comply with the APA not only when it initially promulgates a rule, but also when its actions constitute a substantive amendment to a rule falling within the APA rulemaking requirements. These rulemaking procedures apply only to an “agency process.” The APA defines “agency” to include “each authority of the Government of the United States,” but excludes Congress and the courts. In effect, the APA applies only to the executive branch. The text of the statute does not explicitly mention the President, who is the head of the executive branch and seemingly an “authority of the Government of the United States.”

However, in 1992, the Supreme Court held in Franklin v. Massachusetts, 505 U.S. 788 (1992) that the President's “actions are not subject to [the APA's] requirements.” In that case, the State of Massachusetts challenged the decision of the President and the Secretary of Commerce to use a certain method for counting federal employees serving overseas in the 1990 Census, arguing, in part, that this decision was arbitrary and capricious and therefore unlawful under the APA. The Court concluded that the relevant final action incorporating this method was that of the President, rather than the Secretary, and went on to consider whether the President was an “agency” subject to the APA.

The Court acknowledged that the APA definition of “agency” does not expressly exclude the President, but noted that the President is not “explicitly included, either.”

Citing “respect for the separation of powers and the unique constitutional position of the President,” the Court held that “textual silence” was “not enough to subject the President to the provisions of the APA.” But the Court was careful to clarify that it was only holding that the President's actions may not be reviewed “for abuse of discretion under the APA,” and those actions “may still be reviewed for constitutionality.”

The Supreme Court confirmed this ruling two years later, in Dalton v. Spencer, 511 U.S. 462, 468 (1994), where the Court relied on Franklin's reasoning to reject an APA challenge to the President's decision to approve the closure of a naval shipyard. Otherwise, however, the Court has not further elaborated on the scope of the presidential exception to the APA.

Lower courts have explored the ramifications of this case to a greater extent. Franklin is often invoked as a justification to bar judicial review when a court is asked to review agency action that is not yet “final” and may only become final through presidential action. If the critical step to finalize an act must be taken by the President, courts may reject procedural challenges to interim agency actions. Thus, the D.C. Circuit has held that “Franklin is limited to those cases in which the President has final constitutional or statutory responsibility for the final step necessary for the agency action directly to affect the parties.”

Critically, although the APA's procedural limitations may not apply to presidential action, other laws may govern the President's rulemaking authority. As the Supreme Court has said, the President only has the power to issue an executive order if authorized by “an act of Congress or . . . the Constitution itself” Courts may review claims that the President's action was unauthorized.

Regardless of the aforementioned conclusion, the Proclamation and any related administrative action will also be exempted from the APA § 553 notice-and-comment rulemaking requirements as a result of the “military or foreign affairs function of the United States” exclusion in APA § 553 (a)(1) and the “good cause” exclusion in APA § 553 (b)(3)(B).

System Immigrant Visa Recapture Program—$1.8 Trillion of Annual U.S. Economic Development for 18 Years:

System has developed a proprietary structure and assembled multiple industry-leading business consortiums (“the system”) to apply monetization structuring and/or financial structuring to U.S. immigration policy to support America's values as a nation of immigrants while advancing the national interest and national security of the United States.

From 1921 until 2019, the United States Congress granted 25,294,990 immigrant visas under United States law. During this time, the U.S. Government only issued 20,567,754 immigrant visas counted against immigrant visa numerical limits. Recapturing all historically unused immigrant visas, minus 180,000 immigrant visas recaptured with special legislation, would result in 4,547,236 immigrant visas.

The recapture of all unused immigrant visas for use in subsequent fiscal years to advance the national interest and national security of the United States will support strong employment for Americans and will strengthen economic recovery for the United States following the COVID-19 outbreak.

It is the objective of the system that the U.S. Government recaptures all 4,547,236 immigrant visas over 18 years (an average of 250,000 immigrants per year for 18 years). The aforementioned 250,000 immigrant visas recaptured on an annual basis for 18 years are intended to be part of the proposed U.S. Government Employment-Based National Interest Immigrant Visa Program (EB-NI Program). EB-NI Program immigrant visas will include the EB-5 Program investment and job creation criteria. It is intended that the EB-NI Program will allocate 200,000 EB-NI immigrant visas to the system and 50,000 EB-NI immigrant visas to other entities on an annual basis for 18 years.

System Program includes a legal and financial structure over 18 years for System Program to acquire hundreds of billions of dollars of Commercial Airplanes, Commercial Satellites and Spacecraft and, as a related matter, for System Program to finance and develop trillions of dollars of shipbuilding, transportation, energy, technology, healthcare, education, real estate, manufacturing, infrastructure, and other sectors in the United States. Further, the ability to utilize a funded balance sheet and coordinate investments across multiple interrelated verticals enables System Program to mitigate low-equity returns and financing risk.

According to a 2005 report by the United States Government Accountability Office (“GAO”), only 6,024 visas under the EB-5 category were issued from 1992 through 2004, despite the law's allocation of 10,000 visas per year and an aggregate of 130,000 EB-5 Visas from 1992 through 2004. (“Immigrant Investors: Small Number of Participants Attributed to Pending Regulations and Other Factors”, GAO-05-256: Published: Apr. 1, 2005).

From 2005 until 2020, there are at least 80,000 unused EB-5 Visas (State Department and Fragomen, Del Rey, Bernsen & Loewy LLP).

There are approximately 200,000 unused EB-5 Visas, from 1990-2020, that can potentially be recaptured for use in subsequent fiscal years.

A key component and objective of System Program is the preservation and creation of over 24 million United States jobs on an annual basis for 18 years, resulting in a major expansion of the United States economy, and the potential significant reduction or elimination of the $27 trillion United States National Debt from 12-15 years of EB-NI Program implementation.

Legislative History and Framework:

Immigration is essential to who we are as a nation, our core values, and our aspirations for our future. The United States can and should create an immigration policy to support America's values as a nation of immigrants while advancing the national interest and national security of the United States.

Established by Immigration Acts of 1921 and 1924, the national origins quota system numerically limited immigration to the United States.

Congress re-codified and combined all previous immigration and naturalization law into the Immigration and Nationality Act (INA) of 1952.

In 1965 amendments to the 1952 immigration law, Congress replaced the national origins system with a preference system designed to reunite immigrant families and attract skilled immigrants to the United States. This change to national policy responded to changes in the sources of immigration since 1924.

The Immigration Act of 1990 (IMMACT 90), Pub. L. No. 101-649, retooled the immigrant selection system once again. IMMACT 90 increased the annual levels of total worldwide legal immigration to the United States and revised the preference categories governing permanent legal immigration. Immigrant visas were divided into three separate categories specific to a given fiscal year: family-sponsored, employment-based, and “diversity” immigrants selected by lottery from countries with low immigration volumes.

IMMACT 90 provides that the overall numerical limit for permanent employment-based immigrants is 140,000 per year. This number includes the immigrants plus their eligible spouses and minor unmarried children, meaning the actual number of employment-based immigrants is less than 140,000 each year.

The 140,000 visas are divided into five preference categories. For some categories, the sponsor must first test the U.S. labor market under terms and conditions established by the Department of Labor, and the Secretary of Labor must certify that the petitioner's application met certain requirements before the sponsor may file a petition with USCIS. For some categories, the sponsor's first step is to file a petition with USCIS or the foreign national may self-petition.

The final step is the foreign national's application for an immigrant visa at a U.S. Embassy or Consulate abroad or an application to adjust status to lawful permanent resident (LPR) if in lawful status in the United States. For consular processing, the immigrant visa application cannot be filed until after USCIS approves the immigrant petition. For adjustment of status, the time to file the application depends on whether a visa number is considered to be immediately available.

The INA and IMMACT 90 are silent with regards to the recapture of unused immigrant visas for use in subsequent fiscal years and annual levels of worldwide immigration to the United States.

It is System's legal position and conclusion that the recapture of unused immigrant visas for use in subsequent fiscal years, as provided for by the Proclamation, can be lawfully implemented without subjecting recaptured immigrant visa numbers to IMMACT 90's annual numerical limitations for worldwide employment-based immigrant visas.

IMMACT 90 created a new preference allocation of visas for immigrants who have invested, or are in the process of investing, a designated amount of lawfully obtained capital in a commercial enterprise, and can demonstrate that the investment will create ten or more jobs for qualified U.S. workers. Under the Employment-Based Fifth Preference Immigrant Investor Program (EB-5 Program), qualified immigrant investors may obtain lawful permanent resident status in the United States for themselves and their derivatives.

The EB-5 Program is intended to attract foreign capital, encourage economic development, promote job creation in a new enterprise or job retention in the case of a “troubled business,” and generally benefit the U.S. economy and labor market. To qualify for an EB-5 visa, an applicant must invest the requisite amount of capital in a “new commercial enterprise” which creates fulltime employment of 35 hours per week for ten or more qualifying U.S. workers.

The INA limits the number of employment-based immigrants to 140,000 annually. (INA § 201(d)(1)(A)). Of that number, 7.1 percent, or 9,940 visas are allocated to the EB-5 program. (INA § 203(b)(5)). The annual limits on the number of visas that may be issued were established in 1990 and 30 years later, have never been changed. In addition to the worldwide 7.1 percent ceiling, the number of immigrant visas made available to natives of any single foreign state may not exceed 7 percent of the total number of visas that are available in a given fiscal year. (INA § 202(a)(2)). This amounts to approximately 695.8 EB-5 visas per country per year.

The “per country limitation” only applies if demand for EB-5 visas exceeds the 9,940 ceiling. (INA § 202(a)(5)).

In addition, Congress drafted the INA so that unused visas in one preference category can be allocated to another preference category, and so that a country which exhausts its annual per country allocation can be allocated visas unused by other countries. For example, though the overall limit of 9,940 remains, when a country does not use all of its allotted EB-5 visas, those unused visas may be re-allocated to applicants from another country. Further, although this number could be supplemented by unused family visas, there have been no unused family or employment visas in recent years.

The United States Citizenship and Immigration Services (“USCIS”) has authority to approve in its discretion USCIS Form I-526, Immigration Petition by Alien Entrepreneur (“Form I-526”) and USCIS Form I-829, Petition by Investor to Remove Conditions on Permanent Resident Status (“Form I-829”) involving the EB-5 Program.

From 1921 until 2019, Congress granted 25,294,990 immigrant visas under United States law. During this time, the U.S. Government only issued 20,567,754 immigrant visas counted against immigrant visa numerical limits.

Recapturing all historically unused immigrant visas, minus 180,000 immigrant visas recaptured with special legislation, would result in 4,547,236 immigrant visas.

The recapture of all unused immigrant visas for use in subsequent fiscal years to advance the national interest or national security of the United States will support strong employment for Americans and will strengthen economic recovery for the United States following the COVID-19 outbreak.

INA Silence on Visa Recapture—Derivative Exemption—Exclusion of National and Annual Caps:

The issue of recapture of unused EB-5 visas for use in subsequent fiscal years is silent on the face of the Immigration and Nationality Act (INA), 8 U.S.C. 1101 et seq. and IMMACT 90.

The Immigration Act of 1990 (IMMACT90), Pub. L. No. 101-649, § 121(a), 104 Stat. 4978, 4989, created a new preference allocation of visas for immigrants who have invested, or are in the process of investing, a designated amount of lawfully obtained capital in a commercial enterprise, and can demonstrate that the investment will create ten or more jobs for qualified U.S. workers. The EB-5 law authorizes just under 10,000 visas to be issued to EB-5 investors each fiscal year.

Additionally, the below three issues are silent on the face of the INA and IMMACT 90. (Immigration Act of 1990 (IMMACT90), Pub. L. No. 101-649, § 121(a), 104 Stat. 4978, 4989).

1. Exempting spouses and children of recaptured EB-5 investor immigrants from worldwide employment-based immigration limits;

2. Excluding per-country visa caps from worldwide employment-based immigration limits;

3. Excluding annual employment-based visa caps from worldwide employment-based immigration limits.

USCIS EB-5 Derivative Counting Policy:

Nothing in the EB-5 statute, or any other provision of law, provides that visas issued to the spouses or children of EB-5 investors should count against the approximately 10,000 visa numbers set aside for actual EB-5 investors. Nevertheless, USCIS has implemented a policy and practice of deducting visa numbers for spouses and children from the allotment set aside for EB-5 investors.

This “Counting Policy” provides that “[e]very individual (whether a principal beneficiary or derivative) who is issued an immigrant visa or who adjusts status to LPR in a particular classification counts against its numerical limit.” 9 Foreign Affairs Manual 503.12(A)(a). The USCIS applies this policy when determining the “cut-off” dates applicable to EB-5 investors. The result of the Counting Policy is to reduce the number of visas made available to EB-5 investors well below the allotment Congress established. EB-5 visa numbers are to “be made available [. . . ] to qualified immigrants” who invest in a job-creating new commercial enterprise. 8 U.S.C. § 1153(b)(5). The USCIS's policy diminishes this number substantially by expending the majority of EB-5 visa numbers on the spouses and children of investors who do not meet the definition of an investor at § 1153(b)(5).

Recapture of Annual National and Annual Employment-Based Numerical Limits:

The presidential recapture of unused EB-5 visas for use in subsequent fiscal years (i) implicates and integrates the recapture of related unused annual employment-based numerical limits for use in subsequent fiscal years and; (ii) implicates and integrates the related recapture of unused annual national numerical limits for use in subsequent fiscal years.

The concept of “stacking” in insurance law is applicable to the recapture of unused EB-5 visas for use in subsequent fiscal years and whether unused EB-5 visas can be recaptured and “stacked” for use in subsequent fiscal years irrespective of annual employment-based numerical limits and irrespective of annual national numerical limits.

In insurance law, stacking is the application of two or more policies' limits to a single occurrence or claim. This is common with product liability, construction defect, pollution and other environmental contamination claims in which the occurrence has transpired over numerous years, and it is difficult to ascertain which policy provides coverage. It can also occur under auto liability or uninsured motorists (UM)/underinsured motorists (UIM) coverage in a business auto policy (BAP) or a personal auto policy (PAP) when two or more vehicle limits can be stacked to apply to a single occurrence. Attempts to “stack” coverage can be based on a theory that a party is entitled to coverage under more than one policy. This is called inter-policy stacking. (International Risk Management Institute).

A credible argument can be made that unused EB-5 visas can be recaptured and “stacked” for use in subsequent fiscal years irrespective of annual employment-based numerical limits and irrespective of annual national numerical limits.

If it is legally viable to presidentially recapture unused EB-5 visas for use in subsequent fiscal years then the following three conclusions can be made:

1. Unused EB-5 visa numerical limits accrue;

2. Annual employment-based numerical limits involving EB-5 also accrue and increase proportionately to and with the recaptured EB-5 visas for use in subsequent fiscal years;

3. Annual national numerical limits involving EB-5 also accrue and increase proportionately to and with the recaptured EB-5 visas for use in subsequent fiscal years.

If the aforementioned conclusions are correct, there will be no need to exempt or exclude annual employment-based numerical limits for recaptured EB-5 visas for use in subsequent fiscal years.

If the aforementioned conclusions are correct, there will be no need to exempt or exclude annual national numerical limits for recaptured EB-5 visas for use in subsequent fiscal years.

If the aforementioned conclusions are correct, there will be no need for the recaptured EB-5 visas for use in subsequent fiscal years allotment to come from anywhere other than the unused EB-5 visas themselves, i.e., there will be no need for the recaptured unused EB-5 visas for use in subsequent fiscal years to be exempted or excluded numerically, as it relates to annual employment-based numerical limits or annual national numerical limits, or to be distributed from EB-1, EB-2, EB-3, EB-4, EB-5, or Diversity Visas.

If all of the above conclusions are correct, then it is legally viable to obtain some or most or all recaptured unused EB-5 visas for use in subsequent fiscal years from countries such as China, that are subject to retrogression within the EB-5 Program, as annual employment-based numerical limits and annual national numerical limits will increase proportionately to and with the recaptured unused EB-5 visas for use in subsequent fiscal years.

It is possible for EB-5 derivative visas to remain I-526 visas until the EB-5 immigrant investor becomes a U.S. citizen allowing for the maximization of investor funding for the recaptured EB-5 visas. In this scenario, the EB-5 derivatives will receive their I-829 visas only after the EB-5 immigrant investor becomes a U.S. citizen.

Recaptured EB-5 Visas in the National Interest v. Traditional EB-5:

Recaptured EB-5 visas for use in subsequent fascial years to advance the national interest or national security of the United States are distinguishable from conventional and historical EB-5 visas which, in general, lack a national interest or national security component and focus on the Targeted Employment Area (TEA) $900,000 EB-5 visa category.

System does not plan on focusing on the $900,000 Targeted Employment Area (TEA) EB-5 investment category but rather the $1,800,000 EB-5 investment category, providing increased benefit to the United States economy compared with traditional EB-5.

Chevron Deference:

The principles of Chevron deference apply to the proper deference owed to an agency's interpretation of a statute. See Scialabba v. Cuellar de Osorio, 573 U.S. 41, 56 (2014) (plurality) (citing Chevron U.S.A. Inc. v. Natural Resources Defense Council, Inc., 467 U.S. 837, 842-44 (1984); INS v. Aguirre-Aguirre, 526 U.S. 415, 424-25 (1999)); Go v. Holder, 744 F.3d 604 (9th Cir. 2014) (Wallace, J. concurring) (making distinction between deference owed to the agency's interpretation of statutes compared to that owed to the agency's interpretation of a regulation). “Indeed, ‘judicial deference to the Executive Branch is especially appropriate in the immigration context,’ where decisions about a complex statutory scheme often implicate foreign relations.” Scialabba, 573 U.S. at 56-57. “Chevron deference is appropriate when ‘it appears that Congress delegated authority to the agency generally to make rules carrying the force of law, and . . . the agency interpretation claiming deference was promulgated in the exercise of that authority.’” Campos-Hernandez v. Sessions, 889 F.3d 564, 568 (9th Cir. 2018) (citation omitted).

At step one of the familiar Chevron analysis, we ask whether, “applying the normal tools of statutory construction,” the statute is ambiguous, . . . ; we consider this question de novo, . . . . “If the intent of Congress is clear, that is the end of the matter . . . .” . . . But if the statute is ambiguous, we move to step two of the Chevron inquiry and consider whether the agency's interpretation permissibly construes the statute.

USCIS Discretion:

The United States Citizenship and Immigration Services (“USCIS”) has authority to approve in its discretion USCIS Form I-924, Application For Regional Center Under the Immigrant Investor Pilot Program (“Form I-924”), USCIS Form I-526, Immigration Petition by Alien Entrepreneur (“Form I-526”) and USCIS Form I-829, Petition by Investor to Remove Conditions on Permanent Resident Status (“Form I-829”).

The successful processing of Form I-924, Form I-526 and Form I-829 are required for the administrative recapture of unused EB-5 visas for use in subsequent fiscal years pursuant to the System program.

The issue of recapture of unused EB-5 visas for use in subsequent fiscal years is silent on the face of the INA and IMMACT 90, as are (i) exempting spouses and children of recaptured EB-5 investor immigrants from worldwide employment-based immigration limits; (ii) excluding per-country visa caps from worldwide employment-based immigration limits and; (iii) excluding annual employment-based visa caps from worldwide employment-based immigration limits.

Distinguishing recaptured EB-5 visas that advance the national interest or national security of the United States from traditional EB-5 supports a revised interpretation by USCIS of the aforementioned issues.

It is well-established that agencies may change their interpretations in order to better effect Congressional purpose and to avoid absurd results.

Moreover, in the System context, as the aforementioned issues involves the Proclamation, USCIS will have legal support to permissibly construe that recaptured EB-5 visas that advance the national interest or national security of the United States (i) exempt spouses and children of recaptured EB-5 investor immigrants from worldwide employment-based immigration limits; (ii) exclude per-country visa caps from worldwide employment-based immigration limits and; (iii) exclude annual employment-based visa caps from worldwide employment-based immigration limits.

International Emergency Economic Powers Act:

Enacted in 1977, the International Emergency Economic Powers Act, 50 U.S.C. Section 1701-1707 (IEEPA) provides the president with authority to undertake a wide range of actions in response to “any unusual and extraordinary threat, which has its source in whole or substantial part outside the United States, to the national security, foreign policy, or economy of the United States,” but only if the president first declares a national emergency with regard to that threat.

Although the authority conferred by the IEEPA is broad, Congress passed the act in an effort to limit the president's authority to declare an indefinite state of national emergency during peacetime. Congress intended presidential use of IEEPA authority to be narrowly tailored, time-limited and subj ect to congressional oversight. There are legislative and judicial avenues for affected parties to address executive branch overreach that purports to draw on IEEPA's authority. The act, for example, requires the president to consult Congress “in every possible instance” before exercising authority under the IEEPA.

The president must also provide Congress with reports explaining, among other things, the reason that the president believes action based on the IEEPA is necessary to deal with an unusual and extraordinary threat. For example, with respect to IEEPA actions on Chinese technology transfers, the president would be obligated to explain to Congress why existing laws, such as foreign investment restrictions administered by the Committee on Foreign Investment in the United States and U.S. export control rules enforced by the U.S. Departments of State and Commerce, are insufficient. Once the president takes action, the IEEPA authorizes Congress to terminate the action through a concurrent resolution, i.e., a resolution adopted by the U.S. Senate and House of Representatives that does not require the signature of the president.

The IEEPA neither contains an independent right of judicial review nor imposes limits on such review. Thus, to mount a judicial challenge, a party could seek a declaratory judgment that the IEEPA-based executive action was unconstitutional.

Generally, federal courts are very deferential to the executive branch on constitutional questions involving national security and could deem a presidential declaration of a national emergency to be a nonjusticiable political question.

Nevertheless, at least two courts (the Ninth Circuit in its 2012 decision in AI Haramain Foundation v. Treasury and the U.S. District Court for the Northern District of Ohio in its 2009 decision in Kind Hearts v. Geithner) have held that when the Office of Foreign Assets Control used authority conferred by the IEEPA to freeze the assets of an organization, that asset freeze was subject to meaningful constitutional review under the First, Fourth and Fifth Amendments.

These cases indicate that constitutional challenges to IEEPA actions may be viable in certain circumstances. The Administrative Procedure Act is another source of authority for a party to bring a claim in federal court. The APA entitles a person “adversely affected or aggrieved by agency action” to judicial review of the action.

For example, under the APA, an affected party could claim that an IEEPA-based executive action is ultra vires (i.e., beyond congressionally delegated authority) or otherwise violates the act. In the case of technology transfers, IEEPA explicitly denies the president authority to regulate imports and exports of “any information” except for certain items subject to U.S. export controls, sanctions, antiterrorism, and aviation safety requirements.

Thus, an action that expansively defines “technology” could violate the statute and be overturned by the federal courts. Additional APA claims could state that an IEEPA-based action is not grounded in substantial evidence, is arbitrary and capricious, or was issued without required public notice and comment. Of course, an aggrieved party must meet the basic constitutional and procedural requirements to sue in federal court, including standing, ripeness, and applicable exhaustion requirements.

The use of the IEEPA opens the door to potential judicial challenges and legislative responses.

Indeed, the successful lower court challenges to President Trump's “travel ban” executive order may indicate that federal courts may be willing to review national security-related executive actions.

The Biden administration and Congress should carefully consider the act's intent, requirements and limitations, as well as the possible unintended consequences, of using this broad tool.

It is very possible that, in addition to causing economic ramifications for key U.S. employers and their workers, IEEPA presidential action could establish new and complex regulatory schemes that overlap with existing laws, giving rise to both efficiencies and inefficiencies within government and the regulated community. (See Thomas J. McCarthy, James Tysse and Caroline Wolverton, Challenging Executive Actions Under IEEPA, The National Law Journal, June 2018).

IEEPA and Presidential Proclamation Regarding Immigrant Visa Recapture:

If proclaimed by President Biden in the Proclamation, “the COVID-19 outbreak in the United States and related national emergency constitutes an international emergency and involves an unusual and extraordinary threat, which has its source in whole or substantial part outside the United States, to the national security, foreign policy, or economy of the United States” pursuant to the International Emergency Economic Powers Act (IEEPA), Title II of Pub.L. 95-223, 91 Stat. 1626, enacted Oct. 28, 1977.

Under IEEPA, the President may, under such regulations as he may prescribe, by means of instructions, licenses, or otherwise investigate, regulate, or prohibit any transactions in foreign exchange.

The Proclamation includes the possibility of the President of the United States to regulate, pursuant to IEEPA, the recapture of all immigrant visas to advance the national interest or national security and foreign affairs function of the United States.

The President has the ability to regulate, pursuant to IEEPA, the recapture of all immigrant visas to advance the national interest or national security and foreign affairs function of the United States and, for example, for all recaptured immigrant visas to include a $1,800,000 investment component; a $1,800,000 investment component will necessarily involve transactions in foreign exchange and can, therefore, implicate IEEPA and the President's ability to regulate said recapture of immigrant visas.

Consistent with Section 1185(a)(1) and Section 1182(f) of Title 8 (Immigration and Nationality Act), the President or USCIS will be able to impose, restrict and provide limitations and exceptions that all recaptured immigrant visas be used only to advance the national interest or national security of the United States and that all of these visas involve a $1,800,000 investment restriction or limitation (IEEPA transactions in foreign exchange).

USCIS can issue a new rule to impose, restrict and provide limitations and exceptions that all recaptured immigrant visas include a $1,800,000 investment component (IEEPA transactions in foreign exchange).

Pursuant to IEEPA, the Proclamation provides a legal structure for the President to regulate and expedite the processing of all immigrant visas that involve a $1,800,000 investment component (IEEPA transactions in foreign exchange).

If USCIS issues a new rule or substantive amendment to an existing rule pursuant to the Proclamation, USCIS will be exempted from the APA § 553 notice-and-comment rulemaking requirements as a result of the “military or foreign affairs function of the United States” exclusion in APA § 553 (a)(1) and the “good cause” exclusion in APA § 553 (b)(3)(B).

APA § 553 (a)(1) and § 553 (b)(3)(B) are implicated in the Proclamation.

The Proclamation provides a basis for USCIS to establish a nexus between JOBS America and all recaptured immigrant visas mentioned Section 1 and Section 2.

According to Section 5, “[t]here is established JOBS America (Joint Opportunity to Build and Strengthen America), a Government wide Initiative to facilitate investment and job creation in the United States by Americans and qualified foreigners including citizens of foreign nations that obtain an immigrant visa pursuant to Section 1 and Section 2 herein. JOBS America is to be housed in the Department of Commerce.”

“JOBS America will establish criteria for businesses, non-profit organizations and other entities to qualify for and participate in JOBS America as JOBS America Commercial Partners or JOBS America Non-Profit Partners. Citizens of foreign nations that obtain an immigrant visa pursuant to Section 1 and Section 2 herein who are selected to participate in JOBS America shall be classified as JOBS America Immigrant Partners. The Department of Commerce shall provide funding and administrative support for JOBS America through resources and staff assigned to work on JOBS America, to the extent permitted by law within existing appropriations.”

According to Section 6, “JOBS America shall coordinate with Department of Commerce, Department of Homeland Security and Department of State to establish uniform and nation-specific policies and procedures for citizens of foreign nations that obtain an immigrant visa pursuant to Section 1 and Section 2 herein to participate in JOBS America to advance the national interest or national security and foreign affairs function of the United States.” (Emphasis added).

Conclusion:

The COVID-19 Pandemic is an unparalleled crisis, potentially impacting the health, wellbeing and economic status of hundreds of millions of Americans and billions of people around the world. This crisis has fundamentally impacted the United States political and economic system and that of the entire world.

System Worldwide, Inc. (“System”) has developed a transformational and patent pending program to recapture unused immigrant visas for use in subsequent fiscal years to advance the national interest or national security of the United States (“System Program”). The System Program can benefit the national interest and national security of the United States, especially at this current time.

The System Program can be implemented by the President of the United States and does not require an act of Congress or Congressional approval.

The President has become our immigration policymaker in chief

On his first day in office, President Biden took the first steps in a broad, whole of government effort to reform the immigration system, including sending to Congress legislation that creates a pathway to citizenship for the nearly 11 million undocumented immigrants living in and contributing to the United States.

Additionally, on Feb. 2, 2021, President Biden employed his executive authority by issuing a number of executive orders on immigration including to (i) Create a Task Force to Reunify Families; (ii) Develop a Strategy to Address Irregular Migration Across the Southern Border and Create a Humane Asylum System and; (iii) Restore Faith in Our Legal Immigration System and Promote Integration of New Americans.

The political and legal consternation over President Trump's proclamations to suspend entry of certain immigrants and President Obama's prior initiatives to halt the deportations of millions of unauthorized immigrants obscures the fact that the centralization and consolidation of the immigration power in the Executive Branch has been underway for decades.

The President and Immigration Law and The President and Immigration Law Redux demonstrate how the most ordinary of executive powers—the power to enforce the law—has become a vital engine in the process of deciding who may become a member of our polity. This concentration of power may appear shocking to some, but policymaking through enforcement can serve values vital to our legal traditions, including by promoting transparency, accountability, and consistency in the application of the law. Moreover, in a field still dominated by attention to judicial review, the dynamics between the political branches—between Congress and the Executive, and within the Executive itself—construct regulatory reality. (Adam B. Cox & Cristina M. Rodriguez, The President and Immigration Law, 119 Yale L. J. 458 (2009) and The President and Immigration Law Redux, 125 Yale L. J. 325 (2015)).

This regulatory reality supports that the President can direct the USCIS to recapture unused EB-5 visas for use in subsequent fiscal years based on federal law, within the specific context of immigration law, without the need for an act of Congress or Congressional approval.

The Presidential Proclamation (“Proclamation”) drafted by System Provider provides the necessary legal architecture for President Biden to recapture unused EB-5 visas for use in subsequent fiscal years.

The combined workings of (i) Immigration and Nationality Act); (ii) Employment-Based Fifth Preference Immigrant Investor Program (EB-5); (iii) National Emergencies Act; (iv) Stafford Act; (v) International Emergency Economic Powers Act; (vi) Administrative Procedure Act and; (vii) presidential executive power within immigration law provide President Biden the necessary legal authority to recapture unused EB-5 visas for use in subsequent fiscal years to advance the national interest or national security of the United States presidentially.

This is precisely what President Biden can accomplish in the Proclamation:

Additionally, the Proclamation provides President Biden the necessary legal authority to recapture unused immigrant visas and nonimmigrant visas for use in subsequent fiscal years and to allocate these visas to the EB-NI Program to advance the national interest or national security of the United States presidentially.

Importantly, the recapture of unused immigrant visas for use in subsequent fiscal years can be done presidentially and said recapture, and its attached legal basis, does not require administrative action to create the substantive legal basis for the recapture but simply administrative action to implement the recapture itself.

A legal consequence of this conclusion is that the Proclamations will provide a legal foundation for both the President and the U.S. Citizenship and Immigration Service (USCIS) to be exempted from the notice-and-comment rulemaking requirements of the Administrative Procedure Act (APA) (5 USC § 551 et seq. (1946)), which usually requires advance notice and a period for public comment on proposed new rules or rule amendments.

The USCIS will be exempted from the notice-and-comment rulemaking requirements of the APA because the relevant new rule (recapture of unused EB-5 visas for use in subsequent fiscal years) will be created by Presidential Proclamation and not created or amended by USCIS.

If USCIS issues a new rule or substantive amendment to an existing rule pursuant to Proclamations 2-9, USCIS will be exempted from the APA § 553 notice-and-comment rulemaking requirements as a result of the “foreign affairs function of the United States” exclusion in APA § 553 (a)(1) and the “good cause” exclusion in APA § 553 (b)(3)(B). APA § 553 (a)(1) and § 553 (b)(3)(B) are implicated in Proclamations 2-9.

See System Program EB-5 Visa Recapture Legal Analysis—Memorandum 1 for a detailed analysis of the “foreign affairs function of the United States” exclusion in Administrative Procedure Act § 553 (a)(1).

Regardless of the aforementioned conclusion, the Proclamation and any related administrative action will also be exempted from the APA § 553 notice-and-comment rulemaking requirements as a result of the “military or foreign affairs function of the United States” exclusion in APA § 553 (a)(1) and the “good cause” exclusion in APA § 553 (b)(3)(B).

The Proclamation will support USCIS action to implement the recapture of unused EB-5 visas for use in subsequent fiscal years to advance the national interest or national security of the United States.

Additionally, there is ample legal, legislative, regulatory, and policy precedent to support the position that unused immigrant visa numbers, including involving EB-5, should be recaptured for use in subsequent fiscal years.

The United States Citizenship and Immigration Services (“USCIS”) has authority to approve in its discretion USCIS Form I-924, Application For Regional Center Under the Immigrant Investor Pilot Program, USCIS Form I-526, Immigration Petition by Alien Entrepreneur and USCIS Form I-829, Petition by Investor to Remove Conditions on Permanent Resident Status.

The successful processing of Form I-924, Form I-526 and Form I-829 are required for the administrative recapture of unused EB-5 visas for use in subsequent fiscal years pursuant to the System program.

The issue of recapture of unused EB-5 visas for use in subsequent fiscal years is silent on the face of the INA and INIMACT90, as are (i) exempting spouses and children of recaptured EB-5 investor immigrants from worldwide employment-based immigration limits; (ii) excluding per-country visa caps from worldwide employment-based immigration limits and; (iii) excluding annual employment-based visa caps from worldwide employment-based immigration limits.

Distinguishing recaptured EB-5 visas that advance the national interest or national security of the United States from traditional EB-5 supports a revised interpretation by USCIS of the aforementioned issues.

It is well-established that agencies may change their interpretations in order to better effect Congressional purpose and to avoid absurd results.

Moreover, in the System context, as the aforementioned issues involves the Proclamation, USCIS will have legal support to permissibly construe that recaptured EB-5 visas that advance the national interest or national security of the United States (i) exempt spouses and children of recaptured EB-5 investor immigrants from worldwide employment-based immigration limits; (ii) exclude per-country visa caps from worldwide employment-based immigration limits and; (iii) exclude annual employment-based visa caps from worldwide employment-based immigration limits.

System has developed a proprietary structure and assembled multiple industry-leading business consortiums (“System Program”) to apply monetization structuring and/or financial structuring to U.S. immigration policy to support America's values as a nation of immigrants while advancing the national interest and national security of the United States.

From 1921 until 2019, the United States Congress granted 25,294,990 immigrant visas under United States law. During this time, the U.S. Government only issued 20,567,754 immigrant visas counted against immigrant visa numerical limits. Recapturing all historically unused immigrant visas, minus 180,000 immigrant visas recaptured with special legislation, would result in 4,547,236 immigrant visas.

The recapture of all unused immigrant visas for use in subsequent fiscal years to advance the national interest and national security of the United States will support strong employment for Americans and will strengthen economic recovery for the United States following the COVID-19 outbreak.

It is the objective of System Program that the U.S. Government recaptures all 4,547,236 immigrant visas over 18 years (an average of 250,000 immigrants per year for 18 years). The aforementioned 250,000 immigrant visas recaptured on an annual basis for 18 years are intended to be part of the proposed U.S. Government Employment-Based National Interest Immigrant Visa Program (EB-NI Program). EB-NI Program immigrant visas will include the EB-5 Program investment and job creation criteria. It is intended that the EB-NI Program will allocate 200,000 EB-NI immigrant visas to System Program and 50,000 EB-NI immigrant visas to other entities on an annual basis for 18 years.

In order to qualify for 3,600,000 EB-NI immigrant visas (200,000 immigrant visas annually for 18 years), System Program will be required to create or preserve 36,00,000 U.S. jobs. System Program can create or preserve the requisite 36,000,000 U.S. jobs within two years of EB-NI Program implementation. System Program will secure an agreement with the U.S. Government that System Program is allocated 200,00 EB-NI visas annually for 18 years or 3,600,000 EB-NI visas in total over 18 years. Other entities will have the potential to receive 50,000 EB-NI visas annually for 18 years or 900,000 EB-NI visas in total over 18 years.

System Program includes a legal and financial structure over 18 years for System Program to acquire hundreds of billions of dollars of Commercial Airplanes, Commercial Satellites and Spacecraft and, as a related matter, for System Program to finance and develop trillions of dollars of shipbuilding, transportation, energy, technology, healthcare, education, real estate, manufacturing, infrastructure, and other sectors in the United States. Further, the ability to utilize a funded balance sheet and coordinate investments across multiple interrelated verticals enables Program to mitigate low-equity returns and financing risk.

A key component and objective of The system is the preservation and creation of over 24 million United States jobs on an annual basis for 18 years, resulting in a major expansion of the United States economy, and the potential significant reduction or elimination of the $27 trillion United States National Debt from 12-15 years of EB-NI Program implementation.

System envisions the creation of a single System regional center for EB-5 purposes with a contiguous geographic scope encompassing the entire continental United States (“System National Regional Center”).

An EB-5 regional center is an economic unit, public or private, in the United States that is involved with promoting economic growth. Regional centers are designated by USCIS for participation in the Immigrant Investor Program. A regional center can be associated with one or more new commercial enterprises. A regional center's geographic area must be limited, contiguous, and consistent with the purpose of concentrating pooled investment in defined economic zones.

System National Regional Center will be composed of approximately 200 special purpose vehicles on an annual basis for 18 years that will each be composed of 1,000 EB-NI immigrants.

Each EB-NI immigrant will facilitate a $1,800,000 investment into a System National Regional Center special purpose vehicle.

Each System National Regional Center special purpose vehicle will provide loans to System and, subsequently, System will invest in System Aviation, System Infrastructure, System Real Estate, System Space, and other System projects.

During year one of EB-NI Program implementation, the System National Regional Center will include a Matter of Ho compliant business plan, actual projects, hypothetical projects and exemplar projects sufficient to recapture 200,000 unused EB-5 visas with the requisite 2,000,000 jobs to be created within two years or a reasonable period of time.

System's acquisition of Commercial Airplanes, Commercial Satellites and Spacecraft is intended to provide the necessary 2,000,000 jobs for the recapture of approximately 200,000 unused EB-5 Visas during year one of EB-NI Program implementation.

Utilizing the System EB-5 Recapture Program, the recapture of 200,000 unused EB-5 visas will support System's preservation or creation of over 24 million U.S. jobs and at least 119 jobs per EB-5 Visa.

As a result of the Proclamation, USCIS can process and approve in its discretion the System National Regional Center and System Business Plan to preserve or create 2,000,000 jobs sufficient to recapture 200,00 unused EB-5 visas for use in subsequent fiscal years.

It is possible for EB-5 derivative visas to remain I-526 visas until the EB-5 immigrant investor becomes a U.S. citizen allowing for the maximization of investor funding for the recaptured EB-5 visas. In this scenario, the EB-5 derivatives will receive their I-829 visas only after the EB-5 immigrant investor becomes a U.S. citizen.

Some embodiments include a computer-implemented system that includes at least specifically programming at least one computer system to include a legal and financial structure over 18 years for System to acquire hundreds of billions of dollars of Commercial Airplanes, Commercial Satellites and Spacecraft and, as a related matter, for System to finance and develop trillions of dollars of shipbuilding, transportation, energy, technology, healthcare, education, real estate, manufacturing, infrastructure, and other sectors in the United States. Further, the ability to utilize a funded balance sheet and coordinate investments across multiple interrelated verticals enables System to mitigate low-equity returns and financing risk.

Some embodiments include a computer-implemented system that includes at least specifically programming at least one computer system or a portion of at least one computer system to aggregate, manage and track immigrant investor visas and/or immigrant investor visas funding including, but not limited to, recaptured immigrant visas and/or unused recaptured immigrant visas to be used for financing, funding and/or investment and/or credit enhancement to finance certain investment. Some embodiments include a computer-implemented system that includes at least specifically programming at least one computer system or a portion of at least one computer system to aggregate, manage and track immigrant investor visas and/or immigrant investor visas funding including, but not limited to, recaptured immigrant visas and/or unused recaptured immigrant visas to be used for financing, funding and/or investment and/or credit enhancement to finance certain aerospace products. Some embodiments include a computer-implemented system that includes at least specifically programming at least one computer system to aggregate, manage and track immigrant investor visas and/or immigrant investor visas funding including, but not limited to, recaptured immigrant visas and/or unused recaptured immigrant visas to be used for financing, funding and/or investment and/or credit enhancement to finance certain infrastructure. Some embodiments include a computer-implemented system that includes at least specifically programming at least one computer system to aggregate, manage and track immigrant investor visas and/or immigrant investor visas funding including, but not limited to, recaptured immigrant visas and/or unused recaptured immigrant visas to be used for financing, funding and/or investment and/or credit enhancement to finance certain aerospace products and/or infrastructure and/or investment.

Some embodiments include a computer-implemented system that includes at least specifically programming at least one computer system to aggregate, manage and track immigrant investor visas and/or immigrant investor visas funding including, but not limited to, recaptured immigrant visas and/or unused recaptured immigrant visas to be used for financing, funding and/or investment and/or credit enhancement to finance certain aerospace products as a basis and structure to finance certain infrastructure. Some embodiments include a computer-implemented system that includes at least specifically programming at least one computer system to aggregate, manage and track immigrant investor visas and/or immigrant investor visas funding including, but not limited to, recaptured immigrant visas and/or unused recaptured immigrant visas to be used for financing, funding and/or investment and/or credit enhancement to finance certain aerospace products as a basis and structure to finance certain investment. Some embodiments include a computer-implemented system that includes at least specifically programming at least one computer system to aggregate, manage and track immigrant investor visas and/or immigrant investor visas funding including, but not limited to, recaptured immigrant visas and/or unused recaptured immigrant visas to be used for financing, funding and/or investment and/or credit enhancement to finance certain aerospace products as a basis and structure to finance certain aerospace products and/or infrastructure and/or investment.

Some embodiments include a computer-implemented system that includes at least specifically programming at least one computer system to aggregate, manage and track immigrant investor visas and/or immigrant investor visas funding including, but not limited to, recaptured immigrant visas and/or unused recaptured immigrant visas to be used for financing, funding and/or investment and/or credit enhancement to finance certain Commercial Airplanes and/or Commercial Satellites and/or Spacecraft as a basis and structure to finance certain infrastructure. Some embodiments include a computer-implemented system that includes at least specifically programming at least one computer system to aggregate, manage and track immigrant investor visas and/or immigrant investor visas funding including, but not limited to, recaptured immigrant visas and/or unused recaptured immigrant visas to be used for financing, funding and/or investment and/or credit enhancement to finance certain Commercial Airplanes and/or Commercial Satellites and/or Spacecraft as a basis and structure to finance certain investment. Some embodiments include a computer-implemented system that includes at least specifically programming at least one computer system to aggregate, manage and track immigrant investor visas and/or immigrant investor visas funding including, but not limited to, recaptured immigrant visas and/or unused recaptured immigrant visas to be used for financing, funding and/or investment and/or credit enhancement to finance certain Commercial Airplanes and/or Commercial Satellites and/or Spacecraft as a basis and structure to finance certain aerospace products and/or infrastructure and/or investment.

Some embodiments include a computer-implemented system that includes at least specifically programming at least one computer system to aggregate, manage and track immigrant investor visas job creation. Some embodiments include a computer-implemented system that includes at least specifically programming at least one computer system to aggregate, manage and track recaptured immigrant visas and/or unused recaptured immigrant visas job creation.

Some embodiments include a computer-implemented system that includes at least specifically programming at least one computer system to aggregate, manage and track immigrant investor visas and/or immigrant investor visas funding including, but not limited to, recaptured immigrant visas and/or unused recaptured immigrant visas that utilizes and accesses financial information to authenticate investment source of funds and utilizes and accesses criminal background information and other background information to engage in national security related processing, screening and compliance. Some embodiments include a computer-implemented system that includes at least specifically programming at least one computer system to aggregate, manage and track immigrant investor visas and/or immigrant investor visas funding including, but not limited to, recaptured immigrant visas and/or unused recaptured immigrant visas and compliance with relevant federal and state securities law, including but not limited to: (i) Securities Act of 1933; (ii) Securities Exchange Act of 1934; (iii) Investment Company Act of 1940; (iv) Investment Advisers Act of 1940; (v) State “Blue Sky” laws. Some embodiments include a computer-implemented system that includes at least specifically programming at least one computer system to aggregate, manage and track immigrant investor visas and/or immigrant investor visas funding including, but not limited to, recaptured immigrant visas and/or unused recaptured immigrant visas and a return on invested capital for immigrant investor visas investment. Some embodiments include a computer-implemented system that includes at least specifically programming at least one computer system to aggregate, manage and track immigrant investor visas and/or immigrant investor visas funding including, but not limited to, recaptured immigrant visas and/or unused recaptured immigrant visas and a return of invested capital for immigrant investor visas investment. Some embodiments include a computer-implemented system that includes at least specifically programming at least one computer system to aggregate, manage and track immigrant investor visas and/or immigrant investor visas funding including, but not limited to, recaptured immigrant visas and/or unused recaptured immigrant visas and national security-related concerns including, but not limited to: (i) Committee on Foreign Investment in the United States (CFIUS), Foreign Investment Risk Review Modernization Act of 2018 (FIRRMA) and Critical Technology Pilot Program; (ii) detailed source of funds review; (iii) compliance with Uniting and Strengthening America by Providing Appropriate Tools to Restrict, Intercept and Obstruct Terrorism Act of 2001 (USA PATRIOT Act), Know-Your-Customer (KYC), Anti-Money Laundering (AML), Bank Secrecy Act (BSA) and; (iv) Office of Foreign Asset Control (OFAC) requirements.

Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years for financing, funding and/or investment and/or credit enhancement to finance certain investment. Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years for financing, funding and/or investment and/or credit enhancement to finance certain aerospace products. Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years for financing, funding and/or investment and/or credit enhancement to finance certain infrastructure. Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years to be used for financing, funding and/or investment and/or credit enhancement to finance certain aerospace products and/or infrastructure and/or investment.

Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years for financing, funding and/or financing, funding and/or investment and/or credit enhancement to finance certain aerospace products as a basis and structure to finance certain infrastructure. Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years for financing, funding and/or investment and/or credit enhancement to finance certain aerospace products as a basis and structure to finance certain investment. Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years for financing, funding and/or investment and/or credit enhancement to finance certain aerospace products and/or infrastructure and/or investment as a basis and structure to finance certain infrastructure.

Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years for financing, funding and/or investment and/or credit enhancement to finance certain Commercial Airplanes and/or Commercial Satellites and/or Spacecraft as a basis and structure to finance certain infrastructure. Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years for financing, funding and/or investment and/or credit enhancement to finance certain Commercial Airplanes and/or Commercial Satellites and/or Spacecraft as a basis and structure to finance certain investment. Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years to be used for financing, funding and/or investment and/or credit enhancement to finance certain Commercial Airplanes and/or Commercial Satellites and/or Spacecraft as a basis and structure to finance certain aerospace products and/or infrastructure and/or investment.

Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years and recaptured immigrant visas and/or unused recaptured immigrant visas visa job creation.

Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding that utilizes and accesses financial information to authenticate investment source of funds and utilizes and accesses criminal background information and other background information to engage in national security related processing, screening and compliance. Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years and compliance with relevant federal and state securities law, including but not limited to: (i) Securities Act of 1933; (ii) Securities Exchange Act of 1934; (iii) Investment Company Act of 1940; (iv) Investment Advisers Act of 1940; (v) State “Blue Sky” laws. Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years and a return on invested capital for recaptured immigrant visas and/or unused recaptured immigrant visas investment. Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years and a return of invested capital for recaptured immigrant visas and/or unused recaptured immigrant visas investment. Some embodiments include a computer-implemented system that includes at least specifically programming at least one computer system or a portion of at least one computer system to aggregate, manage and track recaptured immigrant visas and/or unused recaptured immigrant visas and/or recaptured immigrant visas and/or unused recaptured immigrant visas funding for use in subsequent fiscal years and national security-related concerns including, but not limited to: (i) Committee on Foreign Investment in the United States (CFIUS), Foreign Investment Risk Review Modernization Act of 2018 (FIRRMA) and Critical Technology Pilot Program; (ii) detailed source of funds review; (iii) compliance with Uniting and Strengthening America by Providing Appropriate Tools to Restrict, Intercept and Obstruct Terrorism Act of 2001 (USA PATRIOT Act), Know-Your-Customer (KYC), Anti-Money Laundering (AML), Bank Secrecy Act (BSA) and; (iv) Office of Foreign Asset Control (OFAC) requirements.

In some embodiments, the system includes recaptured immigrant visas and/or unused recaptured immigrant visas availability software. In some embodiments, the recaptured immigrant visas and/or unused recaptured immigrant visas software is configured to receive recaptured immigrant visas and/or unused recaptured immigrant visas visa data. In some embodiments, the recaptured immigrant visas and/or unused recaptured immigrant visas data includes an unused recaptured immigrant visas and/or unused recaptured immigrant visas total from past years and/or the present year. In some embodiments, the recaptured immigrant visas and/or unused recaptured immigrant visas data includes a currently available recaptured immigrant visas and/or unused recaptured immigrant visas total. In some embodiments, the recaptured immigrant visas and/or unused recaptured immigrant visas software is configured to calculate the total number of available visas by adding the number of unused recaptured immigrant visas and/or unused recaptured immigrant visas from past years to the number of available visas in the current year. In some embodiments, the system includes a communications module configured to receive investment data and immigration data from one or more databases. In some embodiments, the recaptured immigrant visas and/or unused recaptured immigrant visas software includes the communications module.

In some embodiments, the system includes automated visa application software that applies monetization structuring and/or financial structuring to the immigrant visas. In some embodiments, the visa application software includes an immigration module configured to execute one or more steps described throughout this application regarding immigration and/or visa tracking. In some embodiments, the visa application software is configured to receive an input in one language and translate it to another language. In some embodiments, the visa application software is configured to receive one or more biometric identifiers (e.g., photographs, fingerprints, retinal scans, DNA, and/or any other biometric data). In some embodiments, the visa application software is configured to receive one or more electronic documents including immigration information (e.g., name, date-of-birth, address, marital status, criminal history, current income, current net worth, authentication of immigrant investor source of funds, and/or any information required by immigration officials) spouse information (e.g., immigration information), and/or children information (e.g., immigration information).

In some embodiments, the visa application software is configured to compare an applicant's immigration information against credit databases and/or criminal databases (e.g., foreign, federal, state, and/or local law enforcement databases) and/or other databases useful for information verification. In some embodiments, the visa application software is configured to compare an application immigration information to one or more criminal databases and return a warning message and/or deny a visa application in response to a correlation between the immigrant information and criminal activity and/or association with known criminals. In some embodiments, the visa application software is configured to compare an application immigration information to terrorist watchlists and return a warning message and/or deny a visa application in response to a correlation between a visa application information and/or biometric data and a known terrorist and/or terrorist organization.

In some embodiments the visa application software is configured to aggregate, manage and track immigrant investor visas and/or immigrant investor visas funding including, but not limited to, recaptured immigrant visas and/or unused recaptured immigrant visas that utilizes and accesses financial information to authenticate investment source of funds and utilizes and accesses criminal background information and other background information to engage in national security related processing, screening and compliance.

In some embodiments the visa application software is configured to aggregate, manage and track immigrant investor visas and/or immigrant investor visas funding including, but not limited to, recaptured immigrant visas and/or unused recaptured immigrant visas and compliance with relevant federal and state securities law, including but not limited to: (i) Securities Act of 1933; (ii) Securities Exchange Act of 1934; (iii) Investment Company Act of 1940; (iv) Investment Advisers Act of 1940; (v) State “Blue Sky” laws.

In some embodiments the visa application software is configured to aggregate, manage and track immigrant investor visas and/or immigrant investor visas funding including, but not limited to, recaptured immigrant visas and/or unused recaptured immigrant visas and national security-related concerns including, but not limited to: (i) Committee on Foreign Investment in the United States (CFIUS), Foreign Investment Risk Review Modernization Act of 2018 (FIRRMA) and Critical Technology Pilot Program; (ii) detailed source of funds review; (iii) compliance with Uniting and Strengthening America by Providing Appropriate Tools to Restrict, Intercept and Obstruct Terrorism Act of 2001 (USA PATRIOT Act), Know-Your-Customer (KYC), Anti-Money Laundering (AML), Bank Secrecy Act (BSA) and; (iv) Office of Foreign Asset Control (OFAC) requirements.

In some embodiments, the visa application software is configured to calculate the probability of getting a recaptured immigrant visas and/or unused recaptured immigrant visas visa. In some embodiments, the visa application software is configured to access and/or store records and/or statistics regarding visa denials. In some embodiments, the visa application software is configured to compare immigration information to denial statistics to score and/or rank an applicant's visa application probability. In some embodiments, a higher score correlates to a higher probability of obtaining a visa.

In some embodiments, the visa application software is configured to store the applicant's information in a secured and/or encrypted database. In some embodiments, the visa application software is configured to encrypt and/or store an applicant's information on a visa document. In some embodiments, the visa document is a visa card the applicant can carry for identification purposes.

In some embodiments, the visa document includes a verification system. In some embodiments, the verification system includes a computer readable microchip and/or radio frequency identification device (RFID) which stores the applicant's information and/or enables visa tracking. In some embodiments, the visa application software is configured to receive the verification system at a remote location (i.e., a remote computer) to allows the applicant to “check-in” with immigration authorities periodically. In some embodiments, the visa application software is configured to notify an applicant of their visa status and/or request communication and/or documents when a user “checks-in.”

In some embodiments, the visa application software is configured to create a digital certificate for electronic communication security. In some embodiments, the system issues a key to decode a digital certificate for communication security. In some embodiments, the visa application software is configured to receive biometric identifiers from a remote computer. In some embodiments, the system uses one or more biometric identifiers and/or digital certificates for electronic communications. In some embodiments, the system in configured to receive report from foreign, federal, state, local, and/or credit agencies regarding an applicant's activity while in a country.

In some embodiments, the investment evaluation software (i.e., module) matches an investor and an investment. In some embodiments, the investment evaluation software collects, stores, and/or transmits one or more regional center projects to an applicant. In some embodiments, the investment evaluation software is configured to estimate the number of jobs created from an investment. In some embodiments, the investment evaluation software is configured to determine if j obs created are one or more of direct jobs, indirect jobs, and/or induced jobs (as defined by the United States Citizenship and Immigration Services (USCIS) under the recaptured immigrant visas and/or unused recaptured immigrant visas Immigrant Investor Program; hereafter “jobs”).

In some embodiments, the investment evaluation software is configured to identify, store, evaluate, and/or send information regarding regional center (as defined by USCIS) investment opportunities (investment, investment opportunity, and plurals thereof are used interchangeably herein). In some embodiments, the investment evaluation software is configured to identify, store, evaluate, score and/or send information regarding individual businesses for sale and/or investment and/or lending. In some embodiments, the investment evaluation software is configured to estimate the number of new jobs created by an investment. In some embodiments, the investment evaluation software is configured to score an investment that creates more new jobs higher than an investment that creates less new jobs. In some embodiments, the investment evaluation software is configured to use the jobs score in a financial risk-return calculation.

In some embodiments, the investment evaluation software is configured to arrange investments by asset classes. In some embodiments, the investment evaluation software is configured to receive a current investment portfolio from an investor. In some embodiments, the investment evaluation software is configured to identify, match, evaluate, score, store, and/or send information regarding investments that are similar in risk to an investor's current portfolio. In some embodiments, the investment evaluation software is configured to determine a risk score based on an applicant's current investment portfolio. In some embodiments, a risk score is determined by scoring and/or ranking the risk associated with each current investment in an applicant's current investment portfolio. In some embodiments, the investment evaluation software is configured to use the portfolio score and/or rank in a risk-return calculation. In some embodiments, the investment evaluation software portion of the system is configured to return a list of potential investments to an applicant that has the highest probability of obtaining a recaptured immigrant visas and/or unused recaptured immigrant visas visa. In some embodiments, the list includes potential investments with the highest probability of creating the most jobs.

In some embodiments, the investment evaluation software is configured to identify investments that are eligible for crowd sourcing and/or donations (hereafter collectively “crowd sourcing”). In some embodiments, the investment evaluation software assigns a score to investments based on the ability to raise capital through crowd sourcing. In some embodiments, the investment evaluation software is configured to identify investments with crowd sourcing by utilizing publicly disclosed list. In some embodiments, the investment evaluation software is configured to score an investment based on one or more public records (e.g., rate of growth, valuation, number of employees, demand for product, backorders, social media information, assets, liabilities, number of rounds of funding, profit/non-profit status, tax returns, etc.) investment evaluation software assigns a score to investments based the change in one or more public records between when the investment was listed and the public records currently available.

In some embodiments, the investment evaluation software is configured to select and display one or more investments ranked by score. In some embodiments, the investment evaluation software is configured to display simulations of time-based growth. In some embodiments, the simulations use probability and/or statistics (i.e., statistical analysis) to determine time-based growth. In some embodiments, the investment evaluation software scores and/or ranks an investment at least in part based on time-based growth. In some embodiments, the investment evaluation software uses statistical analysis to correlate time-based growth to employee hiring growth to predict the number of employees needed for growth over time. In some embodiments, the investment evaluation software ranks an investment higher for more employee growth over time than an investment with less employee growth over the same time period. In some embodiments, the investment evaluation software is configured to remove investments from consideration that do not meet one or more job creation criteria (e.g., employee growth of a desired number of employees within 2 years). In some embodiments, the investment evaluation software scores and/or ranks higher an investment that meets one or more job creation criteria faster than investments that take a longer time to reach the job creation criteria. In some embodiments, a job creation criterion is 10 jobs. In some embodiments, the job creation criterion is 5 jobs. In some embodiments, the investment evaluation software displays a list of potential investments ranked by score with graphical representations of one or more predictions.

In some embodiments, the employee pool software is configured to identify employee pool skillsets. In some embodiments, employee pool software is configured to categorize employee pools by one or more geographical locations. In some embodiments, employee pools are defined by one or more investment locations (e.g., locations of investments on the list created by the investment software). In some embodiments, the employee pool software is configured to determine Targeted Employment Areas (TEA; as defined by the USCIS). In some embodiments, the employee pool software is configured to identify high unemployment areas (i.e., areas with an unemployment rate of at least 150% of the U.S. national average). In some embodiments, the employee pool software scores and/or ranks an area and/or employee pool higher if the employee pool is located in a TEA. In some embodiments, the employee pool software scores and/or ranks an area and/or employee pool lower if the employee pool is located in a TEA.

In some embodiments, the score and/or rank for an employee pool for the employment pool software is based on input from the investment evaluation software. In some embodiments, the investment evaluation software is configured to score and/or rank an employee pool based on the capital an applicant has available to invest. In some embodiments, the investment evaluation software is configured to score and/or rank a TEA employment pool higher if an applicant has greater or equal to $900,000 (U.S. dollar equivalent) and less than or equal to $1.8 million. In some embodiments, the investment evaluation software adjusts an employment pools'score and/or rank higher if an applicant has greater than $1.8 million to invest. In some embodiments, the investment evaluation software ranks a TEA and a non-TEA employment pool the same.

In some embodiments, the employment pool software is configured to evaluate an employee pool's skillset. In some embodiments, the employment pool software is configured to predict if there are enough potential employees with qualifying skillsets within a geographical area to meet one or more job creation criteria. In some embodiments, the employment pool software is configured to rank an area with more potential employees with qualifying skillsets higher than an area with less potential employees with qualifying skillsets. In some embodiments, the investment evaluation software is configured to remove investments from the list with employment pools predicted not to meet one or more job creation criteria. In some embodiments, the employment pool software is configured to display one or more graphical representations, probabilities, and/or statistics of one or more predictions as described herein.

In some embodiments, system includes a capital tracking software. In some embodiments, the capital tracking software mitigates the risk of crime, corruption, and fraud affecting an investment. In some embodiments, the capital tracking software is configured to receive, store, analyze, track and/or report on one or more investments' finances (e.g., credit score, account balances, total investment amounts, applicant investment amounts, assets, liabilities, expenditures, inventory, insurance payments, insurance claims, lawsuits, criminal charges, and/or any business expense or credit). In some embodiments, the capital tracking software is configured to calculate an applicant's capital as a percentage of total capital in an investment. In some embodiments, the system is configured to calculate an applicant's capital gains and/or losses as a percentage of total capital gains and/or losses of an investment. In some embodiments, the capital tracking software is configured to track and report an investment's capital delta (i.e. total available capital and/or credit change with respect to time). In some embodiments, the capital tracking software is configured to generate and alert if the capital delta exceeds a preset limit. In some embodiments, the capital tracking software is configured to generate an alert if a capital delta correlates to not meeting one or more job creation criteria within 2 years.

In some embodiments, the system comprises capital tracking software that is configured to generate an alert in response to a finance anomaly within an investment's finances. In some embodiments, a finance anomaly is a sudden change in capital delta with no corresponding income and/or expenditure. In some embodiments, the capital tracking software is configured to analyze purchases and compare an asset's purchase and/or sale value against an asset's market value to generate a market value delta. In some embodiments, the capital tracking software is configured to generate and alert if the market value delta exceeds a preset limit.

In some embodiments, the system includes an aggregation module configured to aggregate the investment data and the immigration data into aggregated data. The aggregation module performs one or more steps associated with aggregation as described throughout this application according to some embodiments. In some embodiments, the system aggregates (i.e., collects and assigns) unused recaptured immigrant visas and/or unused recaptured immigrant visas into one or more business models that satisfies the requirements of the recaptured immigrant visas and/or unused recaptured immigrant visas program, such as the creation of jobs. In some embodiments, the one or more businesses are used to fund multiple different projects and/or continuously fund projects in sequential order as each project is completed.

In some embodiments, the system utilizes the financing of up to or over $350 billion of commercial airplanes, commercial satellites and spacecraft to support the creation or preservation of up to or over 2,011,450 aerospace jobs in the United States providing the baseline jobs to recapture up to or over 200,000 unused recaptured immigrant visas and/or unused recaptured immigrant visas to raise up to or over $360 billion of unlevered recaptured immigrant visas and/or unused recaptured immigrant visas funding and, as a related matter, a structure to finance up to or over a $5.05 trillion private investment in United States infrastructure and/or other industries and the creation of approximately up to or over 77 million infrastructure jobs and/or jobs in other industries in the United States.

In some embodiments, the system utilizes up to or over $360 billion of recaptured immigrant visas and/or unused recaptured immigrant visas funding to be enhanced up to or over fifteen times to raise up to or over $5.4 trillion of funding for public-private partnership investment in United States aerospace and infrastructure and/or other industries. In some embodiments, the system utilizes the financing and/or acquisition of commercial airplanes, commercial satellites and spacecraft to support sustainable national interest-centric infrastructure development and to provide uncommon financial and strategic benefit to the aerospace and multiple infrastructure sectors and/or other industries in the United States. In some embodiments, the system utilizes the financing of up to or over $350 billion of commercial airplanes, commercial satellites and spacecraft and, as a related matter, the system utilizes the financing of up to or over $5 trillion of infrastructure in the United States including, but not limited to, border security, transportation, 5G Space Internet and energy. In some embodiments, the system utilizes the financing of certain secured transactions in aerospace mobile equipment (movable equipment) (commercial airplanes, commercial satellites and spacecraft) as a basis and structure to finance certain types of infrastructure in the United States and/or globally. In some embodiments, the system utilizes the financing of certain secured transactions in aerospace mobile equipment (movable equipment) (Commercial Airplanes, Commercial Satellites and Spacecraft) as a basis and structure to finance certain types of other industries including, but not limited to, manufacturing, telecommunications, information technology, and healthcare in the United States and/or globally. In some embodiments, the system utilizes the Article Two executive power pursuant to the United States Constitution to facilitate a large-scale investment in the United States aerospace sector and, as a related matter, to facilitate a large-scale investment in United States infrastructure without the need for an act of Congress or Congressional approval. Additionally, in some embodiments, the system utilizes the system is implemented with taxpayer funding.

Some embodiments of the invention include a system to utilize recaptured immigrant visas and/or unused recaptured immigrant visas funding to (i) finance Boeing Commercial Airplanes and Boeing Defense, Space & Security products and; (ii) finance and develop infrastructure in the United States. In some embodiments, the system utilizes recaptured immigrant visas and/or unused recaptured immigrant visas funding to (i) finance Commercial Airplanes, and/or Commercial Satellites and/or Spacecraft; and (ii) finance and develop infrastructure in the United States. In some embodiments, the system utilizes the Recapture of up to 200,000 or more unused recaptured immigrant visas and/or unused recaptured immigrant visas in the national interest to raise up to or over $360 billion of recaptured immigrant visas and/or unused recaptured immigrant visas funding to finance Boeing Commercial Airplanes, Boeing Defense, Space & Security products and finance and develop infrastructure in the United States. In some embodiments, the system utilizes the Recapture of up to 200,000 or more unused recaptured immigrant visas and/or unused recaptured immigrant visas in the national interest to raise up to or over $360 billion of recaptured immigrant visas and/or unused recaptured immigrant visas funding to finance Commercial Airplanes and/or Commercial Satellites and/or Spacecraft and finance and develop infrastructure in the United States. In some embodiments, the system utilizes the Recapture of up to 200,000 or more unused recaptured immigrant visas and/or unused recaptured immigrant visas to raise up to or over $360 billion of recaptured immigrant visas and/or unused recaptured immigrant visas funding to finance investment in the United States. In some embodiments, the system utilizes the Recapture of up to 200,000 or more unused recaptured immigrant visas and/or unused recaptured immigrant visas to raise up to or over $360 billion of recaptured immigrant visas and/or unused recaptured immigrant visas funding to finance investment in the United States and globally. In some embodiments, the system utilizes present/future contractually obligated income in the form of up to or over $360 billion of recaptured immigrant visas and/or unused recaptured immigrant visas funding for the recapture of up to or over 200,000 unused recaptured immigrant visas and/or unused recaptured immigrant visas. In some embodiments, the system utilizes debt financing related to financing of Boeing Commercial Airplanes, which benefits from (i) U.S. Bankruptcy Code Section 1110 Enhanced Equipment Trust Certificates (“EETC”) financing; (ii) Cape Town Convention on International Interests in Mobile Equipment EETC financing; (iii) asset-based securitization; and (iv) U.S. Internal Revenue Code supported accelerated depreciation. In some embodiments, the system utilizes debt financing related to financing Commercial Airplanes and/or Commercial Satellites and/o Spacecraft, which benefits from (i) U.S. Bankruptcy Code Section 1110 Enhanced Equipment Trust Certificates (“EETC”) financing; (ii) Cape Town Convention on International Interests in Mobile Equipment EETC financing; (iii) asset-based securitization; and (iv) U.S. Internal Revenue Code supported accelerated depreciation. In some embodiments, the system utilizes debt financing involving present/future contractually obligated income in the form of up to or over $360 billion of recaptured immigrant visas and/or unused recaptured immigrant visas funding to reduce cost of debt financing of Boeing Commercial Airplanes and Boeing Defense, Space & Security products. In some embodiments, the system utilizes debt financing involving present/future contractually obligated income in the form of up to or over $360 billion of recaptured immigrant visas and/or unused recaptured immigrant visas funding to reduce cost of debt financing of Commercial Airplanes and/or Commercial Satellites and/or Spacecraft. In some embodiments, the system utilizes present/future contractually obligated income in the form of up to or over $360 billion of recaptured immigrant visas and/or unused recaptured immigrant visas funding for investment in the United States and/or globally. In some embodiments, the system utilizes debt financing related to infrastructure financing; a system utilizes debt financing related to infrastructure financing supported by aircraft securitization. In some embodiments, the system utilizes debt financing related to infrastructure financing supported by infrastructure public-private partnerships in the United States and/or globally. In some embodiments, the system utilizes present/future contractually obligated income in the form of up to or over $360 billion of recaptured immigrant visas and/or unused recaptured immigrant visas funding to reduce cost of debt financing of United States infrastructure and/or infrastructure on a global basis. In some embodiments, the system utilizes attractive debt financing related to United States and/or global infrastructure development supported by infrastructure-asset-based securitization. In some embodiments, the system utilizes New Markets Tax Credit, other Tax Credit, Cap-and-Trade Programs (Carbon Emissions Trading) and other government incentives for United States infrastructure financing and development.

In some embodiments, the system utilizes the Article Two executive power pursuant to the United States Constitution to facilitate a large-scale investment in the United States aerospace sector and, as a related matter, to facilitate a large-scale investment in United States infrastructure without the need for an act of Congress or Congressional approval. In some embodiments, the system is implemented without taxpayer funding. In some embodiments, the system utilizes multiple investment and jobs scenarios including topline/optimal and baseline/conservative and hybrid scenarios. In some embodiments, the system utilizes multiple investment and jobs scenarios involving single or multiple companies including topline/optimal and baseline/conservative and hybrid scenarios. In some embodiments, the system utilizes multiple investment and jobs scenarios involving single or multiple industries including topline/optimal and baseline/conservative and hybrid scenarios. In some embodiments, the system utilizes the U.S. Department of State (“State Department”), in conjunction with the U.S. Department of Homeland Security (“DHS”), to engage federal administrative authority to recapture unused recaptured immigrant visas and/or unused recaptured immigrant visas in the national interest, within the specific context of immigration law, supported by legal, legislative, regulatory and policy precedent, without the need for an act of Congress or Congressional approval.

In some embodiments, the system utilizes the U.S. Department of State (“State Department”), in conjunction with the U.S. Department of Homeland Security (“DHS”), to engage administrative authority to recapture unused recaptured immigrant visas and/or unused recaptured immigrant visas, within the specific context of immigration law, supported by legal, legislative, regulatory and policy precedent, without the need for an act of Congress or Congressional approval.

In some embodiments, the system utilizes current or future United States law including, but not limited to federal law, to recapture unused recaptured immigrant visas and/or unused recaptured immigrant visas in the national interest, within the specific context of immigration law, supported by legal, legislative, regulatory and policy precedent, without the need for an act of Congress or Congressional approval.

In some embodiments, the system utilizes current or future United States law including, but not limited to federal law, to recapture unused recaptured immigrant visas and/or unused recaptured immigrant visas, within the specific context of immigration law, supported by legal, legislative, regulatory and policy precedent, without the need for an act of Congress or Congressional approval.

In some embodiments, the system utilizes current or is configured to use future United States law including, but not limited to federal law, including current and/or future immigrant investor visas, within the specific context of immigration law, supported by legal, legislative, regulatory and policy precedent, without the need for an act of Congress or Congressional approval.

In some embodiments, the system utilizes current or future United States law including, but not limited to federal law, including current and/or future immigrant investor visas, within the specific context of immigration law, supported by legal, legislative, regulatory and policy precedent, with an act of Congress or Congressional approval.

In some embodiments, the system utilizes a capitalized holding company structure maintaining an investment-grade credit rating, ideally from at least two of the three major rating agencies, and serving as guarantor for the company's operations within, for example, aviation, space and infrastructure. In some embodiments, the system is designed to be in the national interest and national in scope, and offering competitive advantages for investment in commercial airplanes, commercial satellites and spacecraft, and infrastructure development. In some embodiments, the system is configured to expedite immigrant investor visa processing in the national interest or otherwise creating a premium immigrant investor visa product including, but not limited to, a premium recaptured immigrant visas and/or unused recaptured immigrant visas product, involving the $900,000 targeted employment area (TEA) recaptured immigrant visas and/or unused recaptured immigrant visas category providing for the recapture of up to or over 200,000 recaptured immigrant visas and/or unused recaptured immigrant visas enabling the creation of up to or over 389 jobs per recaptured immigrant visas and/or unused recaptured immigrant visas visa, as opposed to 10 jobs per recaptured immigrant visas and/or unused recaptured immigrant visas visa, and addressing four major concerns with the recaptured immigrant visas and/or unused recaptured immigrant visas program.

In some embodiments, the system utilizes a capitalized holding company structure maintaining an investment-grade credit rating, ideally from at least two of the three major rating agencies, and serving as guarantor for the company's operations within, for example, aviation, space and infrastructure. In some embodiments, the program is designed to be in the national interest and national in scope, and offering competitive advantages for investment in commercial airplanes, commercial satellites and spacecraft, and infrastructure development. In some embodiments, the system expedites immigrant investor visa processing in the national interest or otherwise creating a premium immigrant investor visa product including, but not limited to, a premium recaptured immigrant visas and/or unused recaptured immigrant visas product, involving the $1,800,000 recaptured immigrant visas and/or unused recaptured immigrant visas visa category as opposed the current $900,000 targeted employment area (TEA) recaptured immigrant visas and/or unused recaptured immigrant visas category providing for the recapture of up to or over 200,000 recaptured immigrant visas and/or unused recaptured immigrant visas enabling the creation of up to or over 389 jobs per recaptured immigrant visas and/or unused recaptured immigrant visas visa, as opposed to 10 jobs per recaptured immigrant visas and/or unused recaptured immigrant visas visa, and addressing four major concerns with the recaptured immigrant visas and/or unused recaptured immigrant visas program.

In some embodiments, the system utilizes a capitalized holding company structure maintaining an investment-grade credit rating, ideally from at least two of the three major rating agencies, and serving as guarantor for the company's operations within, for example, aviation, space and infrastructure. In some embodiments, the system is designed to be in the national interest and national in scope, and offering competitive advantages for investment in commercial airplanes, commercial satellites and spacecraft, and infrastructure development. In some embodiments, the system expedites immigrant investor visa processing in the national interest or otherwise creating a premium immigrant investor visa product including, but not limited to, a premium recaptured immigrant visas and/or unused recaptured immigrant visas product, involving the $900,000 targeted employment area (TEA) recaptured immigrant visas and/or unused recaptured immigrant visas category providing for the recapture of up to or over 200,000 recaptured immigrant visas and/or unused recaptured immigrant visas enabling the creation of up to or over 389 jobs per recaptured immigrant visas and/or unused recaptured immigrant visas visa, as opposed to 10 jobs per recaptured immigrant visas and/or unused recaptured immigrant visas visa, and addressing four major concerns with the recaptured immigrant visas and/or unused recaptured immigrant visas program.

In some embodiments, the system utilizes and addresses four major concerns with the recaptured immigrant visas and/or unused recaptured immigrant visas program: (1) Credible and predictable long-term U.S. jobs (certain members of Congress have expressed concern, privately and publicly, with the frequent exaggeration and puffery of U.S. job creation in the recaptured immigrant visas and/or unused recaptured immigrant visas space and lack of long-term job creation with many recaptured immigrant visas and/or unused recaptured immigrant visas Regional Centers); (2) Legality of funding and compliance with relevant federal and state securities law, including: (i) the Securities Act of 1933; (ii) the Securities Exchange Act of 1934; (iii) the Investment Company Act of 1940; (iv) the Investment Advisers Act of 1940; (v) Jumpstart Our Business Startups Act (JOBS Act); (vi) CROWDFUND Act; and (vii) State “Blue Sky” laws; (3) Return on invested capital for recaptured immigrant visas and/or unused recaptured immigrant visas investors and return of invested capital for recaptured immigrant visas and/or unused recaptured immigrant visas investors (there have been many instances of recaptured immigrant visas and/or unused recaptured immigrant visas Regional Centers and related businesses not providing a return on invested capital and return of invested capital to recaptured immigrant visas and/or unused recaptured immigrant visas investors); (4) National security-related concerns including, but not limited to: (i) CFIUS, FIRRMA and Critical Technology Pilot Program; (ii) detailed source of funds review; (iii) compliance with USA PATRIOT Act, Know-Your-Customer (KYC), Anti-Money Laundering (AML), Bank Secrecy Act (BSA) and; (iv) Office of Foreign Asset Control (OFAC) requirements.

In some embodiments, the system utilizes a single regional center for recaptured immigrant visas and/or unused recaptured immigrant visas purposes with a contiguous geographic scope encompassing the entire continental United States. In some embodiments, the system utilizes a regional center that is composed of up to 100 or more separate investment funds and special purpose vehicles (SPV) that will each be composed of up to 1,999 accredited investors-limited partners. In some embodiments, the System regional center investment funds/SPV will invest in System Aviation, System Infrastructure, System Real Estate and System Space projects. In some embodiments, the System regional center will include a Matter of Ho compliant business plan, actual projects, hypothetical projects and exemplar projects sufficient to recapture 200,000 unused recaptured immigrant visas and/or unused recaptured immigrant visas with the requisite 2,000,000 jobs to be created within two years or a reasonable period of time.

Some embodiments include a computer-implemented system that includes at least specifically programming at least one computer system or a portion of at least one computer system to aggregate immigrant investor visas including, but not limited to, the United States Citizenship and Immigration Service (“USCIS”) Employment-Based Fifth Preference Immigrant Investor Program (“immigrant investor funding Program” or “immigrant investor funding”) (collectively, “immigrant investor visas” or “immigrant investor visa funding”), for the purposes of immigrant investor visa automated application processing; and/or immigrant investor visa automated legal processing; and/or immigrant investor visa automated securities law compliance; and/or immigrant investor visa automated securities law compliance processing; and/or immigrant investor visa automated expedited processing; and/or immigrant investor visa automated authentication of source of funds processing; and/or immigrant investor visa automated background check processing; and/or immigrant investor visa automated national security related screening and processing, and/or investment; and/or investment in aircraft; and/or investment in satellites; and/or investment in spacecraft; and/or investment in commercial aviation; and/or investment in aerospace; and/or investment in infrastructure; and/or investment in real estate; and/or investment in information technology software; and/or investment in information technology hardware; and/or investment in telecommunications; and/or investment in aircraft and/or satellites and/or spacecraft to finance infrastructure; and/or investment in high-speed rail; and/or investment in smart grid; and/or investment in 5G; and/or investment in Space Internet; and/or investment in water supply system or water supply network; and/or investment in water infrastructure; and/or investment in airport infrastructure; and/or investment in port infrastructure; and/or investment in inland port infrastructure; and/or investment in sports venue; and/or investment in air transportation infrastructure; and/or investment in surface transportation infrastructure; and/or investment in rail infrastructure; and/or investment in highway infrastructure; and/or investment in road infrastructure; and/or investment in education; and/or investment in energy infrastructure; and/or investment in renewable energy; and/or investment in nuclear energy; and/or investment in civil infrastructure; and/or investment in autonomous vehicle infrastructure; and/or investment in flying vehicle infrastructure; and/or investment in military infrastructure; and/or investment in autonomous vehicle manufacturing; and/or investment in flying vehicle manufacturing; and/or investment in crypto currency; and/or investment in block chain; and/or investment in military hardware; and/or investment in automobile manufacturing; and/or investment in aircraft manufacturing; and/or investment in aviation education; and/or investment involving Islamic finance; and/or investment involving donation; and/or investment involving crowd funding; and/or deriving revenues through the leasing model.

Some embodiments of the invention comprise a computer-implemented system that includes at least one of: specifically programming at least one computer system or a portion of at least one computer system to perform at least one of the following: aggregate Islamic finance for investment; and/or Islamic finance for investment in aircraft; and/or Islamic finance for investment in satellites; and/or Islamic finance for investment in spacecraft; and/or Islamic finance for investment in commercial aviation; and/or Islamic finance for investment in aerospace; and/or Islamic finance for investment in infrastructure; and/or Islamic finance for investment in real estate; and/or Islamic finance for investment in information technology software; and/or Islamic finance for investment in information technology hardware; and/or Islamic finance for investment in telecommunications; and/or Islamic finance for investment in aircraft and/or satellites and/or spacecraft to finance infrastructure; and/or Islamic finance for investment in high-speed rail; and/or Islamic finance for investment in smart grid; and/or Islamic finance for investment in 5G; and/or Islamic finance for investment in Space Internet; and/or Islamic finance for investment in water supply system or water supply network; and/or Islamic finance for investment in water infrastructure; and/or Islamic finance for investment in airport infrastructure; and/or Islamic finance for investment in port infrastructure; and/or Islamic finance for investment in inland port infrastructure; and/or Islamic finance for investment in sports venue; and/or Islamic finance for investment in air transportation infrastructure; and/or Islamic finance for investment in surface transportation infrastructure; and/or Islamic finance for investment in rail infrastructure; and/or Islamic finance for investment in highway infrastructure; and/or Islamic finance for investment in road infrastructure; and/or Islamic finance for investment in education; and/or Islamic finance for investment in energy infrastructure; and/or Islamic finance for investment in renewable energy; and/or investment in nuclear energy; and/or Islamic finance for investment in civil infrastructure; and/or Islamic finance for investment in autonomous vehicle infrastructure; and/or Islamic finance for investment in flying vehicle infrastructure; and/or Islamic finance for investment in military infrastructure; and/or Islamic finance for investment in autonomous vehicle manufacturing; and/or Islamic finance for investment in flying vehicle manufacturing; and/or Islamic finance for investment in crypto currency; and/or Islamic finance for investment in block chain; and/or Islamic finance for investment in military hardware; and/or Islamic finance for investment in automobile manufacturing; and/or Islamic finance for investment in aircraft manufacturing; and/or Islamic finance for investment involving Islamic finance; and/or Islamic finance for investment involving donation; and/or Islamic finance for investment involving crowd funding.

Some embodiments of the invention comprise a computer-implemented system that includes at least: specifically programming at least one computer system or a portion of at least one computer system to perform at least one of the following: aggregate donation for investment; and/or donation for investment in aircraft; and/or donation for investment in satellites; and/or donation for investment in spacecraft; and/or donation for investment in commercial aviation; and/or donation for investment in aerospace; and/or donation for investment in infrastructure; and/or donation for investment in real estate; and/or donation for investment in information technology software; and/or donation for investment in information technology hardware; and/or donation for investment in telecommunications; and/or donation for investment in aircraft and/or satellites and/or spacecraft to finance infrastructure; and/or donation for investment in high speed rail; and/or donation for investment in smart grid; and/or donation for investment in 5G; and/or donation for investment in Space Internet; and/or donation for investment in water supply system or water supply network; and/or donation for investment in water infrastructure; and/or donation for investment in airport infrastructure; and/or donation for investment in port infrastructure; and/or donation for investment in inland port infrastructure; and/or donation for investment in sports venue; and/or donation for investment in air transportation infrastructure; and/or donation for investment in highway infrastructure; and/or donation for investment in road infrastructure; and/or donation for investment in education; and/or donation for investment in energy infrastructure; and/or donation for investment in renewable energy; and/or investment in nuclear energy; and/or donation for investment in civil infrastructure; and/or donation for investment in autonomous vehicle infrastructure; and/or donation for investment in flying vehicle infrastructure; and/or donation for investment in military infrastructure; and/or donation for investment in autonomous vehicle manufacturing; and/or donation for investment in flying vehicle manufacturing; and/or donation for investment in crypto currency; and/or donation for investment in block chain; and/or donation for investment in military hardware; and/or donation for investment in automobile manufacturing; and/or donation for investment in aircraft manufacturing; and/or donation for investment involving Islamic finance; and/or donation for investment involving donation; and/or donation for investment involving crowd funding.

Some embodiments of the invention comprise a computer-implemented system that includes at least: specifically programming at least one computer system or a portion of at least one computer system to perform at least one of the following: aggregate crowd funding for investment; and/or crowd funding for investment in aircraft; and/or crowd funding for investment in satellites; and/or crowd funding for investment in spacecraft; and/or crowd funding for investment in commercial aviation; and/or crowd funding for investment in aerospace; and/or crowd funding for investment in infrastructure; and/or crowd funding for investment in real estate; and/or crowd funding for investment in information technology software; and/or crowd funding for investment in information technology hardware; and/or crowd funding for investment in telecommunications; and/or crowd funding for investment in aircraft and/or satellites and/or spacecraft to finance infrastructure; and/or crowd funding for investment in high-speed rail; and/or crowd funding for investment in smart grid; and/or crowd funding for investment in 5G; and/or crowd funding for investment in Space Internet; and/or crowd funding for investment in water supply system or water supply network; and/or crowd funding for investment in water infrastructure; and/or crowd funding for investment in airport infrastructure; and/or crowd funding for investment in port infrastructure; and/or crowd funding for investment in inland port infrastructure; and/or crowd funding for investment in sports venue; and/or crowd funding for investment in air transportation infrastructure; and/or crowd funding for investment in highway infrastructure; and/or crowd funding for investment in road infrastructure; and/or crowd funding for investment in education; and/or crowd funding for investment in energy infrastructure; and/or crowd funding for investment in renewable energy; and/or investment in nuclear energy; and/or crowd funding for investment in civil infrastructure; and/or crowd funding for investment in autonomous vehicle infrastructure; and/or crowd funding for investment in flying vehicle infrastructure; and/or crowd funding for investment in military infrastructure; and/or crowd funding for investment in autonomous vehicle manufacturing; and/or crowd funding for investment in flying vehicle manufacturing; and/or crowd funding for investment in crypto currency; and/or crowd funding for investment in block chain; and/or crowd funding for investment in military hardware; and/or crowd funding for investment in automobile manufacturing; and/or crowd funding for investment in aircraft manufacturing; and/or crowd funding for investment involving donation; and/or crowd funding for investment involving Islamic finance; and/or crowd funding for investment involving donation; and/or crowd funding for investment involving crowd funding.

Some embodiments of the invention comprise a computer-implemented system that includes specifically programming at least one computer system or a portion of at least one computer system to perform at least one of the following: deriving revenues through the leasing model involving investment; and/or deriving revenues through the leasing model involving investment in aircraft; and/or deriving revenues through the leasing model involving investment in satellites; and/or deriving revenues through the leasing model involving investment in spacecraft; and/or deriving revenues through the leasing model involving investment in commercial aviation; and/or deriving revenues through the leasing model involving investment in aerospace; and/or deriving revenues through the leasing model involving investment in infrastructure; and/or deriving revenues through the leasing model involving investment in real estate; and/or deriving revenues through the leasing model involving investment in information technology software; and/or deriving revenues through the leasing model involving investment in information technology hardware; and/or deriving revenues through the leasing model involving investment in telecommunications; and/or deriving revenues through the leasing model involving investment in aircraft and/or satellites and/or spacecraft to finance infrastructure; and/or deriving revenues through the leasing model involving investment in high-speed rail; and/or deriving revenues through the leasing model involving investment in smart grid; and/or deriving revenues through the leasing model involving investment in 5G; and/or deriving revenues through the leasing model involving investment in Space Internet; and/or deriving revenues through the leasing model involving investment in water supply system or water supply network; and/or deriving revenues through the leasing model involving investment in water infrastructure; and/or deriving revenues through the leasing model involving investment in airport infrastructure; and/or deriving revenues through the leasing model involving investment in port infrastructure; and/or deriving revenues through the leasing model involving investment in inland port infrastructure; and/or deriving revenues through the leasing model involving investment in sports venue; and/or deriving revenues through the leasing model involving investment in air transportation infrastructure; and/or deriving revenues through the leasing model involving investment in surface transportation infrastructure; and/or deriving revenues through the leasing model involving investment in rail infrastructure; and/or deriving revenues through the leasing model involving investment in highway infrastructure; and/or deriving revenues through the leasing model involving investment in road infrastructure; and/or deriving revenues through the leasing model involving investment in education; and/or deriving revenues through the leasing model involving investment in energy infrastructure; and/or deriving revenues through the leasing model involving investment in renewable energy; and/or investment in nuclear energy; and/or deriving revenues through the leasing model involving investment in civil infrastructure; and/or deriving revenues through the leasing model involving investment in autonomous vehicle infrastructure; and/or deriving revenues through the leasing model involving investment in flying vehicle infrastructure; and/or deriving revenues through the leasing model involving investment in military infrastructure; and/or deriving revenues through the leasing model involving investment in autonomous vehicle manufacturing; and/or deriving revenues through the leasing model involving investment in flying vehicle manufacturing; and/or deriving revenues through the leasing model involving investment in crypto currency; and/or deriving revenues through the leasing model involving investment in block chain; and/or deriving revenues through the leasing model involving investment in military hardware; and/or deriving revenues through the leasing model involving investment in automobile manufacturing; and/or deriving revenues through the leasing model involving investment in aircraft manufacturing; and/or deriving revenues through the leasing model involving investment in aviation education; and/or deriving revenues through the leasing model in investment involving Islamic finance; and/or deriving revenues through the leasing model in investment involving donation; and/or deriving revenues through the leasing model in investment involving crowd funding.

The U.S. Citizenship & Immigration Service (“USCIS”) Employment-Based Fifth Preference Immigrant Investor Program, more commonly known as EB-5 (“EB-5” or “EB-5 Program”) was established by Congress in 1990 to stimulate the United States economy through job creation and capital investment by foreign investors and is administered by the USCIS within the Department of Homeland Security (“DHS”). In order to obtain an EB-5 visa, foreign investors must invest $1,800,000 (or at least $900,000 in a Targeted Employment Area—high unemployment or rural area), creating or preserving at least 10 jobs for United States workers excluding the investor and their immediate family.

The EB-5 Program establishes a path to permanent residency for up to 10,000 immigrants (and immediate family members) annually who invest in an existing or new business in the United States and create or preserve at least 10 U.S. jobs. Under this program, immigrants will be required to invest $1.8 million in a qualified U.S. business; however, if they invest in a business located in specified “targeted employment areas,” the investment threshold is lowered to $900,000.

As of Nov. 21, 2019, the EB-5 standard minimum investment amount increased to $1,800,000 from $1,000,000 and the minimum investment in a TEA increased to $900,000 from $500,000.

A geographic area is classified as a targeted employment area (“TEA”) if it is considered rural or if it is experiencing an unemployment rate at least 150% of the national average (to be reported by each regional center's state of operation).

For the purposes of the EB-5 program, a rural area is not part of a metropolitan statistical area (as designated by the Office of Management and Budget) and is outside of any city or town with a population of 20,000 or more.

When immigrant investors apply for visas, they receive a conditional green card (USCIS I-526, Immigration Petition by Alien Entrepreneur) contingent on meeting the job creation requirement. Subsequently, when they prove that they have met the requirement, the conditions are removed. (USCIS I-829, Petition by Entrepreneur to Remove Conditions).

From an immigrant's perspective, the EB-5 Program represents merely one of several paths to obtain a visa. (Immigration and Nationality Act (INA) section 203(b)(5). The term “EB-5” refers to the fifth category of the five permanent resident visas available in the employment-based preference system that prioritizes immigrants based on their skills.

The EB-5 visa is based on the immigrant's investment of capital in a business that creates new jobs or preserves existing jobs. However, from a business developer's perspective, the immigrant's investment to qualify for the visa creates an alternative capital source for the business developer's project (“EB-5 capital” or “EB-5 financing”). Despite enactment by Congress in 1990, for many years the EB-5 Program was not a common path followed by immigrants to seek a visa. However, when traditional capital markets evaporated during the Great Recession, developers' demand for alternate capital sources rejuvenated the EB-5 Program. Since 2008, the number of EB-5 visas sought, and hence the use of EB-5 capital, has skyrocketed.

For example, 1,258 EB-5 visa applications (I-526 petitions) were filed during fiscal year 2008, compared to 10,928 during fiscal year 2014. This represents an increase of 769% [(10,928-1,258)/1,258] over this 6-year period.

Furthermore, the number of applications filed during 2014 alone represented more than 25% of the applications filed since the Program's inception in 1990.

EB-5 capital has become a capital source providing extraordinary flexibility and attractive terms, especially to finance commercial real estate projects. Consequently, many developers routinely consider EB-5 capital as a potential source to fill a major space in the capital stack.

The EB-5 investor's motivation for making the investment accounts for the relative flexibility and favorable terms afforded by EB-5 capital compared to conventional capital sources. Unlike that of the conventional capital providers (such as banks, private equity funds, REITs, life insurance companies and pension funds), the EB-5 investor's reason for making the investment is to secure a visa. Thus, his primary objective at the time of making the investment is to satisfy the EB-5 visa requirements. Consequently, so long as the investor believes that the investment will qualify for the visa and result in the safe return of his capital, he is willing to accept a below market, if not minimal, return on the investment.

For example, the EB-5 investors who funded one of the largest capital raises in history relating to the renovation of a Las Vegas casino resort (two tranches totaling almost $400 million) are entitled to interest at the rate of 0.5% per annum.

Furthermore, the investor might not require some of the other protections that more sophisticated, conventional real estate investors typically seek.

Sometimes, critics refer pejoratively to EB-5 as the “visa for sale” or “cash for visa” program. However, the immigrant's investment is not a purchase of a visa, but instead an investment in a U.S. project that will create jobs with the expectation that the investor's capital will be returned. While the investment must be “at risk”, the investor's expectation is that he will recover his investment after it has been outstanding for sufficient time to comply with the EB-5 immigration requirements.

EB-5 capital can fill any space in the capital stack and take the form of debt or equity; ranging from unsecured loans to senior mortgage loans to equity. EB-5 capital raises for individual projects have ranged in size from $500,000 to more than $600 million. During the past ten years, EB-5 capital has played a key role in financing several large-scale projects, particularly in major urban areas.

Examples include several projects that have raised, or are in the process of raising, $200 million or more of EB-5 capital. The Related Companies (“Related”) raised at least $600 million for a mixed-use project in the Hudson Yards on the West Side of Manhattan. Forest City Ratner (“Forest City”) raised $477 million for Phases I and 2 of Atlantic Yards and is in the process of raising an additional $100 million for Phase III. Silverstein Properties (“Silverstein”) has a pending raise of $250 million for the mixed-use, Four Seasons Hotel and luxury condominium in the Tribeca section of Manhattan. A partnership including Acadia Realty (“Acadia”) raised $200 million for the mixed-use City Point project in downtown Brooklyn. Stockbridge/SBE (“SBE”) raised almost $400 million for the renovation of the SBE's SLS Hotel and Casino Las Vegas (formerly the Sahara Hotel).

Simply stated, the Program will require that the immigrant make a capital investment of $900,000 or $1,800,000 (depending on whether the project is located in a TEA) (INA section 203(b)(5)(C) in a business located within the United States. The business must directly create 10 new, full-time jobs per investor. (INA section 203(b)(5)(A)). Thus, the number of jobs that a project will create is a key determinant of the amount of the potential EB-5 capital raise.

Most projects create a limited number of direct jobs. However, if the project is affiliated with a government-approved Regional Center, an additional category of jobs may be counted, “indirect jobs”. Typically, a new business generates many more indirect jobs than direct jobs.

If the immigrant invests directly in the project, rather than through a Regional Center, then only “direct” jobs are counted—jobs where the workers are employed directly by the Job Creating Entity that owns the project.

Although United States Citizenship and Immigration Service is the Federal agency that administers the immigration process, including the EB-5 Program, it regulates only aspects of the immigrant's investment that enables visa qualification. The Securities and Exchange Commission regulates the process of soliciting investors, but this aspect plays only a small role in the overall capital formation and capital structure process. In recent years, the overwhelming majority of investors seeking EB-5 visas have invested in commercial real estate projects through Regional Centers.

IIUSA, the national trade association for EB-5 Regional Centers, estimates that 95% of all EB-5 capital is raised and invested through Regional Centers (although not all of the capital is invested in real estate projects). The EB-5 investor does not typically invest directly in the project entity, but instead invests through a New Commercial Enterprise, an EB-5 required investment vehicle. Although the investor's funds can ultimately be deployed to the project as a loan or equity, EB-5 investments are most commonly structured as a loan.

Many EB-5 investors prefer loans to equity because their prime motive to make the investment is to secure the visa. They believe the features of a secured loan increase the likelihood that they will be recover their investment. A fixed maturity date and a default remedy including foreclosure impose pressure on borrower.

The EB-5 Program brings together interests that are often not gracefully coordinated. The complexity of the application process, varying roles for different institutions, high transaction costs, a cadre of intermediaries—including unregulated brokers working abroad—and the often inability of USCIS to effectively administer the EB-5 Program present a set of obstacles that may prevent potential investors from using the program and further erode public confidence.

The DHS Office of Inspector General (OIG) released an audit of the USCIS-run EB-5 regional center program in December 2013.

The audit asserted that USCIS was not effectively managing the regional center program for two primary reasons. First, the legislation establishing the program does not give USCIS the authority to prevent fraud and national security threats; and second, the agency does not consistently enforce its own regulations and procedures. The audit offered four recommendations to USCIS aimed at improving the EB-5 regional center program: (1) Update and clarify regulations related to USCIS' authority to deny or terminate regional center participants when connections to fraud and/or national security risks are known, and to make these concerns explicit cause for revocation of regional center status; (2) Develop memoranda of understanding with other federal agencies (Commerce, SEC, Labor) to lend expertise to the adjudication of applications and petitions related to the EB-5 regional center program; (3) Conduct comprehensive reviews of the EB-5 program to measure economic impact of the program on the U.S. economy; (4) Establish quality assurance to strengthen the integrity of the program and ensure that regional centers operate within the Code of Federal Regulations requirements.

In their response, USCIS concurred with and is developing plans to implement changes related to recommendations one, two, and four listed above and described corrective actions and detailed steps that are already underway to improve the functioning of the program as related to the recommendations made by OIG. Regarding the first recommendation, USCIS will update regulations to provide greater clarity on eligibility under the program, especially regarding evidentiary requirements, and will issue a revised rule. In response to recommendation number two, USCIS will develop and implement an interagency collaboration plan. USCIS also plans to establish quality assurance standards to promote program integrity and ensure regulatory compliance in response to the fourth recommendation. Regarding the third recommendation concerning a broader assessment of the program's impact, USCIS did not concur that it was the best agency to conduct such a study, even though it agreed that such a review would be beneficial.

As an agency that administers benefits, USCIS argued that it was not well-positioned to conduct such a study.

Some embodiments include a communication module between System Provider and System Provider Global Financial Syndicate Loan 1.

Some embodiments include a communication module for System Provider to establish relationships with global capital market sources to raise (i) $900 billion of debt capital to serve as a credit enhancement for System Provider Program Year 1 (“System Provider Global Financial Syndicate Loan 1”); (ii) $90 billion of debt capital to service the interest component of System Provider Global Financial Syndicate Loan 1 (“System Provider Global Financial Syndicate Loan 2”); (iii) $4.5 trillion of debt capital to service System Provider Program Year 1 projects (“System Provider Global Financial Syndicate Annual Project Financing”).

Some embodiments include one of several proposed financial structures for System Provider Program Year 1 and assumes that the U.S. Government will allow System Provider to process 500,000 EB-NI immigrant visas related to System Provider Program Year 1. Each EB-NI immigrant visas will require a $1,800,000 financing, funding or investment in a new or existing commercial enterprise that creates or preserves at least 10 U.S. jobs.

System Provider Global Financial Syndicate Loan 1−$1,800,000 Loan×500,000 EB-NI Visas=$900 Billion Loan

Some embodiments include System Provider Global Financial Syndicate to provide a $1,800,000 loan to System Provider for each allocated EB-NI immigrant visa for a total of 500,000 EB-NI immigrant visas during System Provider Program Year 1 for a total of $900 billion (System Provider Global Financial Syndicate Loan 1) Foundational credit for System Provider Global Financial Syndicate Loan 1 ($1,800,000 loan) is based upon future receipt of EB-NI immigrant funding.

Some embodiments include a communication module between System Provider and a creditor for a loan for a 10-year term.

Some embodiments include a communication module between System Provider and a creditor for an interest-only loan.

Some embodiments include a communication module between System Provider and a creditor for a loan at 1% interest (estimated interest rate) resulting in $180,000 of interest during 10-year term.

In some embodiments System Provider is responsible for 100% of the interest, or $180,000, at loan origination. The future value of $180,000 at 6% interest calculated monthly over 10 years is $327,491.

System Provider Global Financial Syndicate obtains a $327,491 future value benefit at origination of System Provider Global Financial Syndicate Loan 1 ($1,800,000 loan to System Provider). System Provider is responsible for $1,800,000 principal at the end of the 10-year term.

In some embodiments, System Provider will secure System Provider Global Financial Syndicate Loan 1 ($1,800,000 loan) with System Provider collateral including Commercial Airplanes, Commercial Satellites, Spacecraft, other System Provider assets, other System Provider revenue streams.

In some embodiments System Provider Program Year 1 involves System Provider Global Financial Syndicate Loan 2−$180,000 Loan×500,000 EB-NI Visas=$90 Billion Loan.

In some embodiments, System Provider Global Financial Syndicate provides $180,000 loan to System Provider for each allocated EB-NI immigrant visa for a total of 500,00 EB-NI immigrant visas during System Provider Program Year 1 for a total of $90 billion (System Provider Global Financial Syndicate Loan 2); Financing $180,000 Interest Payment for System Provider Global Financial Syndicate Loan 2; System Provider Global Financial Syndicate provides $180,000 loan to System Provider; 10-year term; principal and interest; interest rate to be determined; System Provider will secure System Provider Global Financial Syndicate Loan 2 ($180,000 loan) with System Provider collateral including Commercial Airplanes, Commercial Satellites, Spacecraft, other System Provider assets, other System Provider revenue streams.

Some embodiments include System Provider Program Year 1 System Provider Immigrant Visa Financial Product. System Provider has developed an immigrant visa financial product (“System Provider Immigrant Visa Financial Product”).

In some embodiments, System Provider Immigrant Visa Financial Product (i) involves EB-NI immigrant visas; (ii) will cost $180,000 each; (iii) can be financed over 10 years, 20 years or 30 years; (iv) can be scaled, resulting in 500,000 System Provider Immigrant Financial Product transactions during System Provider Program Year 1 and 200,000 System Provider Immigrant Financial Product transactions during System Provider Program Years 2-21; (v) will be subsidized, insured and secured by System Provider and; (vi) can result in System Provider financing $90 billion of subsidized, insured and secured transactions During System Provider Program Year 1 and $36 billion of subsidized, insured and secured transactions During System Provider Program Years 2-21.

In some embodiments, System Provider Immigrant Visa Financial Product (Subsidized, Insured and Secured Transaction for $180,000); EB-NI Immigrant Finances $180,000 (Principal and Interest); 10-year term, 20-year term, 30-year term; Principal and interest (interest payment subsidized by System Provider); interest rate to be determined; $180,000 loan to EB-NI Immigrant; $180,000—Interest payment involving System Provider Global Financial Syndicate Loan 1; System Provider will insure System Provider Immigrant Visa Financial Product ($180,000 loan to EB-NI Immigrant); System provider will secure System Provider Immigrant Visa Financial Product ($180,000 loan to EB-NI Immigrant) with System Provider collateral including Commercial Airplanes, Commercial Satellites, Spacecraft, other System Provider assets, other System Provider revenue streams; $180,000 loan to EB-NI Immigrant×500,000 EB-NI Immigrants=$90 billion of subsidized, insured and secured transactions during System Provider Program Year 1; $180,000 loan to EB-NI Immigrant×200,000 EB-NI Immigrants=$36 billion of subsidized, insured and secured transactions annually during System Provider Program Years 2-20; Possible assignment of $90 billion of insured and secured transactions during System Provider Program Year 1 and $36 billion of insured and secured transactions during System Provider Program Years 2-20 to a third-party financial institution in partnership with System Provider.

Some embodiments include a communication module between System Provider and System Provider Global Financial Syndicate Loan 1.

Some embodiments include a communication module for System Provider to establish relationships with global capital market sources to raise (i) debt capital to serve as a credit enhancement for System Provider Program (“System Provider Global Financial Syndicate Loan 1”); (ii) debt capital to service the interest component of System Provider Global Financial Syndicate Loan 1 (“System Provider Global Financial Syndicate Loan 2”); (iii) debt capital to service System Provider Program projects (“System Provider Global Financial Syndicate Annual Project Financing”).

Some embodiments include one of several proposed financial structures for System Provider Program and assumes that the U.S. Government will allow System Provider to process 500,000 EB-NI immigrant visas related to System Provider. Each EB-NI immigrant visas will require a financing, funding or investment in a new or existing commercial enterprise that creates or preserves at least 10 U.S. jobs.

System Provider Global Financial Syndicate Loan 1

Some embodiments include System Provider Global Financial Syndicate to provide a loan to System Provider for each allocated EB-NI immigrant visa for EB-NI immigrant visas, or alternative immigrant visas or non-immigrant visas, for System Provider Program for a total loan (System Provider Global Financial Syndicate Loan 1) Foundational credit for System Provider Global Financial Syndicate Loan 1 (loan) is based upon future receipt of EB-NI immigrant funding and/or alternative immigrant visa and/or non-immigrant visa funding.

Some embodiments include a communication module between System Provider and a creditor for a loan for a 10-year term.

Some embodiments include a communication module between System Provider and a creditor for an interest-only loan.

Some embodiments include a communication module between System Provider and a creditor for a loan at specified interest (estimated interest rate) resulting in a specified loan with interest during 10-year term

In some embodiments, System Provider is responsible for 100% of the interest, interest of loan amount, at loan origination. The future value of interest amount is calculated monthly over 10 years.

In some embodiments, System Provider Global Financial Syndicate obtains a future value benefit at origination of System Provider Global Financial Syndicate Loan 1 (loan to System Provider). System Provider is responsible for principal at the end of the 10-year term.

In some embodiments, System Provider will secure System Provider Global Financial Syndicate Loan 1 (loan) with System Provider collateral including Commercial Airplanes, Commercial Satellites, Spacecraft, other System Provider assets and/or other System Provider revenue streams

In some embodiments, System Provider Program involves System Provider Global Financial Syndicate Loan 2 Loan×EB-NI Visas and/or alternative immigrant visas and/or non-immigrant visas equals loan amount.

In some embodiments, System Provider Global Financial Syndicate provides loan to System Provider for each allocated EB-NI immigrant visa for a total of EB-NI immigrant visas and/or alternative immigrant visas and/or non-immigrant visas for System Provider Program for a total loan amount (System Provider Global Financial Syndicate Loan 2);financing loan amount Interest Payment for System Provider Global Financial Syndicate Loan 2; System Provider Global Financial Syndicate provides loan to System Provider; 10-year term; principal and interest; interest rate to be determined; System Provider will secure System Provider Global Financial Syndicate Loan 2 (loan) with System Provider collateral including Commercial Airplanes, Commercial Satellites, Spacecraft, other System Provider assets, other System Provider revenue streams

Some embodiments include System Provider Program—System Provider Immigrant Visa Financial Product. System Provider has developed an immigrant visa financial product (“System Provider Immigrant Visa Financial Product”).

In some embodiments, System Provider Immigrant Visa Financial Product (i) involves EB-NI immigrant visas and/or alternative immigrant visas and/or non-immigrant visas; (ii) will cost specified amount; (iii) can be financed over 10 years, 20 years or 30 years; (iv) can be scaled, resulting in specified amount of System Provider Immigrant Financial Product transactions for System Provider Program and specified amount of System Provider Immigrant Financial Product transactions during System Provider Program; (v) will be subsidized, insured and secured by System Provider and; (vi) can result in System Provider financing specified amount of subsidized, insured and secured transactions For System Provider Program and specified amount of subsidized, insured and secured transactions During System Provider Program.

In some embodiments, System Provider Immigrant Visa Financial Product (Subsidized, Insured and Secured Transaction for specified amount); EB-NI Immigrant and/or alternative immigrant and/or non-immigrant finances specified amount (Principal and Interest); 10-year term, 20-year term, 30-year term; Principal and interest (interest payment subsidized by System Provider); interest rate to be determined; loan amount to EB-NI Immigrant and/or alternative immigrant and/or non-immigrant; specified amount—interest payment involving System Provider Global Financial Syndicate Loan 1; System Provider will insure System Provider Immigrant Visa Financial Product (loan to EB-NI Immigrant and/or alternative immigrant and/or non-immigrant); System provider will secure System Provider Immigrant Visa Financial Product (specified loan amount to EB-NI Immigrant) with System Provider collateral including Commercial Airplanes, Commercial Satellites, Spacecraft, other System Provider assets, other System Provider revenue streams; specified loan amount to EB-NI Immigrant and/or alternative immigrant and/or non-immigrant×specified number of EB-NI Immigrants and/or alternative immigrant and/or non-immigrant=specified number of subsidized, insured and secured transactions for System Provider Program; specified loan amount to EB-NI Immigrant x specified number of EB-NI Immigrants and/or alternative immigrant and/or non-immigrant)=specified amount of subsidized, insured and secured transactions annually for System Provider Program; Possible assignment of specified amount of insured and secured transactions during System Provider Program and specified amount of insured and secured transactions for System Provider Program to a third-party financial institution in partnership with System Provider.

1. A system for automating and processing monetization of immigrant visas and/or the financial structuring of immigrant visas for financing, funding and/or investment for job creation and economic development, comprising:
one or more computers comprising one or more processors and one or more non-transitory computer readable media, the non-transitory computer readable media comprising instructions that, when executed by the one or more processors, implement:
a communications module configured to:
receive financing data and immigration data from one or more databases;
receive funding data and immigration data from one or more databases; and
receive investment data and immigration data from one or more databases;
an aggregation module configured to:
aggregate the financing data and the immigration data into aggregated data;
aggregate the funding data and the immigration data into aggregated data;
and
aggregate the investment data and the immigration data into aggregated data;
a financing module configured to implement and/or track one or more financing transactions;
a funding module configured to implement and/or track one or more funding transactions;
an investment module configured to implement and/or track one or more investments;
an immigration module configured to implement and/or track one or more immigrant visa programs; and
a graphical user interface (GUI) configured to visually display one or more system outputs from the communications module, the aggregation module, the financing module, the funding module, the investment module, and/or the immigration module;
wherein the immigration data comprises available visas for one or more immigrant visa programs;
wherein the financing data comprises data about one or more financing transactions;
wherein aggregating the financing data and the immigration data into aggregated data comprises storing the financing data and immigration data into one or more system databases;
wherein aggregating the financing data and the immigration data into aggregated data comprises linking the immigration data to the financing data;
wherein tracking one or more financing comprises tracking the aggregated data;
wherein the funding data comprises data about one or more funding transactions;
wherein aggregating the funding data and the immigration data into aggregated data comprises storing the funding data and immigration data into one or more system databases;
wherein aggregating the funding data and the immigration data into aggregated data comprises linking the immigration data to the funding data;
wherein tracking one or more funding transactions comprises tracking the aggregated data;
wherein the investment data comprises data about one or more investment transactions;
wherein aggregating the investment data and the immigration data into aggregated data comprises storing the investment data and immigration data into one or more system databases;
wherein aggregating the investment data and the immigration data into aggregated data comprises linking the immigration data to the investment data;
wherein tracking one or more investments comprises tracking the aggregated data;
and
wherein tracking one or more immigrant visas programs comprises tracking visa compliance with one or more immigrant visa program rules.

2. The system of claim 1,
wherein financing, funding or investment involving immigrant visas comprise the monetization structuring and/or financial structuring of immigrant visas to support immigrant visa financial markets, immigrant visa financial products, immigrant visa financial tools, immigrant visa financial structures, and/or immigrant visa financial algorithms to support economic development, job creation, direct investment, indirect investment, credit enhancement, loan guarantees and/or immigrant visa-based financing, funding and/or investment in multiple industry sectors in the United States and/or on a global basis;
wherein applying monetization and/or financing, funding and/or investment structuring to some or all immigrant visas, recaptured immigrant visas, recaptured unused immigrant visas and/or unused immigrant visas that can be implemented subsequent to Presidential action, federal administrative action and/or legislative action; and
wherein applying monetization and/or financing, funding and/or investment structuring criteria to some or all immigrant visas, recaptured immigrant visas, recaptured unused immigrant visas and/or unused immigrant visas that can be implemented as a result of Presidential action, federal administrative action and/or legislative action.

3. The system of claim 1,
wherein aggregating, managing and tracking immigrant visas and/or investments in furtherance of immigrant visas and/or job creation in furtherance of immigrant visas and/or immigrant visa employment opportunities in furtherance of immigrant visas including, but not limited to, immigrant visas, recaptured immigrant visas for use in subsequent fiscal years, unused immigrant visas recaptured for use in subsequent fiscal years, prospective immigrant visas for use in a specific fiscal year and prospective immigrant visas for use in subsequent fiscal years;
wherein the system attributes a financial value to immigrant visas, attributes a monetary value to immigrant visas, attributes an economic value to immigrant visas, attributes a unit of time to immigrant visas, attributes a monetary value to a unit of time to immigrant visas, attributes a financial value to a unit of time to immigrant visas, attributes an economic value to a unit of time to immigrant visas, fund immigrant visas, finance immigrant visas, collateralizes immigrant visas, collateralizes the financing of immigrant visas, securitizes immigrant visas, securitizes the financing of immigrant visas, creates financial algorithms for immigrant visas, creates financial algorithms for the funding of immigrant visas, creates financial algorithms for the financing of immigrant visas, creates a market for immigrant visas, creates a market for the funding of immigrant visas, creates a market for the financing of immigrant visas, creates financial products for immigrant visas, creates financial products for the funding of immigrant visas, creates financial products for the financing of immigrant visas, creates financial tools for immigrant visas, creates financial tools for the funding of immigrant visas, creates financial tools for the financing of immigrant visas, creates financial structures for immigrant visas, creates financial structures for the funding of immigrant visas, creates financial structures for the financing of immigrant visas, accept and process visa applications, accept and process expedited visa applications, authenticate investment source of funds, enable background check processing, enable national security related screening and processing, track visa processing, track legal compliance, track securities law compliance, track national security law compliance, suggest investments, track job creation, track investment performance, suggest and place immigrants with job creation entities, suggest and place immigrants with employment opportunities and/or monitor investments for fraud; and
wherein the system significantly increases the likelihood of obtaining an immigrant visa while mitigating risk associated with obtaining an immigrant visa.

4. The system of claim 1,
wherein the financing, funding or investment involving immigrant visas comprise aggregating, managing, and tracking immigrant visas to develop, construct and support financial algorithms, financial products, financial tools and financial structures to support direct investment, credit enhancement, loan guarantees and other economic development in multiple industry sectors in the United States and on a global basis;
wherein the financing, funding or investment involving immigrant visas comprise developing a monetization structure for the immigrant visas; and
wherein the financing, funding or investment involving immigrant visas comprise developing a financial structure for the immigrant visas;

5. The system of claim 1,
wherein the financing, funding or investment involving immigrant visas comprise executive, administrative and/or legislative recapture up to or over 4,547,236 immigrant visas;
wherein the financing, funding or investment involving immigrant visas comprise aggregating, managing and tracking immigrant investor visas and/or immigrant investor visas funding including, but not limited to, recaptured immigrant visas to be used for financing investment and/or financing, funding and/or investment and/or credit enhancement for financing, funding or investment; and
wherein the financing, funding or investment involving immigrant visas comprise aggregating, managing and tracking immigrant investor visas and/or immigrant investor visas funding including, but not limited to, unused immigrant visas to be used for financing investment and/or financing, funding and/or investment and/or credit enhancement for financing, funding or investment.

6. The system of claim 1,
wherein the financing, funding or investment involving immigrant visas comprise System Provider Dynamic Immigration;
wherein the financing, funding or investment involving immigrant visas will enhance the flow of credit to targeted sectors of the United States economy;
wherein the financing, funding or investment involving immigrant visas will make those segments of the capital market more efficient and transparent;
wherein the financing, funding or investment involving immigrant visas reduce the risk to investors and other suppliers of capital to finance and develop those targeted sectors; and
wherein the financing, funding or investment involving immigrant visas with System Provider Dynamic Immigration, the funding from each immigrant visa will be deployed as a direct investment, indirect investment or credit enhancement and leveraged at a specific ratio (System Provider Credit Enhancement to System Provider immigrant funding) to raise additional funding based on each immigrant visas financing, funding or investment.

7. The system of claim 1,
wherein the financing, funding or investment amount for each immigrant visa can be separately financed for each immigrant;
wherein the financing, funding or investment amount for each immigrant visa can be separately financed for each immigrant by an authorized third party;
wherein the financing, funding or investment risk for each immigrant visa can be reduced for each immigrant; and
wherein the financing, funding or investment risk for each immigrant visa can be eliminated for each immigrant.

8. The system of claim 1,
wherein the financing, funding or investment amount for each immigrant visa can be separately financed for each immigrant to support an immigrant visa consumer financial market;
wherein the financing, funding or investment amount for each immigrant visa can be separately financed for each immigrant by an authorized third party to support an immigrant visa consumer financial market;
wherein the financing, funding or investment risk for each immigrant visa can be reduced for each immigrant to support an immigrant visa consumer financial market; and
wherein the financing, funding or investment risk for each immigrant visa can eliminated for each immigrant to support an immigrant visa consumer financial market.

9. The system of claim 1,
wherein the financing, funding or investment amount for each immigrant visa can be separately financed for each immigrant to support an immigrant visa consumer financial product;
wherein the financing, funding or investment amount for each immigrant visa can be separately financed for each immigrant by an authorized third party to support an immigrant visa consumer financial product;
wherein the financing, funding or investment risk for each immigrant visa can be reduced for each immigrant to support an immigrant visa consumer financial product; and
wherein the financing, funding or investment risk for each immigrant visa can eliminated for each immigrant to support an immigrant visa consumer financial product.

10. The system of claim 1,
wherein the financing, funding or investment amount for each immigrant visa can be applied to immigrant visas, recaptured immigrant visas, unused immigrant visas and prospective immigrant visas to create an immigrant visa consumer financial market; and
wherein the financing, funding or investment amount for each immigrant visa can be applied to immigrant visas, recaptured immigrant visas, unused immigrant visas and prospective immigrant visas to create an immigrant visa consumer financial product.

11. A system for automating and processing the monetization of non-immigrant visas and/or the financial structuring of non-immigrant visas for financing, funding and/or investment for job creation and economic development, comprising:
one or more computers comprising one or more processors and one or more non-transitory computer readable media, the non-transitory computer readable media comprising instructions that, when executed by the one or more processors, implement:
a communications module configured to:
receive financing data and immigration data from one or more databases;
receive funding data and immigration data from one or more databases; and
receive investment data and immigration data from one or more databases;
an aggregation module configured to:
aggregate the financing data and the immigration data into aggregated data;
aggregate the funding data and the immigration data into aggregated data;
aggregate the investment data and the immigration data into aggregated data;
a financing module configured to track one or more financing;
a funding module configured to track one or more funding;
an investment module configured to track one or more investments;
an immigration module configured to track one or more non-immigrant visa programs; and
a graphical user interface (GUI) configured to visually display one or more system outputs from the communications module, the aggregation module, the financing module, the funding module, the investment module, and/or the immigration module;
wherein the immigration data comprises available visas for one or more non-immigrant visa programs;
wherein the immigration data comprises available visas for one or more non-immigrant visa programs;
wherein the financing data comprises data about one or more financing;
wherein aggregating the financing data and the immigration data into aggregated data comprises storing the financing data and immigration data into one or more system databases;
wherein aggregating the financing data and the immigration data into aggregated data comprises linking the immigration data to the financing data;
wherein tracking one or more financing comprises tracking the aggregated data;
wherein the immigration data comprises available visas for one or more non-immigrant visa programs;
wherein the funding data comprises data about one or more funding;
wherein aggregating the funding data and the immigration data into aggregated data comprises storing the funding data and immigration data into one or more system databases;
wherein aggregating the funding data and the immigration data into aggregated data comprises linking the immigration data to the funding data;
wherein tracking one or more funding comprises tracking the aggregated data;
wherein the immigration data comprises available visas for one or more non-immigrant visa programs;
wherein the investment data comprises data about one or more investments;
wherein aggregating the investment data and the immigration data into aggregated data comprises storing the investment data and immigration data into one or more system databases;
wherein aggregating the investment data and the immigration data into aggregated data comprises linking the immigration data to the investment data;
wherein tracking one or more investments comprises tracking the aggregated data;
and
wherein tracking one or more non-immigrant visas programs comprises tracking visa compliance with one or more non-immigrant visa program rules.

12. The system of claim 11,
wherein financing, funding or investment involving non-immigrant visas comprise the monetization structuring and/or financial structuring of non-immigrant visas to support non-immigrant visa financial markets, non-immigrant visa financial products, non-immigrant visa financial tools, non-immigrant visa financial structures, and/or non-immigrant visa financial algorithms to support economic development, job creation, direct investment, indirect investment, credit enhancement, loan guarantees and/or non-immigrant visa-based financing, funding and/or investment in multiple industry sectors in the United States and on a global basis;
wherein applying monetization and/or financing, funding and/or investment structuring to some or all non-immigrant visas, recaptured non-immigrant visas, recaptured unused non-immigrant visas and/or unused non-immigrant visas that can be implemented subsequent to Presidential action, federal administrative action and/or legislative action;
wherein applying monetization and/or financing, funding and/or investment structuring criteria to some or all non-immigrant visas, recaptured non-immigrant visas, recaptured unused non-immigrant visas and/or unused non-immigrant visas that can be implemented as a result of Presidential action, federal administrative action and/or legislative action;

13. The system of claim 11,
wherein aggregating, managing and tracking non-immigrant visas and/or investments in furtherance of non-immigrant visas and/or job creation in furtherance of non-immigrant visas and/or non-immigrant visa employment opportunities in furtherance of non-immigrant visas including, but not limited to, non-immigrant visas, recaptured non-immigrant visas for use in subsequent fiscal years, unused non-immigrant visas recaptured for use in subsequent fiscal years, prospective non-immigrant visas for use in a specific fiscal year and prospective non-immigrant visas for use in subsequent fiscal years;
wherein the system attributes a financial value to non-immigrant visas, attributes a monetary value to non-immigrant visas, attributes an economic value to non-immigrant visas, attributes a unit of time to non-immigrant visas, attributes a monetary value to a unit of time to non-immigrant visas, attributes a financial value to a unit of time to non-immigrant visas, attributes an economic value to a unit of time to non-immigrant visas, fund non-immigrant visas, finance non-immigrant visas, collateralizes non-immigrant visas, collateralizes the financing of non-immigrant visas, securitizes non-immigrant visas, securitizes the financing of non-immigrant visas, creates financial algorithms for non-immigrant visas, creates financial algorithms for the funding of non-immigrant visas, creates financial algorithms for the financing of non-immigrant visas, creates a market for non-immigrant visas, creates a market for the funding of non-immigrant visas, creates a market for the financing of non-immigrant visas, creates financial products for non-immigrant visas, creates financial products for the funding of non-immigrant visas, creates financial products for the financing of non-immigrant visas, creates financial tools for non-immigrant visas, creates financial tools for the funding of non-immigrant visas, creates financial tools for the financing of non-immigrant visas, creates financial structures for non-immigrant visas, creates financial structures for the funding of non-immigrant visas, creates financial structures for the financing of non-immigrant visas, accept and process visa applications, accept and process expedited visa applications, authenticate investment source of funds, enable background check processing, enable national security related screening and processing, track visa processing, track legal compliance, track securities law compliance, track national security law compliance, suggest investments, track job creation, track investment performance, suggest and place non-immigrants with job creation entities, suggest and place non-immigrants with employment opportunities and/or monitor investments for fraud;
and
wherein the system significantly increases the likelihood of obtaining an non-immigrant visa while mitigating risk associated with obtaining an non-immigrant visa.

14. The system of claim 11,
wherein the financing, funding or investment involving non-immigrant visas comprise aggregating, managing, and tracking non-immigrant visas to develop, construct and support financial algorithms, financial products, financial tools and financial structures to support direct investment, credit enhancement, loan guarantees and other economic development in multiple industry sectors in the United States and on a global basis;
wherein the financing, funding or investment involving non-immigrant visas comprise developing a monetization structure for the non-immigrant visas;
and
wherein the financing, funding or investment involving non-immigrant visas comprise developing a financial structure for the non-immigrant visas;

15. The system of claim 11,
wherein the financing, funding or investment involving non-immigrant visas comprise executive, administrative and/or legislative recapture up to or over 4,547,236 non-immigrant visas;
wherein the financing, funding or investment involving non-immigrant visas comprise aggregating, managing and tracking non-immigrant investor visas and/or non-immigrant investor visas funding including, but not limited to, recaptured non-immigrant visas to be used for financing investment and/or financing, funding and/or investment and/or credit enhancement for financing, funding or investment; and
wherein the financing, funding or investment involving non-immigrant visas comprise aggregating, managing and tracking non-immigrant investor visas and/or non-immigrant investor visas funding including, but not limited to, unused non-immigrant visas to be used for financing investment and/or financing, funding and/or investment and/or credit enhancement for financing, funding or investment.

16. The system of claim 11,
wherein the financing, funding or investment involving non-immigrant visas comprise System Provider Dynamic Immigration;
wherein the financing, funding or investment involving non-immigrant visas will enhance the flow of credit to targeted sectors of the United States economy;
wherein the financing, funding or investment involving non-immigrant visas will make those segments of the capital market more efficient and transparent;
wherein the financing, funding or investment involving non-immigrant visas reduce the risk to investors and other suppliers of capital to finance and develop those sectors;
and
wherein the financing, funding or investment involving non-immigrant visas with System Provider Dynamic Immigration, the funding from each non-immigrant visa will be deployed as a direct investment, indirect investment or credit enhancement and leveraged at a specific ratio (System Provider Credit Enhancement to System Provider non-immigrant funding) to raise additional funding based on each non-immigrant visas financing, funding or investment.

17. The system of claim 11,
wherein the financing, funding or investment amount for each non-immigrant visa can be separately financed for each non-immigrant;
wherein the financing, funding or investment amount for each non-immigrant visa can be separately financed for each non-immigrant by an authorized third party;
wherein the financing, funding or investment risk for each non-immigrant visa can be reduced for each non-immigrant;
and
wherein the financing, funding or investment risk for each non-immigrant visa can eliminated for each non-immigrant.

18. The system of claim 11,
wherein the financing, funding or investment amount for each non-immigrant visa can be separately financed for each non-immigrant to support an non-immigrant visa consumer financial market;
wherein the financing, funding or investment amount for each non-immigrant visa can be separately financed for each non-immigrant by an authorized third party to support an non-immigrant visa consumer financial market;
wherein the financing, funding or investment risk for each non-immigrant visa can be reduced for each non-immigrant to support an non-immigrant visa consumer financial market;
and
wherein the financing, funding or investment risk for each non-immigrant visa can eliminated for each non-immigrant to support an non-immigrant visa consumer financial market.

19. The system of claim 11,
wherein the financing, funding or investment amount for each non-immigrant visa can be separately financed for each non-immigrant to support an non-immigrant visa consumer financial product;
wherein the financing, funding or investment amount for each non-immigrant visa can be separately financed for each non-immigrant by an authorized third party to support an non-immigrant visa consumer financial product;
wherein the financing, funding or investment risk for each non-immigrant visa can be reduced for each non-immigrant to support an non-immigrant visa consumer financial product;
and
wherein the financing, funding or investment risk for each non-immigrant visa can eliminated for each non-immigrant to support an non-immigrant visa consumer financial product.

20. The system of claim 11,
wherein the financing, funding or investment amount for each non-immigrant visa can be applied to non-immigrant visas, recaptured non-immigrant visas, unused non-immigrant visas and prospective non-immigrant visas to create an non-immigrant visa consumer financial market;
and
wherein the financing, funding or investment amount for each non-immigrant visa can be applied to non-immigrant visas, recaptured non-immigrant visas, unused non-immigrant visas and prospective non-immigrant visas to create an non-immigrant visa consumer financial product.
